(19) United States
(12) Patent Application Publication
(10) Pub. No.: US 2014/0206633 A1
(43) Pub. Date: Jul. 24, 2014

(54) PROCESS FOR THE PREPARATION OF ISOXAZOLINE DERIVATIVES

(71) Applicants: Nicholas Phillip Mulholland, Bracknell (GB); Edouard Godineau, Stein (CH); Jérôme Yves Cassayre, Stein (CH); Peter Renold, Stein (CH); Myriem El Qacemi, Stein (CH); Guillaume Revol, Stein (CH)

(72) Inventors: Nicholas Phillip Mulholland, Bracknell (GB); Edouard Godineau, Stein (CH); Jérôme Yves Cassayre, Stein (CH); Peter Renold, Stein (CH); Myriem El Qacemi, Stein (CH); Guillaume Revol, Stein (CH)

(73) Assignee: SYNGENTA CROP PROTECTION LLC, Greensboro, NC (US)

(21) Appl. No.: 13/581,137

(22) PCT Filed: Feb. 3, 2011
(86) PCT No.: PCT/EP11/51513

§ 371 Date: Jan. 7, 2014

(30) Foreign Application Priority Data
Feb. 25, 2010 (EP) 10250336.4
Feb. 25, 2010 (EP) 10250337.2
May 7, 2010 (GB) 1007689.1
May 28, 2010 (EP) 10164231.2
May 28, 2010 (EP) 10164234.6
Oct. 12, 2010 (EP) 10187269.5

(51) Int. Cl. A01N 43/80; B01J 31/02

(52) U.S. Cl. CPC A01N 43/80; B01J 31/0271
USPC 514/29; 548/240; 514/378; 546/134; 546/135; 544/310; 546/136; 514/38; 514/195; 514/209; 514/245

(57) ABSTRACT

The present invention relates to processes for the preparation of compounds of formula IB wherein A¹, A², A³, A⁴, L, Y¹, Y², R¹, R², R³, R⁴ and R⁵ are as defined in the claims, comprising reacting a compound of formula (II) wherein Y¹, Y², L, A¹, A², R¹, R², R³, R⁴ and R⁵ are as defined for the compound of formula (I); with hydroxylamine in the presence of water, a base and a chiral phase transfer catalyst, which chiral phase transfer catalyst is a quinine derivative. The invention also relates to compounds of formula IB and enantiomerically enriched mixtures comprising compounds of formula IB.

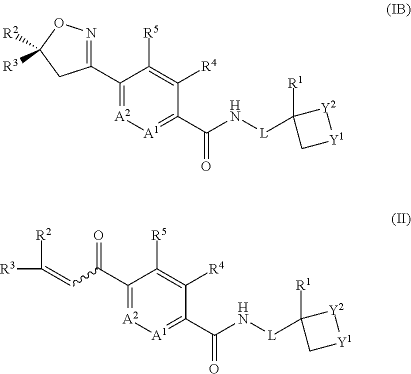

The present invention relates to the stereoselective synthesis of substituted isoxazolines and in particular to the stereoselective synthesis of substituted isoxazolines that have pesticidal activity.

WO2009/080250 discloses isoxazoline compounds that have insecticidal activity. The present invention provides a process for the stereoselective synthesis of isoxazoline compounds, such as those disclosed in WO2009/080250.

In first aspect, the invention provides a process for the preparation of a compound of formula IB

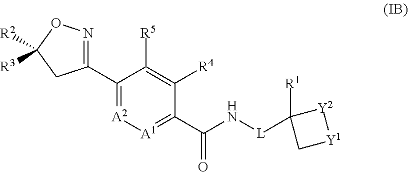

wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
comprising reacting a compound of formula II

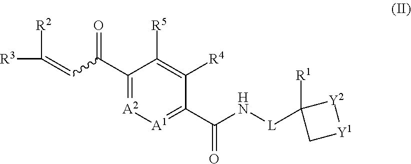

wherein Y¹, Y², L, A¹, A², R¹, R², R³, R⁴ and R⁵ are as defined for the compound of formula I above;
with hydroxylamine in the presence of water, a base and a chiral phase transfer catalyst, which chiral phase transfer catalyst is a quinine derivative, for example a compound of formula III

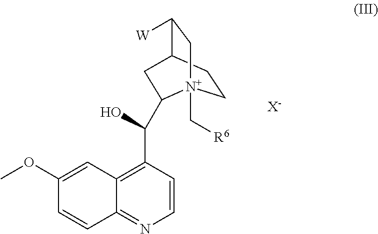

wherein R⁶ is optionally substituted aryl or optionally substituted heteroaryl, W is ethyl or vinyl, and X is an anion, preferably a halogen anion, more preferably chloride or bromide.

Preferably the reaction is performed in an organic solvent.

It has been found that the enantiomer for formula IB is substantially more biologically active than the other enantiomer, e.g. it is substantially more effective at controlling invertebrate animal pests such as insects, acarines, nematodes and/or molluscs. The more biologically active enantiomer may be confirmed using the methodology described in the Examples. In some cases the less biologically active enantiomer has negligible biological activity, e.g. it provides no control of invertebrate animal pests. The present invention allows the more biologically active enantiomer to be selectively synthesised, thereby allowing production of enantiomerically enriched mixtures. This potentially allows reduced rates of application.

In a further aspect, the invention provides a process for the preparation of a mixture comprising a compound of formula IA and a compound of formula IB

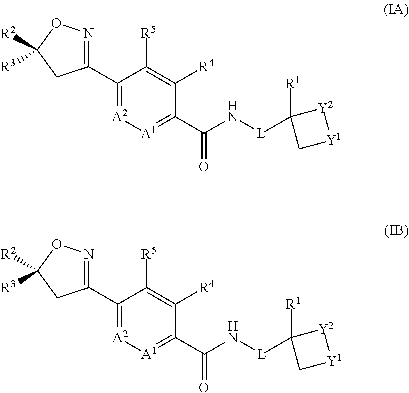

wherein Y¹, Y², L, A¹, A², R¹, R², R³, R⁴ and R⁵ are as defined for the compound of formula I above; wherein the mixture is enantiomerically enriched for the compound of formula IB;
comprising reacting a compound of formula II

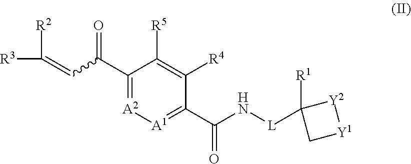

wherein Y¹, Y², L, A¹, A², R¹, R², R³, R⁴ and R⁵ are as defined for the compound of formula I above;
with hydroxylamine in the presence of water, a base and a chiral phase transfer catalyst, which chiral phase transfer catalyst is a quinine derivative, for example a compound of formula III

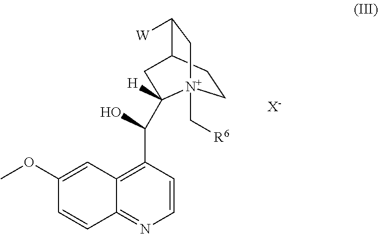

wherein R⁶ is optionally substituted aryl or optionally substituted heteroaryl, W is ethyl or vinyl, and X is an anion, preferably a halogen anion, more preferably chloride or bromide.

In a further aspect the invention provides a process for the preparation of a compound of formula IB or a mixture comprising a compound of formula IA and IB

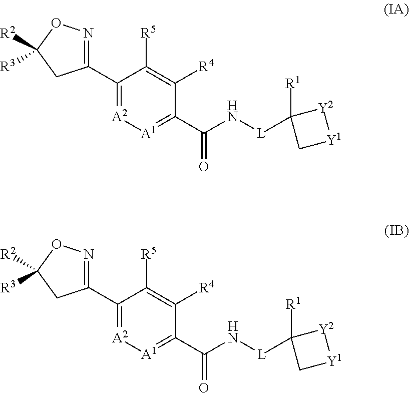

wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
comprising reacting a compound of formula XV

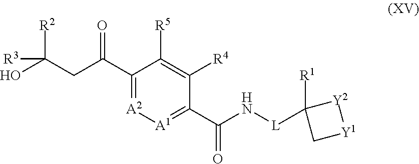

wherein Y¹, Y², L, A¹, A², R¹, R², R³, R⁴ and R⁵ are as defined for the compound of formula I;
with hydroxylamine in the presence of water, a base and a chiral phase transfer catalyst, which chiral phase transfer catalyst is a quinine derivative.

In a further aspect, the invention provides a compound of formula IB

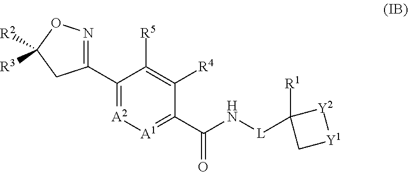

wherein Y¹, Y², L, A¹, A², R¹, R², R³, R⁴ and R⁵ are as defined for the compound of formula I above.

In a further aspect, the invention provides a mixture comprising a compound of formula IA and a compound of formula IB

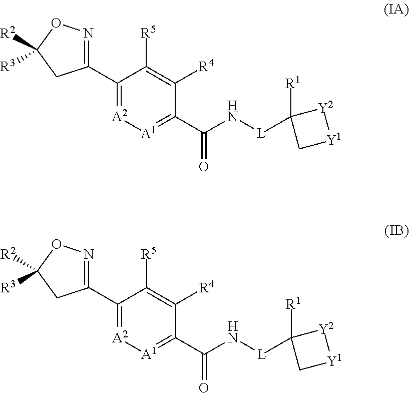

wherein Y¹, Y², L, A¹, A², R¹, R², R³, R⁴ and R⁵ are as defined for the compound of formula I above; wherein the mixture is enantiomerically enriched for the compound of formula IB.

In enantiomerically enriched mixtures of the invention, the molar proportion of the compound of formula IB in the mixture compared to the total amount of both enantiomers is for example greater than 50%, e.g. at least 55, 60, 65, 70, 75, 80, 85, 90, 95, 96, 97, 98, or at least 99%.

In the compound of formula II the stereochemistry around the carbon-carbon double bond may be cis or trans. Both isomers lead to the desired stereochemistry of the compound of formula I. In one embodiment of the invention the compound of formula II is a compound of formula IIA

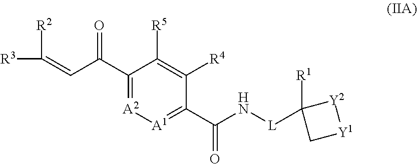

wherein Y¹, Y², L, A¹, A², R¹, R², R³, R⁴ and R⁵ are as defined for the compound of formula I.

Use of chiral phase transfer catalysts derived from quinine, such as compounds of formula III, may have other beneficial effects on the reaction in addition to providing stereoselectivity. For example, they may increase the rate of the reaction and/or allow the reaction to be run under milder conditions, for example at lower temperature.

Each alkyl moiety either alone or as part of a larger group (such as alkoxy, alkylcarbonyl, or alkoxycarbonyl) is a straight or branched chain and is, for example, methyl, ethyl, n-propyl, prop-2-yl, n-butyl, but-2-yl, 2-methyl-prop-1-yl or 2-methyl-prop-2-yl. The alkyl groups are preferably C₁ to C₆ alkyl groups, more preferably C₁-C₄ and most preferably C₁-C₃ alkyl groups.

Halogen is fluorine, chlorine, bromine or iodine.

Haloalkyl groups (either alone or as part of a larger group, such as haloalkoxy) are alkyl groups which are substituted by one or more of the same or different halogen atoms and are, for example, trifluoromethyl, chlorodifluoromethyl, 2,2,2-trifluoro-ethyl or 2,2-difluoro-ethyl.

In the context of the present specification the term “aryl” refers to a ring system which may be mono-, bi- or tricyclic. Examples of such rings include phenyl, naphthalenyl, anthracenyl, indenyl or phenanthrenyl. A preferred aryl group is phenyl.

The term “heteroaryl” refers to an aromatic ring system containing at least one heteroatom and consisting either of a single ring or of two or more fused rings. Preferably, single rings will contain up to three heteroatoms and bicyclic systems up to four heteroatoms which will preferably be chosen from nitrogen, oxygen and sulfur. Examples of monocyclic groups include pyridyl, pyridazinyl, pyrimidinyl, pyrazinyl, pyrrolyl, pyrazolyl, imidazolyl, triazolyl, tetrazolyl, furanyl, thiophenyl, oxazolyl, isoxazolyl, oxadiazolyl, thiazolyl, isothiazolyl, and thiadiazolyl. Examples of bicyclic groups include quinolinyl, cinnolinyl, quinoxalinyl, benzimidazolyl, benzothiophenyl, and benzothiadiazolyl. Monocyclic heteroaryl groups are preferred, pyridyl being most preferred.

Preferably the compound of formula III is a compound of formula IIIa

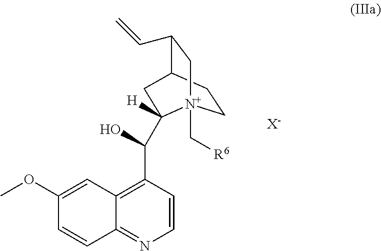

wherein R⁶ is optionally substituted aryl or optionally substituted heteroaryl and X is an anion, halogen, more preferably chloride or bromide.

Preferred substituents of compounds of formula III, including formula IIIa, are, in any combination, as set out below:

Preferably W is vinyl.

Preferably R⁶ is phenyl or phenyl substituted by one to five R⁷, naphthyl or naphthyl substituted by one to five R⁷, anthracenyl or anthracenyl substituted by one to five R⁷, pyrimidinyl or pyrimidinyl substituted by one to three R⁷, or pyridyl or pyridyl substituted by one to four R⁷; more preferably phenyl or phenyl substituted by one to five R⁷, naphthyl or naphthyl substituted by one to five R⁷, anthracenyl or anthracenyl substituted by one to five R⁷, or pyridyl or pyridyl substituted by one to four R⁷; more preferably R⁶ is phenyl or phenyl substituted by one to five R⁷, anthracenyl or anthracenyl substituted by one to five R⁷, or pyridyl or pyridyl substituted by one to four R⁷; even more preferably R⁶ is phenyl or phenyl substituted by one to five substituents selected from halogen, methyl and methoxy, anthracenyl or anthracenyl substituted by one to five substituents selected from halogen, methyl and methoxy, pyridyl or pyridyl substituted by one to four halogen atoms, or group A

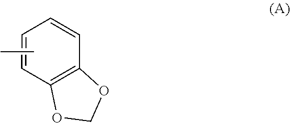

or group A substituted by one to four substituents independently selected from halogen, methyl and methoxy, even more preferably phenyl substituted by one to five substituents independently selected from halogen methyl and methoxy, or pyridyl or pyridyl substituted by one to four halogen atoms.

Each R⁷ is independently halogen, cyano, nitro, C₁-C₈alkyl, C₁-C₈haloalkyl, C₁-C₈alkoxy, C₁-C₈haloalkoxy, C₃-C₈ cycloalkyl, phenyl or phenyl substituted by one to five halogen, and wherein two R⁷ substituents on adjacent carbon atoms may together form a partially saturated 5-7 membered ring containing one or two heteroatoms selected from O, N(R⁸) and S; and each R⁸ is independently hydrogen or C₁-C₄ alkyl. Preferably each R⁷ is independently halogen, cyano, nitro, C₁-C₄alkyl, C₁-C₄haloalkyl, C₁-C₄alkoxy, or C₁-C₄haloalkoxy, and wherein any two R⁷ substituents on adjacent carbon atoms may together form a partially saturated 5 membered ring containing one or two O atoms, more preferably each R⁷ is independently halogen, methyl, halomethyl, methoxy or halomethoxy, and wherein any two R⁷ substituents on adjacent carbon atoms may together form a partially saturated 5 membered ring containing one or two O atoms, more preferably each R⁷ is independently halogen, methyl or methoxy, most preferably each R⁷ is independently fluorine, methyl or methoxy.

In one preferred group of compounds of formula III R⁶ is phenyl or phenyl substituted by one to five R⁷, naphthyl or naphthyl substituted by one to five R⁷, anthracenyl or anthracenyl substituted by one to five R⁷, or heteroaryl or heteroaryl substituted by one to four R⁷; each R⁷ is independently halogen, cyano, nitro, C₁-C₈alkyl, C₁-C₈haloalkyl, C₁-C₈alkoxy, C₁-C₈haloalkoxy, phenyl or phenyl substituted by one to five halogen, and wherein two R⁷ substituents on adjacent carbon atoms may together form a partially saturated 5-7 membered ring containing one or two heteroatoms selected from O, N(R⁸) and S; and each R⁸ is independently hydrogen or C₁-C₄ alkyl.

In another preferred group of compounds of formula III R⁶ is phenyl or phenyl substituted by one to five R⁷, anthracenyl or anthracenyl substituted by one to five R⁷, or pyrimidinyl or pyrimidinyl substituted by one to three R⁷; pyridyl or pyridyl substituted by one to four R⁷; and each R⁷ is independently halogen, cyano, nitro, C₁-C₄alkyl, C₁-C₄haloalkyl, C₁-C₄alkoxy, or C₁-C₄haloalkoxy, and wherein two R⁷ substituents on adjacent carbon atoms may together form a partially saturated 5-7 membered ring containing one or two O atoms.

In another preferred group of compounds of formula III R⁶ is phenyl or phenyl substituted by one to five R⁷, anthracenyl or anthracenyl substituted by one to five R⁷, or pyridyl or pyridyl substituted by one to four R⁷; and each R⁷ is independently halogen, cyano, nitro, C₁-C₄alkyl, C₁-C₄haloalkyl, C₁-C₄alkoxy, or C₁-C₄haloalkoxy, and wherein two R⁷ substituents on adjacent carbon atoms may together form a partially saturated 5-7 membered ring containing one or two O atoms.

In another preferred group of compounds of formula III R⁶ is phenyl or phenyl substituted by one to five R⁷, anthracenyl or anthracenyl substituted by one to five R⁷, or pyridyl or pyridyl substituted by one to four R⁷; and each R⁷ is independently halogen, methyl, halomethyl, methoxy or halomethoxy, and wherein any two R⁷ substituents on adjacent carbon atoms may together form a partially saturated 5 membered ring containing one or two O atoms.

In yet another preferred group of compounds of formula III R⁶ is phenyl or phenyl substituted by one to five substituents independently selected from halogen and methoxy, anthracenyl or anthracenyl substituted by one to five substituents independently selected from halogen and methoxy, pyridyl or pyridyl substituted by one to four halogen atoms, or group A

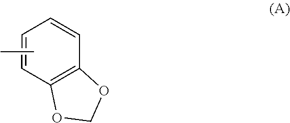

or group A substituted by one to four substituents independently selected from halogen and methoxy.

In yet another preferred group of compounds of formula III R⁶ is phenyl substituted by one to five R⁷, pyridy or pyridyl substituted by one to four R⁷, pyrimidyl or pyrimidinyl substituted by one to three R⁷, or group A

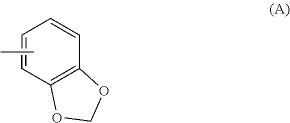

or group A substituted by one to four R⁷, and each R⁷ is independently halogen, nitro, C₁-C₄ alkyl or C₁-C₄ alkoxy.

In yet another preferred group of compounds of formula III R⁶ is phenyl substituted by one to five substituents independently selected from halogen, methyl and methoxy, or pyridyl or pyridyl substituted by one to four halogen atoms.

In yet another preferred group of compounds of formula III R⁶ is phenyl substituted by one to five substituents independently selected from fluorine, methyl and methoxy.

In yet another preferred group of compounds of formula III R⁶ is phenyl substituted by three to five substituents independently selected from fluorine, methyl and methoxy.

In yet another preferred group of compounds of formula III R⁶ is phenyl substituted by three to five methoxy groups.

In yet another preferred group of compounds of formula III R⁶ is phenyl substituted by three to five substituents independently selected from methyl and fluorine.

In yet another preferred group of compounds of formula III R⁶ is phenyl substituted by three to five substituents independently selected from methyl and fluorine, and no more than one substituent is methyl.

In yet another preferred group of compounds of formula III R⁶ is phenyl substituted by three to five fluorine atoms.

In yet another preferred group of compounds of formula III R⁶ is pyridyl or pyridyl substituted by two to four halogen atoms.

Most preferably the compound of formula III is a compound of formula IIIA, IIIB, IIIC, IIID, IIIE, IIIF, IIIG, IIIH, IIIJ, IIIK, IIIL, IIIM, IIIN or IIIO wherein X is an anion, preferably a halogen anion, more preferably chloride or bromide. In one embodiment the compound of formula III is a compound of IIIB, IIIC, IIIE, IIIF, IIIG, IIIH, IIIJ, IIIK, IIIL, IIIM, IIIN and IIIO, wherein X is an anion, preferably a halogen anion, more preferably chloride or bromide.

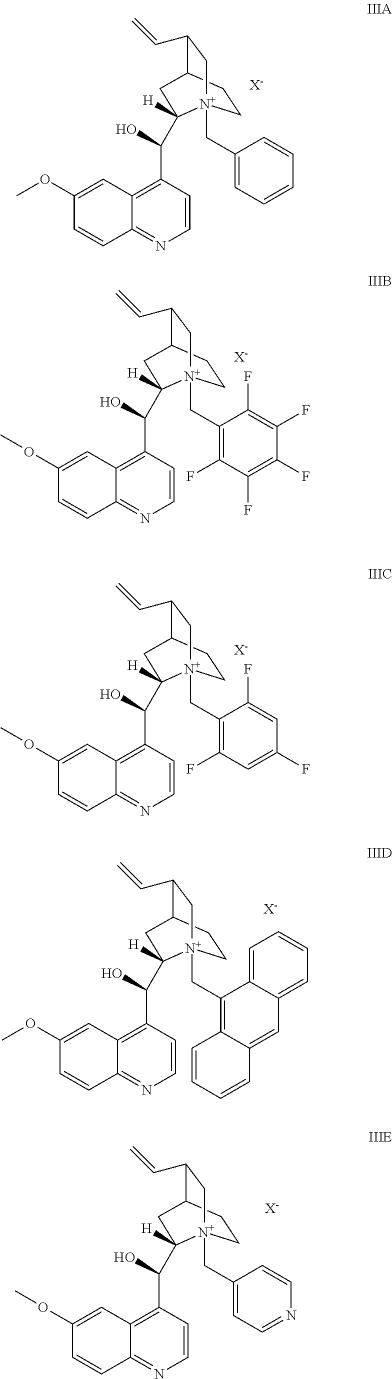

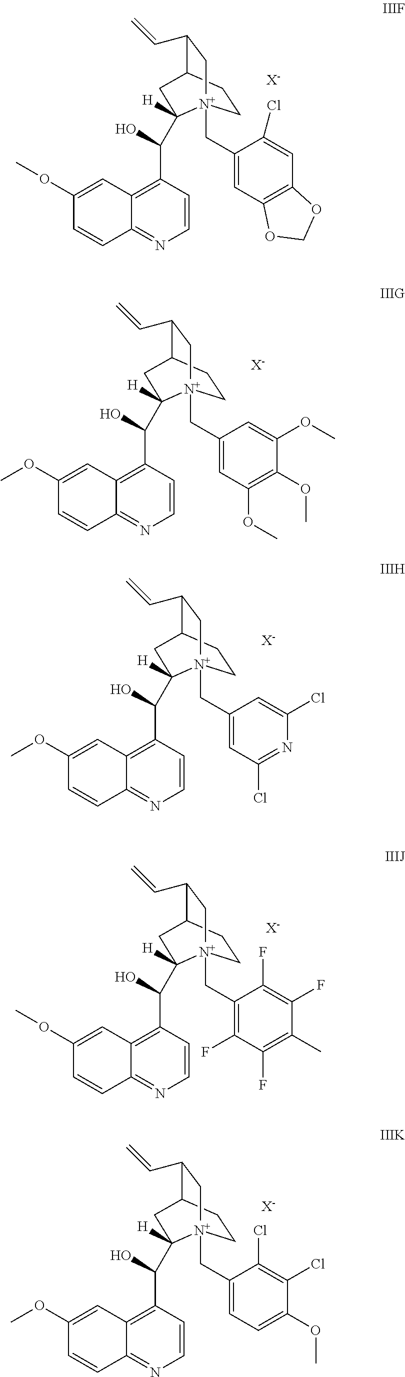

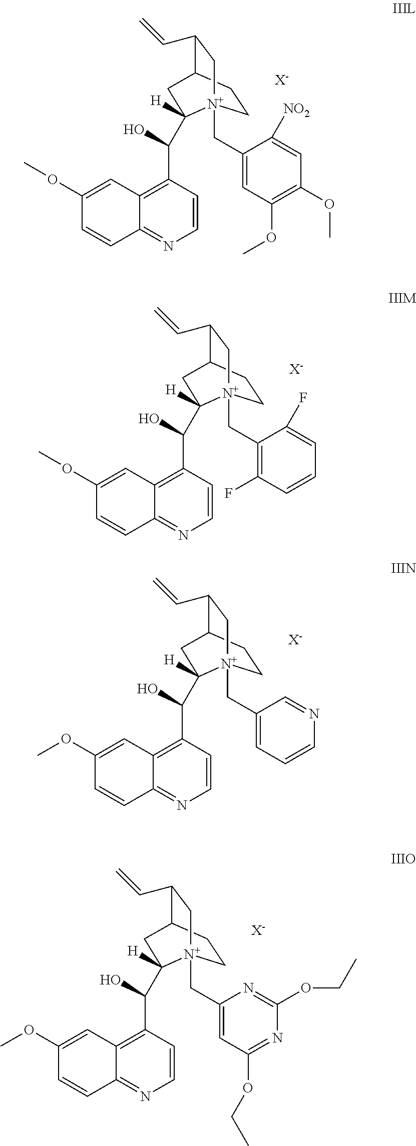

Compounds of formula IIIB, IIIG and IIIJ are preferred.

Some compounds of formula III are novel. Accordingly, in a further aspect the invention provides a compound of formula III*

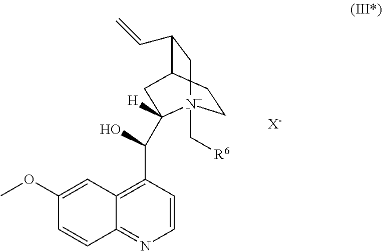

wherein R⁶ is 2,4,6-trifluorophenyl; phenyl substituted by one to five groups independently selected from methyl and fluorine, providing that the phenyl is substituted by at least one methyl and one fluorine; phenyl substituted by one to five groups independently selected from methoxy and nitro, providing that the phenyl is substituted by at least one methoxy and one nitro; phenyl substituted by one to five groups independently selected from methoxy and halogen, providing that the phenyl is substituted by at least one methoxy and one halogen; pyrimidinyl substituted by one to three groups independently selected from halogen, nitro, C₁-C₄ alkyl or C₁-C₄ alkoxy; pyridyl or pyridyl substituted by one to four halogen; or group A

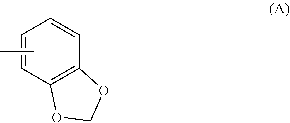

or group A substituted by one to four substituents independently selected from halogen and methoxy, and X is an anion, preferably a halogen anion, more preferably chloride or bromide.

Preferably R⁶ is 2,4,6-trifluorophenyl; phenyl substituted by three to five groups independently selected from methyl and fluorine, providing that the phenyl is substituted by at least one methyl and one fluorine; phenyl substituted by three to five groups independently selected from methoxy and nitro, providing that the phenyl is substituted by at least one methoxy and one nitro; phenyl substituted by three to five groups independently selected from methoxy and halogen, providing that the phenyl is substituted by at least one methoxy and one halogen; pyrimidinyl substituted by one to three C₁-C₄ alkoxy; pyridyl or pyridyl optionally substituted by two to four halogen; or group A

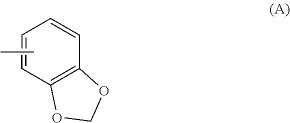

or group A substituted by one to four halogen, and X is an anion, preferably a halogen anion, more preferably chloride or bromide.

In another preferred group of compounds of formula III* R⁶ is 2,4,6-trifluorophenyl, phenyl substituted by three to five groups independently selected from methyl and fluorine, providing that the phenyl is substituted by at least one methyl and one fluorine; or pyridyl or pyridyl substituted by two to four halogen, preferably phenyl substituted by methyl and two to four fluorine atoms.

The invention includes the dissociated cation and N-oxides of the compounds of formula III.

Preferably the compound of formula III* is a compound of formula IIIC, IIIE, IIIF, IIIH, IIIJ, IIIK, IIIL, IIIN or IIIO, wherein X is an anion, preferably a halogen anion, more preferably chloride or bromide

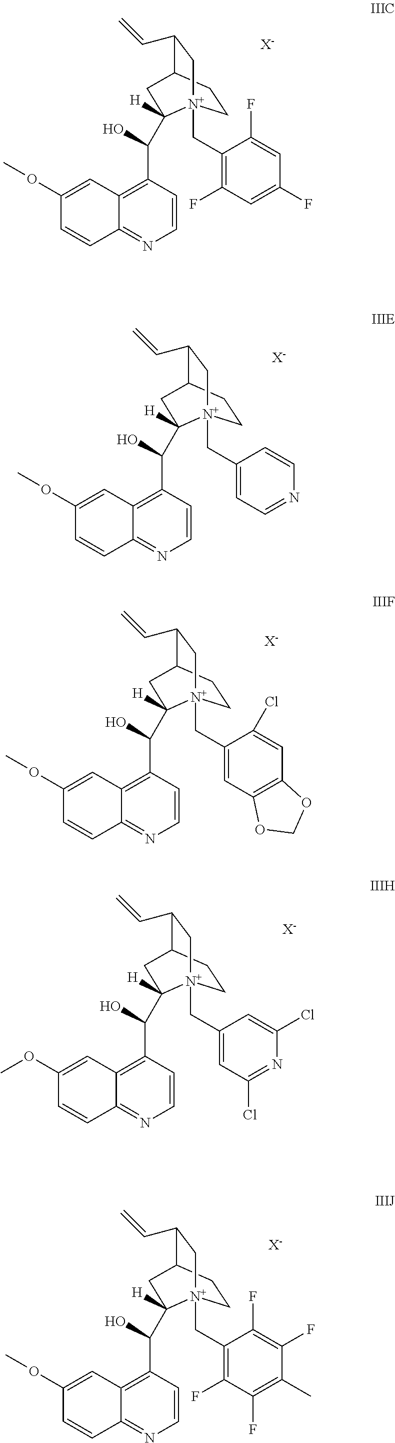

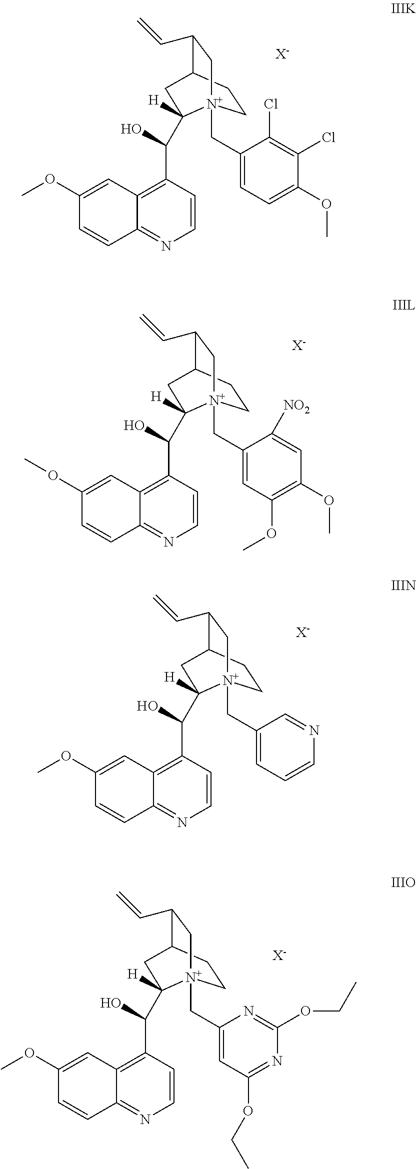

in particular a compound of formula IIIC, IIIE, IIIH or IIIJ more preferably a compound of formula IIIJ.

In a further aspect the invention provides a process for the preparation of a compound of formula III

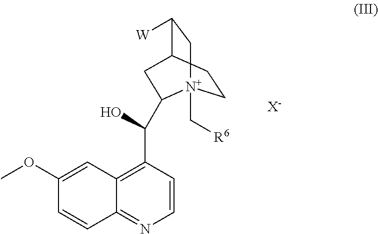

wherein R⁶ is optionally substituted aryl or optionally substituted heteroaryl and X is an anion, preferably a halogen anion, more preferably chloride or bromide;
comprising reacting a compound of formula IV

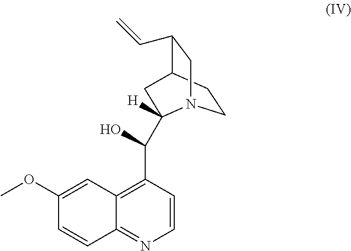 [SMILES: C=CC1CN2CCC1C[C@H]2[C@H](O)c1ccnc2ccc(OC)cc12]

with a compound of formula V

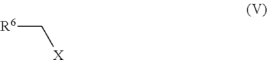

wherein R⁶ and X are as defined for the compound of formula III;
wherein the compound of formula III is for use in a process for the preparation of the compound of formula IB or enriched mixtures thereof. Preferably said process includes the preparation of said compound or mixture.

In a further aspect the invention provides a process for the preparation of a compound of formula III*

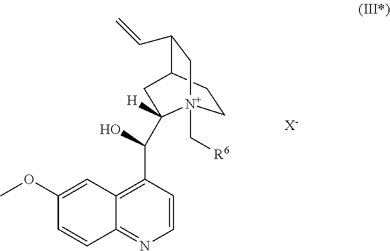

wherein R⁶ is 2,4,6-trifluorophenyl, phenyl substituted by one to five methoxy, pyridyl or pyridyl optionally substituted by one to four halogen, or group A

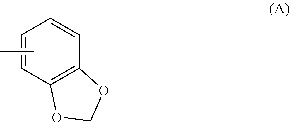

or group A substituted by one to four halogen, and X is an anion, preferably a halogen anion, more preferably chloride or bromide;
comprising reacting a compound of formula IV

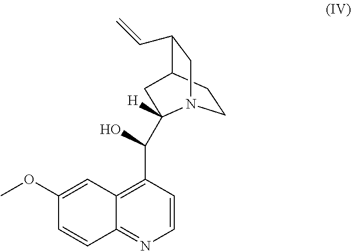 [SMILES: C=CC1CN2CCC1C[C@H]2[C@H](O)c1ccnc2ccc(OC)cc12]

with a compound of formula V

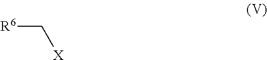

wherein R⁶ and X are as defined for the compound of formula III*.

Preferably processes for the preparation of a compound of formula III or III* are performed in an organic solvent, e.g. toluene.

In a further aspect the invention provides use of a compound of formula III as defined in herein as chiral phase transfer catalyst catalyst in the preparation of a compound of formula IB as defined herein, or a mixture of formula IA and IB as defined herein. In a further aspect the invention provides a process for the preparation of a compound of formula IB as defined herein, or a mixture of formula IA and IB as defined herein, comprising the step of reacting a beta-keto unsaturated carbonyl group with hydroxylamine in the presence of water, a base and a phase transfer catalyst, which phase transfer catalyst is a quinine derivative.

Processes for the preparation of the compound of formula IIB may also proceed via intermediates in which the heterocycle side chain is attached to the molecule after the stereoselective step. For example, a process for the preparation of the compound of formula IB may comprise reacting a compound of formula IX

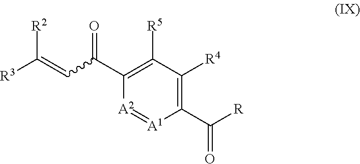

wherein R², R³, R⁴, R⁵, A¹ and A² are as defined for a compound of formula I and R is OH or C₁-C₆alkoxy;
or a compound of formula XVI

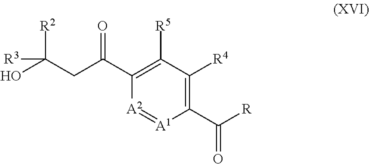

wherein R², R³, R⁴, R⁵, A¹ and A² are as defined for a compound of formula I and R is OH or C₁-C₆alkoxy;
with hydroxylamine in the presence of water, a base and a chiral phase transfer catalyst, which chiral phase transfer catalyst is a quinine derivative, for example a compound of formula III

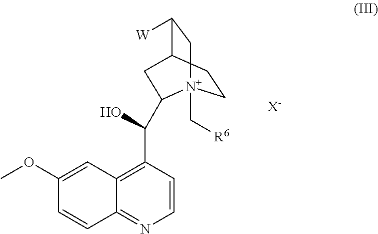

wherein R⁶ is optionally substituted aryl or optionally substituted heteroaryl, W is ethyl or vinyl, and X is an anion, preferably a halogen anion, more preferably chloride or bromide;
to form a compound of formula X

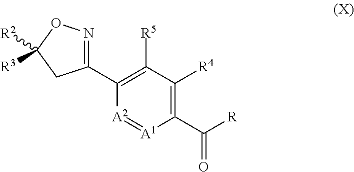

wherein R², R³, R⁴, R⁵, A¹ and A² are as defined for a compound of formula I and R is OH, or C₁-C₆alkoxy;
and reacting the compound of formula X with a compound of formula XI

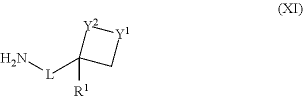

wherein R¹, L, Y¹ and Y² are as defined for a compound of formula I to give the compound of formula IB.

The process may include additional steps of converting the compound of formula X from a compound of formula X wherein R is OH to a compound of formula X wherein R is C₁-C₆alkoxy, or vice versa, or a step of converting a compound of formula X wherein R is R is OH, or C₁-C₆alkoxy to a compound of formula XIV

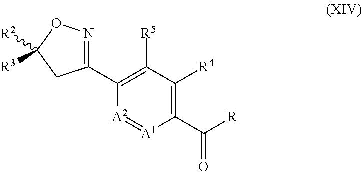

wherein R², R³, R⁴, R⁵, A¹ and A² are as defined for a compound of formula I and R is F, Cl or Br, prior to reacting the compound of formula X (or the compound of formula XIV) with a compound of formula XI.

For example, the process may include the step of converting a compound of formula X wherein R², R³, R⁴, R⁵, A¹ and A² are as defined for a compound of formula I and R is C₁-C₆alkoxy into a compound of formula X wherein R², R³, R⁴, R⁵, A¹ and A² are as defined for a compound of formula I and R is OH; and subsequently reacting the compound of formula X with a compound of formula XI

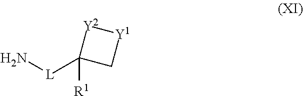

wherein R¹, L, Y¹ and Y² are as defined for a compound of formula I to give the compound of formula IB;
or the process may include the step of converting a compound of formula X wherein R², R³, R⁴, R⁵, A¹ and A² are as defined for a compound of formula I and R is OH or C₁-C₆alkoxy; into a compound of formula XIV

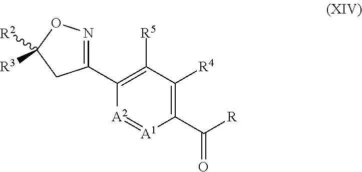

wherein R², R³, R⁴, R⁵, A¹ and A² are as defined for a compound of formula I and R is F, Cl, Br, and subsequently reacting the compound of formula XIV with a compound of formula XI

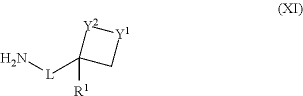

wherein R¹, L, Y¹ and Y² are as defined for a compound of formula I to give the compound of formula IB.

A process for the preparation of the compound of formula IB may alternatively comprise reacting a compound of formula XII

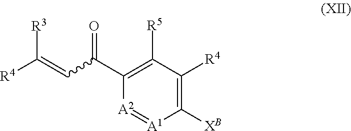

wherein R², R³, R⁴, R⁵, A¹ and A² are as defined for a compound of formula I and X^{B} is a leaving group, e.g. a halogen, such as bromo;
or a compound of formula XVII

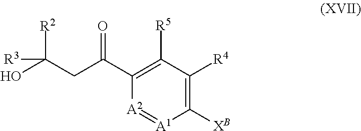

wherein R², R³, R⁴, R⁵, A¹ and A² are as defined for a compound of formula I and X^{B} is a leaving group, e.g. a halogen, such as bromo;
with hydroxylamine in the presence of water, a base and a chiral phase transfer catalyst, which chiral phase transfer catalyst is a quinine derivative, for example a compound of formula III

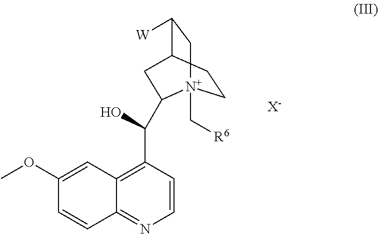

wherein R⁶ is optionally substituted aryl or optionally substituted heteroaryl, W is ethyl or vinyl, and X is an anion, preferably a halogen anion, more preferably chloride or bromide;
to give a compound of formula XIII

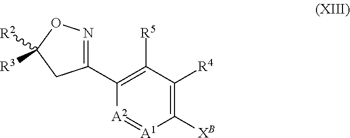

and either reacting the compound of formula XIII with carbon monoxide and R—H, wherein R is OH or C₁-C₆alkoxy; to form a compound of formula X

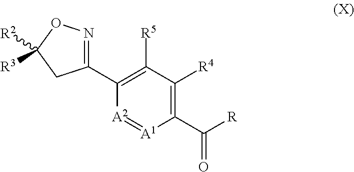

wherein R², R³, R⁴, R⁵, A¹ and A² are as defined for a compound of formula I and R is OH or C₁-C₆alkoxy;
and subsequently reacting the compound of formula X with a compound of formula XI

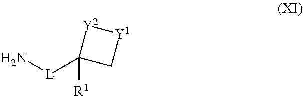

wherein R¹, L, Y¹ and Y² are as defined for a compound of formula I;
to give the more biologically active enantiomer of the compound of formula I;
or reacting the compound of formula XIII with carbon monoxide and a compound of formula XI

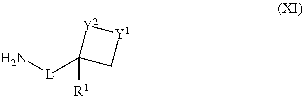

wherein R¹, L, Y¹ and Y² are as defined for a compound of formula I;
to give the more biologically active enantiomer of the compound of formula I.

Likewise, this alternative process may include additional steps of converting the compound of formula X from a compound of formula X wherein R is OH to a compound of formula X wherein R is C₁-C₆alkoxy, or vice versa, or a step of converting a compound of formula X wherein R is R is OH, or C₁-C₆alkoxy to a compound of formula XIV

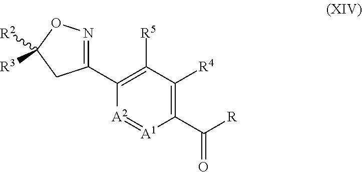

wherein R², R³, R⁴, R⁵, A¹ and A² are as defined for a compound of formula I and R is F, Cl or Br, prior to reacting the compound of formula X (or the compound of formula XIV) with a compound of formula XI.

The preferred values of R², R³, R⁴, R⁵, A¹, A², R¹, L, Y¹ and Y² in the compounds of formula IX, X, XI, XII, XIII, XIV, XV, XVI and XVII are the same as the preferred values for compounds of formula I.

Processes for the preparation of the more biologically active enantiomer of the compound of formula I (formula IB) in which the heterocyclic side chain is attached to the molecule after the stereoselective step similarly relate to processes for the preparation of a mixture comprising the two enantiomers of the compound of formula I (formula IA and IB)

In compounds of formula X R is preferably OH.

Preferred compounds of formula I are as set out below:

In one preferred group of compounds of formula I Y¹ is S and Y² is CH₂.

In another preferred group of compounds of formula I Y¹ is SO and Y² is CH₂.

In another preferred group of compounds of formula I Y¹ is SO₂ and Y² is CH₂.

In another preferred group of compounds of formula I Y² is S and Y¹ is CH₂.

In another preferred group of compounds of formula I Y² is SO and Y¹ is CH₂.

In another preferred group of compounds of formula I Y² is SO₂ and Y¹ is CH₂.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; and R⁴ and R⁵ together form a bridging 1,3-butadiene group.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; and R⁴ and R⁵ together form a bridging 1,3-butadiene group.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; and R⁴ and R⁵ together form a bridging 1,3-butadiene group.

In yet another preferred group of compounds of formula I L is a direct bond or methylene; one of Y¹ and Y² is S and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

Preferably when L is a direct bond Y² is CH₂ and Y¹ is S, SO or SO₂ and when L is methylene Y² is S, SO or SO₂ and Y¹ is CH₂.

In processes of the invention where Y¹ or Y² is S the compound of formula IB, the process may include the additional step of oxidising the S to SO or SO₂.

Each substituent definition in each preferred group of compounds of formula I may be juxtaposed with any substituent definition in any other preferred group of compounds, in any combination. Preferred compounds of formula II correspond to the preferred compounds of formula I.

Preferred compounds of formula I are shown in the Table below.

TABLE A
Compounds of formula I(a)

| | |
|---|---|
| | (Ia) |
| 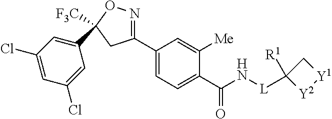 | |

| Comp | | | | |
|---|---|---|---|---|
| No. | L | R¹ | Y¹ | Y² |
| 1 | bond | CH₃ | S | CH₂ |
| 2 | bond | CH₃ | SO (cis) | CH₂ |
| 3 | bond | CH₃ | SO (trans) | CH₂ |
| 4 | bond | CH₃ | SO₂ | CH₂ |
| 5 | bond | H | S | CH₂ |
| 6 | bond | H | SO (cis) | CH₂ |
| 7 | bond | H | SO (trans) | CH₂ |
| 8 | bond | H | SO₂ | CH₂ |
| 9 | CH₂ | CH₃ | CH₂ | S |
| 10 | CH₂ | CH₃ | CH₂ | SO (cis) |
| 11 | CH₂ | CH₃ | CH₂ | SO (trans) |
| 12 | CH₂ | CH₃ | CH₂ | SO₂ |
| 13 | CH₂ | H | CH₂ | S |
| 14 | CH₂ | H | CH₂ | SO (cis) |
| 15 | CH₂ | H | CH₂ | SO (trans) |
| 16 | CH₂ | H | CH₂ | SO₂ |

Bearing in mind the stereocentre which is the subject of the invention, the invention otherwise includes all isomers of compounds of formula I (including formula IA and IB) and salts and N-oxides thereof, including enantiomers, diastereomers and tautomers. The more biologically active enantiomer (i.e. the compound of formula IB relative to the compound of formula IA) may be a mixture of any type of isomer of a compound of formula I, or may be substantially a single type of isomer. For example, where Y¹ or Y² is SO, the more biologically active enantiomer may be a mixture of the cis and trans isomer in any ratio, e.g. in a molar ratio of 1:99 to 99:1, e.g. 10:1 to 1:10, e.g. a substantially 50:50 molar ratio, e.g. in some cases the mixture may be cis enriched, in other cases the mixture may be trans enriched. For example, in trans enriched mixtures of the more biologically active enantiomer, e.g. when Y¹ or Y² is SO, the molar proportion of the trans compound in the mixture compared to the total amount of both cis and trans is for example greater than 50%, e.g. at least 55, 60, 65, 70, 75, 80, 85, 90, 95, 96, 97, 98, or at least 99%, e.g. mixtures may be at least 60% enantiomerically enriched for formula IB and at least 60, 70, 80, or at least 90% enriched for trans SO, e.g. at least 70% enantiomerically enriched for formula IB and at least 60, 70, 80, or at least 90% enriched for trans SO, e.g. at least 80% enantiomerically enriched for formula IB and at least 60, 70, 80, or at least 90% enriched for trans SO, e.g. at least 90% enantiomerically enriched for formula IB and at least 60, 70, 80, or at least 90% enriched for trans SO. Likewise, in cis enriched mixtures (preferred) of the more biologically active enantiomer, e.g. when Y¹ or Y² is SO, the molar proportion of the cis compound in the mixture compared to the total amount of both cis and trans is for example greater than 50%, e.g. at least 55, 60, 65, 70, 75, 80, 85, 90, 95, 96, 97, 98, or at least 99%, e.g. at least 60% enantiomerically enriched for formula IB and at least 60, 70, 80, or at least 90% enriched for cis SO, e.g. at least 70% enantiomerically enriched for formula IB and at least 60, 70, 80, or at least 90% enriched for cis SO, e.g. at least 80% enantiomerically enriched for formula IB and at least 60, 70, 80, or at least 90% enriched for cis SO, e.g. at least 90% enantiomerically enriched for formula IB and at least 60, 70, 80, or at least 90% enriched for cis SO). Y¹ or Y² is SO for compounds 2, 3, 6, 7, 10, 11, 14 and 15 in Table A.

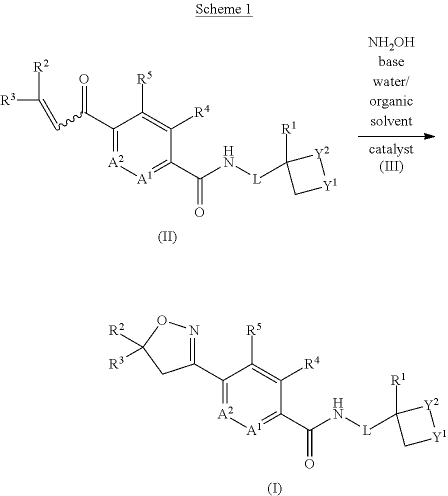

Enantioenriched compounds of formula (I) can be prepared by reacting a compound of formula (II) with hydroxylamine in the presence of a chiral phase transfer catalyst derived from quinine in a mixture of water and an organic solvent, as shown in Scheme 1. In some cases it should be possible to perform the reaction in the absence of an organic solvent, e.g. when the compound of formula II forms an immiscible liquid phase with water. However such reactions are preferably carried out in a suitable organic solvent, for example dichloromethane, 1,2-dichloroethane, toluene, preferably 1,2-dichloroethane at a temperature of between −78° C. to 60° C., preferably between −20° C. and +20° C., and at a dilution of e.g. between 0.1 M to 1 M. The reaction time is usually between 30 minutes and 48 hours, preferably between 1 and 4 hours. The amount of catalyst is usually between 0.1 and 0.4 molar equivalents, preferably between 0.1 and 0.2 molar equivalents. The amount of hydroxylamine is usually between 1 and 20 equivalents, preferably between 2 and 6 equivalents. Such reactions are usually carried out in the presence of a base. Suitable bases include alkali hydroxides such as lithium hydroxide, sodium hydroxide or potassium hydroxide, preferably sodium hydroxide, in usual amounts of between 1 and 10 equivalents, although sub-stoichiometric amounts can be used. Preferably the amount of base used is between 2 and 6 equivalents.

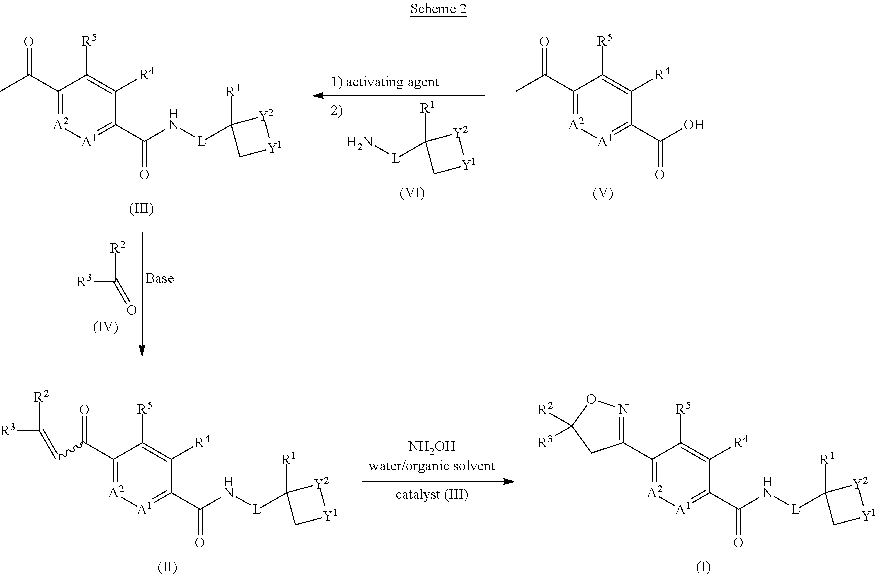

The compound of formula II may be prepared according to scheme 2, e.g. as described in WO2009/080250.

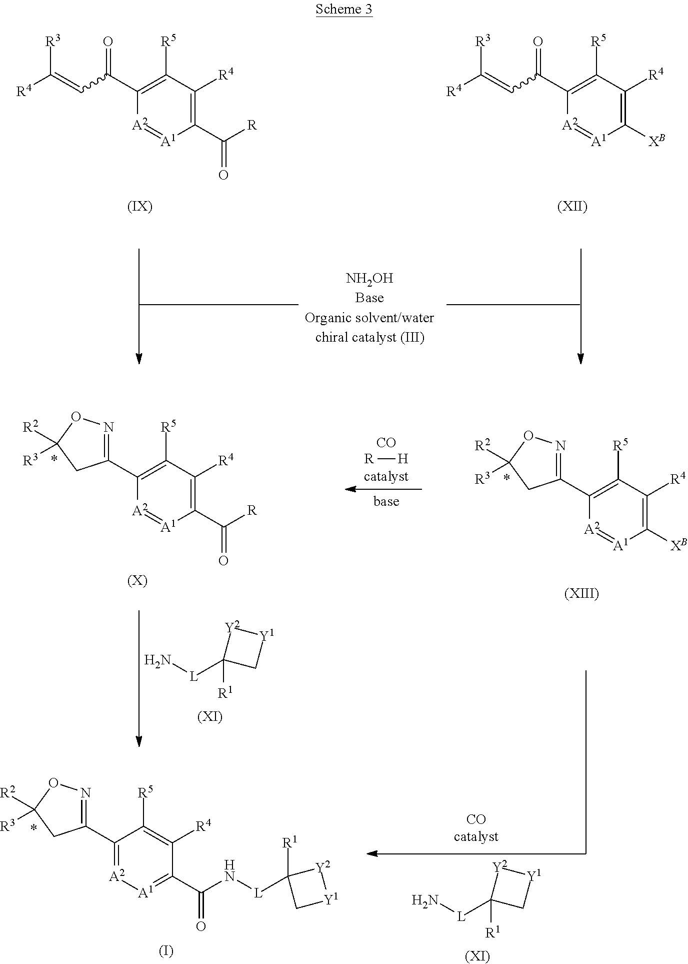

Alternatively, the more biologically active enantiomer of the compound of formula I can be prepared selectively from compounds of formula (IX) wherein R is OH or C₁-C₆alkoxy and (XII) wherein X^{B} is a leaving group, for example a halogen, such as bromo, using an asymmetric reaction similar to that used for conversion of (II) to the more biologically active enantiomer of (I) as shown on Scheme 3. In that case, compounds of formula (X) and (XIII) are obtained enantioselectively and can be converted to compounds of formula (I) using the following methods:

1) Compounds of formula (I) wherein G¹ is oxygen, can be prepared by reacting a compound of formula (X) wherein R is OH, C₁-C₆alkoxy or Cl, F or Br, with an amine of formula (XI) as shown in Scheme 3. When R is OH such reactions are usually carried out in the presence of a coupling reagent, such as N,N′-dicyclohexylcarbodiimide (“DCC”), 1-ethyl-3-(3-dimethylamino-propyl)carbodiimide hydrochloride (“EDC”) or bis(2-oxo-3-oxazolidinyl)phosphonic chloride (“BOP-Cl”), in the presence of a base, and optionally in the presence of a nucleophilic catalyst, such as hydroxybenzotriazole (“HOBT”). When R is Cl, such reactions are usually carried out in the presence of a base, and optionally in the presence of a nucleophilic catalyst. Alternatively, it is possible to conduct the reaction in a biphasic system comprising an organic solvent, preferably ethyl acetate, and an aqueous solvent, preferably a solution of sodium hydrogen carbonate. When R is C₁-C₆alkoxy it is sometimes possible to convert the ester directly to the amide by heating the ester and amine together in a thermal process. Suitable bases include pyridine, triethylamine, 4-(dimethylamino)-pyridine (“DMAP”) or diisopropylethylamine (Hunig's base). Preferred solvents are N,N-dimethylacetamide, tetrahydrofuran, dioxane, 1,2-dimethoxyethane, ethyl acetate and toluene. The reaction is carried out at a temperature of from 0° C. to 100° C., preferably from 15° C. to 30° C., in particular at ambient temperature. Amines of formula (XII) are known in the literature or can be prepared using methods known to a person skilled in the art.

2) Acid halides of formula (X), wherein R is Cl, F or Br, may be made from carboxylic acids of formula (X), wherein R is OH, under standard conditions, such as treatment with thionyl chloride or oxalyl chloride. A preferred solvent is dichloromethane. The reaction is carried out at a temperature of from 0° C. to 100° C., preferably from 15° C. to 30° C., in particular at ambient temperature.

3) Carboxylic acids of formula (X), wherein R is OH, may be formed from esters of formula (X), wherein G¹ is oxygen and R is C₁-C₆alkoxy. It is known to a person skilled in the art that there are many methods for the hydrolysis of such esters depending on the nature of the alkoxy group. One widely used method to achieve such a transformation is the treatment of the ester with an alkali hydroxide, such as lithium hydroxide, sodium hydroxide or potassium hydroxide, in a solvent, such as ethanol or tetrahydrofuran, in the presence of water. Another is the treatment of the ester with an acid, such as trifluoroacetic acid, in a solvent, such as dichloromethane, followed by addition of water. The reaction is carried out at a temperature of from 0° C. to 150° C., preferably from 15° C. to 100° C., in particular at 50° C.

4) Compounds of formula (X) wherein R is C₁-C₆alkoxy, can be prepared by reacting a compound of formula (XII) wherein X^{B} is a leaving group, for example a halogen, such as bromo, with carbon monoxide and an alcohol of formula R—OH, such as ethanol, in the presence of a catalyst, such as bis(triphenylphosphine)palladium(II) dichloride, and a base, such as pyridine, triethylamine, 4-(dimethylamino)-pyridine (“DMAP”) or diisopropylethylamine (Hunig's base). The reaction is carried out at a temperature of from 50° C. to 200° C., preferably from 100° C. to 150° C., in particular at 115° C. The reaction is carried out at a pressure of from 50 to 200 bar, preferably from 100 to 150 bar, in particular at 120 bar.

5) Alternatively, compounds of formula (I) can be prepared by reacting a compound of formula (XIII) wherein X^{B} is a leaving group, for example a halogen, such as bromo, with carbon monoxide and an amine of formula (XI), in the presence of a catalyst, such as palladium(II) acetate or bis(triphenylphosphine)palladium(II) dichloride, optionally in the presence of a ligand, such as triphenylphosphine, and a base, such as sodium carbonate, pyridine, triethylamine, 4-(dimethylamino)-pyridine (“DMAP”) or diisopropyl-ethylamine (Hunig's base), in a solvent, such as water, N,N-dimethylformamide or tetrahydrofuran. The reaction is carried out at a temperature of from 50° C. to 200° C., preferably from 100° C. to 150° C. The reaction is carried out at a pressure of from 50 to 200 bar, preferably from 100 to 150 bar.

The biologically active enantiomers of compounds of formula (I) and enantiomerically enriched mixtures thereof can be used to combat and control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are hereinafter collectively referred to as pests. The pests which may be combated and controlled by the use of the invention compounds include those pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies).

In a further aspect the invention provides a method of protecting an animal from a parasitic invertebrate pest comprising administering to the animal a pesticidally effective amount of a compound or enantiomerically enriched mixture of the invention. In a further aspect the invention provides a compound or enantiomerically enriched mixture of the invention for use in protecting an animal from a parasitic invertebrate pest. In a further aspect the invention provides use of a compound or enantiomerically enriched mixture of the invention in the manufacture of a medicament for protecting an animal from a parasitic invertebrate pest.

In a further aspect the invention provides a method of treating an animal suffering from a parasitic invertebrate pest comprising administering to the animal a pesticidally effective amount of a compound or enantiomerically enriched mixture of the invention. In a further aspect the invention provides a compound or enantiomerically enriched mixture of the invention for use in treating an animal suffering from a parasitic invertebrate pest. In a further aspect the invention provides use of a compound or enantiomerically enriched mixture of the invention in the manufacture of a medicament for treating an animal suffering from a parasitic invertebrate pest.

Examples of pest species which may be controlled by the biologically active enantiomers of compounds of formula (I) and enantiomerically enriched mixtures thereof include: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides fells (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonic (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The compounds of the invention may be used for pest control on various plants, including soybean (e.g. 10-70 g/ha), corn (e.g. 10-70 g/ha), sugarcane (e.g. 20-200 g/ha), alfalfa (e.g. 10-70 g/ha), brassicas (e.g. 10-50 g/ha), oilseed rape (e.g. canola) (e.g. 20-70 g/ha), potatoes (including sweet potatoes) (e.g. 10-70 g/ha), cotton (e.g. 10-70 g/ha), rice (e.g. 10-70 g/ha), coffee (e.g. 30-150 g/ha), citrus (e.g. 60-200 g/ha), almonds (e.g. 40-180 g/ha), fruiting vegetables (e.g. tomatoes, pepper, chili, eggplant, cucumber, squash etc.) (e.g. 10-80 g/ha), tea (e.g. 20-150 g/ha), bulb vegetables (e.g. onion, leek etc.) (e.g. 30-90 g/ha), grapes (e.g. 30-180 g/ha), pome fruit (e.g. apples, pears etc.) (e.g. 30-180 g/ha), and stone fruit (e.g. pears, plums etc.) (e.g. 30-180 g/ha).

The compounds of the invention may be used on soybean to control, for example, Elasmopalpus lignosellus, Diloboderus abderus, Diabrotica speciosa, Sternechus subsignatus, Formicidae, Agrotis ypsilon, Julus ssp., Anticarsia gemmatalis, Megascelis ssp., Procornitermes ssp., Gryllotalpidae, Nezara viridula, Piezodorus spp., Acrosternum spp., Neomegalotomus spp., Cerotoma trifurcata, Popillia japonica, Edessa spp., Liogenys fuscus, Euchistus heros, stalk borer, Scaptocoris castanea, phyllophaga spp., Pseudoplusia includens, Spodoptera spp., Bemisia tabaci, Agriotes spp. The compounds of the invention are preferably used on soybean to control Diloboderus abderus, Diabrotica speciosa, Nezara viridula, Piezodorus spp., Acrosternum spp., Cerotoma trifurcata, Popillia japonica, Euchistus heros, phyllophaga spp., Agriotes spp.

The compounds of the invention may be used on corn to control, for example, Euchistus heros, Dichelops furcatus, Diloboderus abderus, Elasmopalpus lignosellus, Spodoptera frugiperda, Nezara viridula, Cerotoma trifurcata, Popillia japonica, Agrotis ypsilon, Diabrotica speciosa, Heteroptera, Procornitermes ssp., Scaptocoris castanea, Formicidae, Julus ssp., Dalbulus maidis, Diabrotica virgifera, Mocis latipes, Bemisia tabaci, heliothis spp., Tetranychus spp., thrips spp., phyllophaga spp., scaptocoris spp., Liogenys fuscus, Spodoptera spp., Ostrinia spp., Sesamia spp., Agriotes spp. The compounds of the invention are preferably used on corn to control Euchistus heros, Dichelops furcatus, Diloboderus abderus, Nezara viridula, Cerotoma trifurcata, Popillia japonica, Diabrotica speciosa, Diabrotica virgifera, Tetranychus spp., thrips spp., phyllophaga spp., scaptocoris spp., Agriotes spp.

The compounds of the invention may be used on sugar cane to control, for example, Sphenophorus spp., termites, Mahanarva spp. The compounds of the invention are preferably used on sugar cane to control termites, Mahanarva spp.

The compounds of the invention may be used on alfalfa to control, for example, Hypera brunneipennis, Hypera postica, Colias eurytheme, Collops spp., Empoasca solana, Epitrix, Geocoris spp., Lygus hesperus, Lygus lineolaris, Spissistilus spp., Spodoptera spp., Trichoplusia ni. The compounds of the invention are preferably used on alfalfa to control Hypera brunneipennis, Hypera postica, Empoasca solana, Epitrix, Lygus hesperus, Lygus lineolaris, Trichoplusia ni.

The compounds of the invention may be used on brassicas to control, for example, Plutella xylostella, Pieris spp., Mamestra spp., Plusia spp., Trichoplusia ni, Phyllotreta spp., Spodoptera spp., Empoasca solana, thrips spp., Spodoptera spp., Delia spp. The compounds of the invention are preferably used on brassicas to control Plutella xylostella, Pieris spp., Plusia spp., Trichoplusia ni, Phyllotreta spp., thrips spp.

The compounds of the invention may be used on oil seed rape, e.g. canola, to control, for example, Meligethes sp, Ceutorhynchus napi, Psylloides sp.

The compounds of the invention may be used on potatoes, including sweet potatoes, to control, for example, Empoasca sp, Leptinotarsa sp, Diabrotica speciosa, Phthorimaea sp, Paratrioza sp, Maladera matrida, Agriotes sp. The compounds of the invention are preferably used on potatoes, including sweet potatoes, to control Empoasca sp, Leptinotarsa sp, Diabrotica speciosa, Phthorimaea sp, Paratrioza sp, Agriotes sp.

The compounds of the invention may be used on cotton to control, for example, Anthonomus grandis, Pectinophora sp, heliothis sp, Spodoptera sp, Tetranychus sp, Empoasca sp, thrips sp, Bemisia tabaci, Lygus sp, phyllophaga sp, Scaptocoris sp. The compounds of the invention are preferably used on cotton to control Anthonomus grandis, Tetranychus sp, Empoasca sp, thrips sp, Lygus sp, phyllophaga sp, Scaptocoris sp.

The compounds of the invention may be used on rice to control, for example, Leptocorisa sp, Cnaphalocrosis sp, Chilo sp, Scirpophaga sp, Lissorhoptrus sp, Oebalus pugnax. The compounds of the invention are preferably used on rice to control Leptocorisa sp, Lissorhoptrus sp, Oebalus pugnax.

The compounds of the invention may be used on coffee to control, for example, Hypothenemus Hampei, Perileucoptera Coffeella, Tetranychus sp. The compounds of the invention are preferably used on coffee to control Hypothenemus Hampei, Perileucoptera Coffeella.

The compounds of the invention may be used on citrus to control, for example, Panonychus citri, Phyllocoptruta oleivora, Brevipalpus sp, Diaphorina citri, Scirtothrips sp, thrips sp, Unaspis sp, Ceratitis capitata, Phyllocnistis sp. The compounds of the invention are preferably used on citrus to control Panonychus citri, Phyllocoptruta oleivora, Brevipalpus sp, Diaphorina citri, Scirtothrips sp, thrips sp, Phyllocnistis sp.

The compounds of the invention may be used on almonds to control, for example, Amyelois transitella, Tetranychus sp.

The compounds of the invention may be used on fruiting vegetable, including tomatoes, pepper, chili, eggplant, cucumber, squash etc, to control thrips sp, Tetranychus sp, Polyphagotarsonemus sp, Aculops sp, Empoasca sp, Spodoptera sp, heliothis sp, Tuta absoluta, Liriomyza sp, Bemisia tabaci, Trialeurodes sp, Paratrioza sp, Frankliniella occidentalis, Frankliniella sp, Anthonomus sp, Phyllotreta sp, Amrasca sp, Epilachna sp, Halyomorpha sp, Scirtothrips sp, Leucinodes sp, Neoleucinodes sp. The compounds of the invention are preferably used on fruiting vegetable, including tomatoes, pepper, chili, eggplant, cucumber, squash etc, to control, for example, thrips sp, Tetranychus sp, Polyphagotarsonemus sp, Aculops sp, Empoasca sp, Spodoptera sp, heliothis sp, Tuta absoluta, Liriomyza sp, Paratrioza sp, Frankliniella occidentalis, Frankliniella sp, Amrasca sp, Scirtothrips sp, Leucinodes sp, Neoleucinodes sp.

The compounds of the invention may be used on tea to control, for example, Pseudaulacaspis sp, Empoasca sp, Scirtothrips sp, Caloptilia theivora. The compounds of the invention are preferably used on tea to control Empoasca sp, Scirtothrips sp.

The compounds of the invention may be used on bulb vegetables, including onion, leek etc to control, for example, thrips sp, Spodoptera sp, heliothis sp. The compounds of the invention are preferably used on bulb vegetables, including onion, leek etc to control thrips sp.

The compounds of the invention may be used on grapes to control, for example, Empoasca sp, Lobesia sp, Frankliniella sp, thrips sp, Tetranychus sp, Rhipiphorothrips Cruentatus, Eotetranychus Willamettei, Erythroneura Elegantula, Scaphoides sp. The compounds of the invention are preferably used on grapes to control Frankliniella sp, thrips sp, Tetranychus sp, Rhipiphorothrips Cruentatus, Scaphoides sp.

The compounds of the invention may be used on pome fruit, including apples, pairs etc, to control, for example, Cacopsylla sp, Psylla sp, Panonychus ulmi, Cydia pomonella. The compounds of the invention are preferably used on pome fruit, including apples, pairs etc, to control Cacopsylla sp, Psylla sp, Panonychus ulmi.

The compounds of the invention may be used on stone fruit to control, for example, Grapholita molesta, Scirtothrips sp, thrips sp, Frankliniella sp, Tetranychus sp. The compounds of the invention are preferably used on stone fruit to control Scirtothrips sp, thrips sp, Frankliniella sp, Tetranychus sp.

The invention therefore provides a method of combating and/or controlling insects, acarines, nematodes or molluscs which comprises applying an insecticidally, acaricidally, nematicidally or molluscicidally effective amount of the more biologically active enantiomer of a compound of formula (I) or an enantiomerically enriched mixture thereof, or a composition containing the same, to a pest, to a locus of a pest, preferably a plant, to a plant susceptible to attack by a pest or to plant propagation material susceptible to attack by a pest. The more biologically active enantiomers of compounds of formula (I) and enantiomerically enriched mixtures thereof are preferably used against insects, acarines or nematodes.

The term “plant” as used herein includes seedlings, bushes and trees.

The term “plant propagation material” is understood to denote generative parts of a plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

Crops are to be understood as also including those crops which have been rendered tolerant to herbicides or classes of herbicides (e.g. ALS-, GS-, EPSPS-, PPO- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK®(Syngenta Seeds). Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®.

Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood as being those which are obtained by conventional methods of breeding or genetic engineering and contain so-called output traits (e.g. improved storage stability, higher nutritional value and improved flavor).

In order to apply the biologically more active enantiomer of a compound of formula (I) or an enantiomerically enriched mixture thereof as an insecticide, acaricide, nematicide or molluscicide to a pest, a locus of pest, or to a plant susceptible to attack by a pest, said compound or mixture is usually formulated into a composition which includes, in addition to said compound or mixture a suitable inert diluent or carrier and, optionally, a surface active agent (SFA). SFAs are chemicals which are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of the more biologically active enantiomer of a compound of formula (I) or enantiomerically enriched mixture thereof. The composition is generally used for the control of pests such that the compound of mixture is applied at a rate of from 0.1 g to 10 kg per hectare, preferably from 1 g to 6 kg per hectare, more preferably from 1 g to 1 kg per hectare.

When used in a seed dressing, the compound of mixture is used at a rate of 0.0001 g to 10 g (for example 0.001 g or 0.05 g), preferably 0.005 g to 10 g, more preferably 0.005 g to 4 g, per kilogram of seed.

In another aspect the present invention provides an insecticidal, acaricidal, nematicidal or molluscicidal composition comprising an insecticidally, acaricidally, nematicidally or molluscicidally effective amount of the more biologically active enantiomer of a compound of formula (I) or enantiomerically enriched mixture thereof and a suitable carrier or diluent therefor. The composition is preferably an insecticidal, acaricidal, nematicidal or molluscicidal composition.

The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the compound of formula (I).

Dustable powders (DP) may be prepared by mixing compounds or enantiomerically enriched mixtures of the invention with one or more solid diluents (for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers) and mechanically grinding the mixture to a fine powder.

Soluble powders (SP) may be prepared by mixing compounds or enantiomerically enriched mixtures of the invention with one or more water-soluble inorganic salts (such as sodium bicarbonate, sodium carbonate or magnesium sulfate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing compounds or enantiomerically enriched mixtures of the invention with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating compounds or enantiomerically enriched mixtures of the invention with one or more powdered solid diluents or carriers, or from pre-formed blank granules by absorbing compounds and enantiomerically enriched mixtures of the invention (or a solution thereof, in a suitable agent) in a porous granular material (such as pumice, attapulgite clays, fuller's earth, kieselguhr, diatomaceous earths or ground corn cobs) or by adsorbing compounds and enantiomerically enriched mixtures of the invention (or a solution thereof, in a suitable agent) on to a hard core material (such as sands, silicates, mineral carbonates, sulfates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving compounds or enantiomerically enriched mixtures of the invention in water or an organic solvent, such as a ketone, alcohol or glycol ether. These solutions may contain a surface active agent (for example to improve water dilution or prevent crystallization in a spray tank).

Emulsifiable concentrates (EC) or oil-in-water emulsions (EW) may be prepared by dissolving a compound of formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining the compounds or mixtures of the invention either as a liquid (if it is not a liquid at room temperature, it may be melted at a reasonable temperature, typically below 70° C.) or in solution (by dissolving it in an appropriate solvent) and then emulsifiying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. Compounds or enantiomerically enriched mixtures of the invention are present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of compounds or enantiomerically enriched mixtures of the invention. SCs may be prepared by ball or bead milling the solid compounds or enantiomerically enriched mixtures of the invention in a suitable medium, optionally with one or more dispersing agents, to produce a fine particle suspension of the compound. One or more wetting agents may be included in the composition and a suspending agent may be included to reduce the rate at which the particles settle. Alternatively, the compounds and mixtures of the invention may be dry milled and added to water, containing agents hereinbefore described, to produce the desired end product.

Aerosol formulations comprise a compound or enantiomerically enriched mixture of the invention and a suitable propellant (for example n-butane). A compound or mixture of the invention may also be dissolved or dispersed in a suitable medium (for example water or a water miscible liquid, such as n-propanol) to provide compositions for use in non-pressurized, hand-actuated spray pumps.

A compound or enantiomerically enriched mixture of the invention may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerization stage such that an aqueous dispersion of oil droplets is obtained, in which each oil droplet is encapsulated by a polymeric shell and contains a compound or mixture of the invention and, optionally, a carrier or diluent therefor. The polymeric shell may be produced by either an interfacial polycondensation reaction or by a coacervation procedure. The compositions may provide for controlled release of the compound of mixture of the invention and they may be used for seed treatment. A compound or enantiomerically enriched mixture of the invention may also be formulated in a biodegradable polymeric matrix to provide a slow, controlled release of the compound.

A composition may include one or more additives to improve the biological performance of the composition (for example by improving wetting, retention or distribution on surfaces; resistance to rain on treated surfaces; or uptake or mobility of a compound or mixture of the invention)). Such additives include surface active agents, spray additives based on oils, for example certain mineral oils or natural plant oils (such as soy bean and rape seed oil), and blends of these with other bio-enhancing adjuvants (ingredients which may aid or modify the action of a compound of mixture of the invention)).

A compound or enantiomerically enriched mixture of the invention may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier).

Wetting agents, dispersing agents and emulsifying agents may be surface SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulfuric acid (for example sodium lauryl sulfate), salts of sulfonated aromatic compounds (for example sodium dodecylbenzenesulfonate, calcium dodecylbenzenesulfonate, butylnaphthalene sulfonate and mixtures of sodium di-isopropyl- and tri-isopropyl-naphthalene sulfonates), ether sulfates, alcohol ether sulfates (for example sodium laureth-3-sulfate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulfosuccinamates, paraffin or olefine sulfonates, taurates and lignosulfonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

A compound or enantiomerically enriched mixture of the invention may be applied by any of the known means of applying pesticidal compounds. For example, it may be applied, formulated or unformulated, to the pests or to a locus of the pests (such as a habitat of the pests, or a growing plant liable to infestation by the pests) or to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapor or applied through distribution or incorporation of a composition (such as a granular composition or a composition packed in a water-soluble bag) in soil or an aqueous environment.

A compound or enantiomerically enriched mixture of the invention may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ECs, EWs, MEs, SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound or mixture of the invention (for example 0.0001 to 10%, by weight) depending upon the purpose for which they are to be used.

A compound or enantiomerically enriched mixture of the invention may be used in mixtures with fertilizers (for example nitrogen-, potassium- or phosphorus-containing fertilizers). Suitable formulation types include granules of fertilizer. The mixtures preferably contain up to 25% by weight of the compounds and enantiomerically enriched mixtures of the invention.

The invention therefore also provides a fertilizer composition comprising a fertilizer and a compound or enantiomerically enriched mixture of the invention.

The compositions of this invention may contain other compounds having biological activity, for example micronutrients or compounds having fungicidal activity or which possess plant growth regulating, herbicidal, insecticidal, nematicidal or acaricidal activity.

The compounds or enantiomerically enriched mixtures of the invention may be the sole active ingredient of the composition or it may be admixed with one or more additional active ingredients such as a pesticide, fungicide, synergist, herbicide or plant growth regulator where appropriate. An additional active ingredient may: provide a composition having a broader spectrum of activity or increased persistence at a locus; synergize the activity or complement the activity (for example by increasing the speed of effect or overcoming repellency) of the compounds and enantiomerically enriched mixtures of the invention; or help to overcome or prevent the development of resistance to individual components. The particular additional active ingredient will depend upon the intended utility of the composition. Examples of suitable pesticides include the following:

a) a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea selected from the group consisting of diflubenzuron, triflumuron, hexaflumuron, flufenoxuron, lufenuron and chlorfluazuron;
e) an organic tin compound selected from the group consisting of cyhexatin, fenbutatin oxide and azocyclotin;
f) a pyrazole selected from the group consisting of tebufenpyrad and fenpyroximate;
g) a macrolide selected from the group consisting of abamectin, emamectin (e.g. emamectin benzoate), ivermectin, milbemycin, spinosad, azadirachtin and spinetoram;
h) an organochlorine compound selected from the group consisting of endosulfan (in particular alpha-endosulfan), benzene hexachloride, DDT, chlordane and dieldrin;
i) an amidine selected from the group consisting of chlordimeform and amitraz;
j) a fumigant agent selected from the group consisting of chloropicrin, dichloropropane, methyl bromide and metam;
k) a neonicotinoid compound selected from the group consisting of imidacloprid, thiacloprid, acetamiprid, nitenpyram, dinotefuran, thiamethoxam, clothianidin, nithiazine and flonicamid;
l) a diacylhydrazine selected from the group consisting of tebufenozide, chromafenozide and methoxyfenozide;
m) a diphenyl ether selected from the group consisting of diofenolan and pyriproxyfen;
n) indoxacarb;
o) chlorfenapyr;
p) pymetrozine;
q) spirotetramat, spirodiclofen and spiromesifen;
r) a diamide selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon; and
w) buprofezin.
x) diafenthiuron; and
y) 4-[(6-Chloro-pyridin-3-ylmethyl)-(2,2-difluoro-ethyl)-amino]-5H-furan-2-one (DE 102006015467).

In addition to the major chemical classes of pesticide listed above, other pesticides having particular targets may be employed in the composition, if appropriate for the intended utility of the composition. For instance, selective insecticides for particular crops, for example stemborer specific insecticides (such as cartap) or hopper specific insecticides (such as buprofezin) for use in rice may be employed. Alternatively insecticides or acaricides specific for particular insect species/stages may also be included in the compositions (for example acaricidal ovo-larvicides, such as clofentezine, flubenzimine, hexythiazox or tetradifon; acaricidal motilicides, such as dicofol or propargite; acaricides, such as bromopropylate or chlorobenzilate; or growth regulators, such as hydramethylnon, cyromazine, methoprene, chlorfluazuron or diflubenzuron).

Examples of fungicidal compounds which may be included in the composition of the invention are a strobilurin fungicide selected from the group consisting of:

### Azoxystrobin, Dimoxystrobin, Enestrobin, Fluoxastrobin, Kresoxim-methyl, Metominostrobin, Orysastrobin, Picoxystrobin, Pyraclostrobin, Trifloxystrobin;

an azole fungicide selected from the group consisting of:

Azaconazole, Bromuconazole, Cyproconazole, Difenoconazole, Diniconazole, Diniconazole-M, Epoxiconazole, Fenbuconazole, Fluquinconazole, Flusilazole, Flutriafol, Hexaconazole, Imazalil, Imibenconazole, Ipconazole, Metconazole, Myclobutanil, Oxpoconazole, Pefurazoate, Penconazole, Prochloraz, Propiconazole, Prothioconazole, Simeconazole, Tebuconazole, Tetraconazole, Triadimefon, Triadimenol, Triflumizole, Triticonazole, Diclobutrazol, Etaconazole, Furconazole, Furconazole-cis, Thiabendazole and Quinconazole;

a phenyl pyrrole fungicide selected from the group consisting of:

### Fenpiclonil and Fludioxonil;

an anilino-pyrimidine fungicide selected from the group consisting of:

### Cyprodinil, Mepanipyrim and Pyrimethanil;

a morpholine fungicide selected from the group consisting of:

### Aldimorph, Dodemorph, Fenpropimorph, Tridemorph, Fenpropidin, Spiroxamine;

a carboxamide selected from the group consisting of:

Isopyrazam, Sedaxane, Bixafen, Penthiopyrad, Fluxapyroxad, Boscalid, Penflufen, Fluopyram, a compound of formula VI

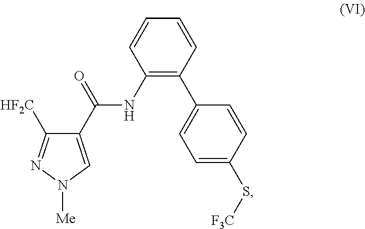

a compound of formula VII

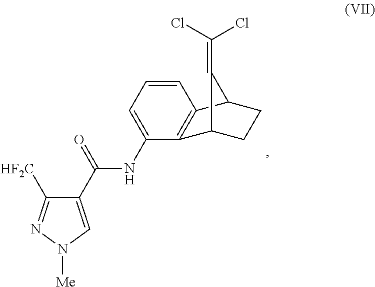

and a compound of formula VIII

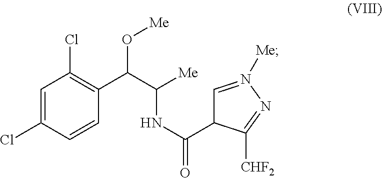

a carboxylic acid amide selected from the group consisting of:

### Mandipropamid, Benthiavalicarb, Dimethomorph;

Chlorothalonil, Fluazinam, Dithianon, Metrafenone, Tricyclazole, Mefenoxam, Metalaxyl, Acibenzolar, Mancozeb, Ametoctradine and Cyflufenamid.

In addition, the compounds and mixtures of the invention may be combined with a nematicidally active biological agent. The nematicidally active biological agent refers to any biological agent that has nematicidal activity. The biological agent can be any type known in the art including bacteria and fungi. The wording “nematicidally active” refers to having an effect on, such as reduction in damage caused by, agricultural-related nematodes. The nematicidally active biological agent can be a bacterium or a fungus. Preferably, the biological agent is a bacterium. Examples of nematicidally active bacteria include Bacillus firmus, Bacillus cereus, Bacillus subtilis, and Pasteuria penetrans, preferably Bacillus firmus, Bacillus subtilis, and Pasteuria penetrans. A suitable Bacillus firmus strain is strain CNCM I-1582 which is commercially available as BioNem™. A suitable Bacillus cereus strain is strain CNCM I-1562. Of both Bacillus strains more details can be found in U.S. Pat. No. 6,406,690. The compounds or enantiomerically enriched mixtures of the invention may be mixed with soil, peat or other rooting media for the protection of plants against seed-borne, soil-borne or foliar fungal diseases.

Examples of suitable synergists for use in the compositions include piperonyl butoxide, sesamex, safroxan and dodecyl imidazole.

Suitable herbicides and plant-growth regulators for inclusion in the compositions will depend upon the intended target and the effect required.

An example of a rice selective herbicide which may be included is propanil. An example of a plant growth regulator for use in cotton is PIX™.

Some mixtures may comprise active ingredients which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

The compounds of the invention (i.e. compounds of formula IB and mixtures comprising compounds of formula IB and formula IA that are enriched for formula B) are also useful in the field of animal health, e.g. they may be used against parasitic invertebrate pests, more preferably against parasitic invertebrate pests in or on an animal. Examples of pests include nematodes, trematodes, cestodes, flies, mites, tricks, lice, fleas, true bugs and maggots. The animal may be a non-human animal, e.g. an animal associated with agriculture, e.g. a cow, a pig, a sheep, a goat, a horse, or a donkey, or a companion animal, e.g. a dog or a cat.

In a further aspect the invention provides a compound of the invention for use in a method of therapeutic treatment.

In a further aspect the invention relates to a method of controlling parasitic invertebrate pests in or on an animal comprising administering a pesticidally effective amount of a compound of the invention. The administration may be for example oral administration, parenteral administration or external administration, e.g. to the surface of the animal body. In a further aspect the invention relates to a compound of the invention for controlling parasitic invertebrate pests in or on an animal. In a further aspect the invention relates to use of a compound of the invention in the manufacture of a medicament for controlling parasitic invertebrate pests in or on an animal

In a further aspect, the invention relates to a method of controlling parasitic invertebrate pests comprising administering a pesticidally effective amount of a compound of the invention to the environment in which an animal resides.

In a further aspect, the invention provides a pharmaceutical composition comprising a compound of the invention and a pharmaceutically suitable excipient.

The compounds of the invention may be used alone or in combination with one or more other biologically active ingredients.

In one aspect the invention provides a combination product comprising a pesticidally effective amount of a component A and a pesticidally effective amount of component B wherein component A is a compound of the invention and component B is a compound as described below.

The compounds of the invention may be used in combination with anthelmintic agents. Such anthelmintic agents include, compounds selected from the macrocyclic lactone class of compounds such as ivermectin, avermectin, abamectin, emamectin, eprinomectin, doramectin, selamectin, moxidectin, nemadectin and milbemycin derivatives as described in EP-357460, EP-444964 and EP-594291. Additional anthelmintic agents include semisynthetic and biosynthetic avermectin/milbemycin derivatives such as those described in U.S. Pat. No. 5,015,630, WO-9415944 and WO-9522552. Additional anthelmintic agents include the benzimidazoles such as albendazole, cambendazole, fenbendazole, flubendazole, mebendazole, oxfendazole, oxibendazole, parbendazole, and other members of the class. Additional anthelmintic agents include imidazothiazoles and tetrahydropyrimidines such as tetramisole, levamisole, pyrantel pamoate, oxantel or morantel. Additional anthelmintic agents include flukicides, such as triclabendazole and clorsulon and the cestocides, such as praziquantel and epsiprantel.

The compounds of the invention may be used in combination with derivatives and analogues of the paraherquamide/marcfortine class of anthelmintic agents, as well as the antiparasitic oxazolines such as those disclosed in U.S. Pat. No. 5,478,855, U.S. Pat. No. 4,639,771 and DE-19520936.

The compounds of the invention may be used in combination with derivatives and analogues of the general class of dioxomorpholine antiparasitic agents as described in WO-9615121 and also with anthelmintic active cyclic depsipeptides such as those described in WO-9611945, WO-9319053, WO-9325543, EP-626375, EP-382173, WO-9419334, EP-382173, and EP-503538.

The compounds of the invention may be used in combination with other ectoparasiticides; for example, fipronil; pyrethroids; organophosphates; insect growth regulators such as lufenuron; ecdysone agonists such as tebufenozide and the like; neonicotinoids such as imidacloprid and the like.

The compounds of the invention may be used in combination with terpene alkaloids, for example those described in International Patent Application Publication Numbers WO95/19363 or WO04/72086, particularly the compounds disclosed therein.

Other examples of such biologically active compounds that the compounds of the invention may be used in combination with include but are not restricted to the following:

Organophosphates: acephate, azamethiphos, azinphos-ethyl, azinphos-methyl, bromophos, bromophos-ethyl, cadusafos, chlorethoxyphos, chlorpyrifos, chlorfenvinphos, chlormephos, demeton, demeton-5-methyl, demeton-5-methyl sulphone, dialifos, diazinon, dichlorvos, dicrotophos, dimethoate, disulfoton, ethion, ethoprophos, etrimfos, famphur, fenamiphos, fenitrothion, fensulfothion, fenthion, flupyrazofos, fonofos, formothion, fosthiazate, heptenophos, isazophos, isothioate, isoxathion, malathion, methacriphos, methamidophos, methidathion, methyl-parathion, mevinphos, monocrotophos, naled, omethoate, oxydemeton-methyl, paraoxon, parathion, parathion-methyl, phenthoate, phosalone, phosfolan, phosphocarb, phosmet, phosphamidon, phorate, phoxim, pirimiphos, pirimiphos-methyl, profenofos, propaphos, proetamphos, prothiofos, pyraclofos, pyridapenthion, quinalphos, sulprophos, temephos, terbufos, tebupirimfos, tetrachlorvinphos, thimeton, triazophos, trichlorfon, vamidothion.

Carbamates: alanycarb, aldicarb, 2-sec-butylphenyl methylcarbamate, benfuracarb, carbaryl, carbofuran, carbosulfan, cloethocarb, ethiofencarb, fenoxycarb, fenthiocarb, furathiocarb, HCN-801, isoprocarb, indoxacarb, methiocarb, methomyl, 5-methyl-m-cumenylbutyryl(methyl)carbamate, oxamyl, pirimicarb, propoxur, thiodicarb, thiofanox, triazamate, UC-51717.

Pyrethroids: acrinathin, allethrin, alphametrin, 5-benzyl-3-furylmethyl (E)-(1R)-cis-2,2-dimethyl-3-(2-oxothiolan-3-ylidenemethyl)cyclopropanecarboxylate, bifenthrin, beta-cyfluthrin, cyfluthrin, a-cypermethrin, beta-cypermethrin, bioallethrin, bioallethrin((S)-cyclopentylisomer), bioresmethrin, bifenthrin, NCl-85193, cycloprothrin, cyhalothrin, cythithrin, cyphenothrin, deltamethrin, empenthrin, esfenvalerate, ethofenprox, fenfluthrin, fenpropathrin, fenvalerate, flucythrinate, flumethrin, fluvalinate (D isomer), imiprothrin, cyhalothrin, lambda-cyhalothrin, permethrin, phenothrin, prallethrin, pyrethrins (natural products), resmethrin, tetramethrin, transfluthrin, theta-cypermethrin, silafluofen, t-fluvalinate, tefluthrin, tralomethrin, Zeta-cypermethrin.

Arthropod growth regulators: a) chitin synthesis inhibitors: benzoylureas: chlorfluazuron, diflubenzuron, fluazuron, flucycloxuron, flufenoxuron, hexaflumuron, lufenuron, novaluron, teflubenzuron, triflumuron, buprofezin, diofenolan, hexythiazox, etoxazole, chlorfentazine; b) ecdysone antagonists: halofenozide, methoxyfenozide, tebufenozide; c) juvenoids: pyriproxyfen, methoprene (including S-methoprene), fenoxycarb; d) lipid biosynthesis inhibitors: spirodiclofen.

Other antiparasitics: acequinocyl, amitraz, AKD-1022, ANS-118, azadirachtin,

Bacillus thuringiensis, bensultap, bifenazate, binapacryl, bromopropylate, BTG-504, BTG-505, camphechlor, cartap, chlorobenzilate, chlordimeform, chlorfenapyr, chromafenozide, clothianidine, cyromazine, diacloden, diafenthiuron, DBI-3204, dinactin, dihydroxymethyldihydroxypyrrolidine, dinobuton, dinocap, endosulfan, ethiprole, ethofenprox, fenazaquin, flumite, MTI-800, fenpyroximate, fluacrypyrim, flubenzimine, flubrocythrinate, flufenzine, flufenprox, fluproxyfen, halofenprox, hydramethylnon, IKI-220, kanemite, NC-196, neem guard, nidinorterfuran, nitenpyram, SD-35651, WL-108477, pirydaryl, propargite, protrifenbute, pymethrozine, pyridaben, pyrimidifen, NC-1111, R-195, RH-0345, RH-2485, RYI-210, S-1283, S-1833, SI-8601, silafluofen, silomadine, spinosad, tebufenpyrad, tetradifon, tetranactin, thiacloprid, thiocyclam, thiamethoxam, tolfenpyrad, triazamate, triethoxyspinosyn, trinactin, verbutin, vertalec, Y¹-5301.

Fungicides: acibenzolar, aldimorph, ampropylfos, andoprim, azaconazole, azoxystrobin, benalaxyl, benomyl, bialaphos, blasticidin-S, Bordeaux mixture, bromuconazole, bupirimate, carpropamid, captafol, captan, carbendazim, chlorfenazole, chloroneb, chloropicrin, chlorothalonil, chlozolinate, copper oxychloride, copper salts, cyflufenamid, cymoxanil, cyproconazole, cyprodinil, cyprofuram, RH-7281, diclocymet, diclobutrazole, diclomezine, dicloran, difenoconazole, RP-407213, dimethomorph, domoxystrobin, diniconazole, diniconazole-M, dodine, edifenphos, epoxiconazole, famoxadone, fenamidone, fenarimol, fenbuconazole, fencaramid, fenpiclonil, fenpropidin, fenpropimorph, fentin acetate, fluazinam, fludioxonil, flumetover, flumorf/flumorlin, fentin hydroxide, fluoxastrobin, fluquinconazole, flusilazole, flutolanil, flutriafol, folpet, fosetyl-aluminium, furalaxyl, furametapyr, hexaconazole, ipconazole, iprobenfos, iprodione, isoprothiolane, kasugamycin, krsoxim-methyl, mancozeb, maneb, mefenoxam, mepronil, metalaxyl, metconazole, metominostrobin/fenominostrobin, metrafenone, myclobutanil, neo-asozin, nicobifen, orysastrobin, oxadixyl, penconazole, pencycuron, probenazole, prochloraz, propamocarb, propioconazole, proquinazid, prothioconazole, pyrifenox, pyraclostrobin, pyrimethanil, pyroquilon, quinoxyfen, spiroxamine, sulfur, tebuconazole, tetrconazole, thiabendazole, thifluzamide, thiophanate-methyl, thiram, tiadinil, triadimefon, triadimenol, tricyclazole, trifloxystrobin, triticonazole, validamycin, vinclozin.

Biological agents: Bacillus thuringiensis ssp aizawai, kurstaki, Bacillus thuringiensis delta endotoxin, baculovirus, entomopathogenic bacteria, virus and fungi.

Bactericides: chlortetracycline, oxytetracycline, streptomycin.

Other biological agents: enrofloxacin, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, carprofen, metaflumizone, praziquarantel, triclabendazole.

When used in combination with other active ingredients, the compounds of the invention are preferably used in combination with imidacloprid, enrofloxacin, praziquantel, pyrantel embonate, febantel, penethamate, moloxicam, cefalexin, kanamycin, pimobendan, clenbuterol, fipronil, ivermectin, omeprazole, tiamulin, benazepril, milbemycin, cyromazine, thiamethoxam, pyriprole, deltamethrin, cefquinome, florfenicol, buserelin, cefovecin, tulathromycin, ceftiour, selamectin, carprofen, metaflumizone, moxidectin, methoprene (including S-methoprene), clorsulon, pyrantel, amitraz, triclabendazole, avermectin, abamectin, emamectin, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, fipronil, lufenuron, ecdysone or tebufenozide; more preferably, enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon, pyrantel, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, lufenuron or ecdysone; even more preferably, enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon or pyrantel.

Of particular note is a combination where the additional active ingredient has a different site of action from the compound of formula I. In certain instances, a combination with at least one other parasitic invertebrate pest control active ingredient having a similar spectrum of control but a different site of action will be particularly advantageous for resistance management. Thus, a combination product of the invention may comprise a pesticidally effective amount of a compound of formula I and pesticidally effective amount of at least one additional parasitic invertebrate pest control active ingredient having a similar spectrum of control but a different site of action.

One skilled in the art recognizes that because in the environment and under physiological conditions salts of chemical compounds are in equilibrium with their corresponding non salt forms, salts share the biological utility of the non salt forms. Thus a wide variety of salts of compounds of the invention (and active ingredients used in combination with the active ingredients of the invention) may be useful for control of invertebrate pests and animal parasites. Salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. The compounds of the invention also include N-oxides. Accordingly, the invention comprises combinations of compounds of the invention including N-oxides and salts thereof and an additional active ingredient including N-oxides and salts thereof.

The compositions for use in animal health may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compounds of the invention can be applied without other adjuvants, but most often application will be of a formulation comprising one or more active ingredients with suitable carriers, diluents, and surfactants and possibly in combination with a food depending on the contemplated end use. One method of application involves spraying a water dispersion or refined oil solution of the combination products. Compositions with spray oils, spray oil concentrations, spreader stickers, adjuvants, other solvents, and synergists such as piperonyl butoxide often enhance compound efficacy. Such sprays can be applied from spray containers such as a can, a bottle or other container, either by means of a pump or by releasing it from a pressurized container, e.g., a pressurized aerosol spray can. Such spray compositions can take various forms, for example, sprays, mists, foams, fumes or fog. Such spray compositions thus can further comprise propellants, foaming agents, etc. as the case may be. Of note is a spray composition comprising a pesticidally effective amount of a compound of the invention and a carrier. One embodiment of such a spray composition comprises a pesticidally effective amount of a compound of the invention and a propellant. Representative propellants include, but are not limited to, methane, ethane, propane, butane, isobutane, butene, pentane, isopentane, neopentane, pentene, hydrofluorocarbons, chlorofluorocarbons, dimethyl ether, and mixtures of the foregoing. Of note is a spray composition (and a method utilizing such a spray composition dispensed from a spray container) used to control at least one parasitic invertebrate pest selected from the group consisting of mosquitoes, black flies, stable flies, deer flies, horse flies, wasps, yellow jackets, hornets, ticks, spiders, ants, gnats, and the like, including individually or in combinations.

The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. The compounds of the invention may be particularly suitable for combating external parasitic pests. The compounds of the invention may be suitable for systemic and/or non-systemic control of infestation or infection by parasites on animals.

The compounds of the invention may be suitable for combating parasitic invertebrate pests that infest animal subjects including those in the wild, livestock and agricultural working animals. Livestock is the term used to refer (singularly or plurally) to a domesticated animal intentionally reared in an agricultural setting to make produce such as food or fiber, or for its labor; examples of livestock include cattle, sheep, goats, horses, pigs, donkeys, camels, buffalo, rabbits, hens, turkeys, ducks and geese (e.g., raised for meat, milk, butter, eggs, fur, leather, feathers and/or wool). By combating parasites, fatalities and performance reduction (in terms of meat, milk, wool, skins, eggs, etc.) are reduced, so that applying the compounds of the invention allows more economic and simple husbandry of animals.

The compounds of the invention may be suitable for combating parasitic invertebrate pests that infest companion animals and pets (e.g., dogs, cats, pet birds and aquarium fish), research and experimental animals (e.g., hamsters, guinea pigs, rats and mice), as well as animals raised for/in zoos, wild habitats and/or circuses.

In an embodiment of this invention, the animal is preferably a vertebrate, and more preferably a mammal, avian or fish. In a particular embodiment, the animal subject is a mammal (including great apes, such as humans). Other mammalian subjects include primates (e.g., monkeys), bovine (e.g., cattle or dairy cows), porcine (e.g., hogs or pigs), ovine (e.g., goats or sheep), equine (e.g., horses), canine (e.g., dogs), feline (e.g., house cats), camels, deer, donkeys, buffalos, antelopes, rabbits, and rodents (e.g., guinea pigs, squirrels, rats, mice, gerbils, and hamsters). Avians include Anatidae (swans, ducks and geese), Columbidae (e.g., doves and pigeons), Phasianidae (e.g., partridges, grouse and turkeys), Thesienidae (e.g., domestic chickens), Psittacines (e.g., parakeets, macaws, and parrots), game birds, and ratites (e.g., ostriches).

Birds treated or protected by the compounds of the invention can be associated with either commercial or noncommercial aviculture. These include Anatidae, such as swans, geese, and ducks, Columbidae, such as doves and domestic pigeons, Phasianidae, such as partridge, grouse and turkeys, Thesienidae, such as domestic chickens, and Psittacines, such as parakeets, macaws and parrots raised for the pet or collector market, among others.

For purposes of the present invention, the term “fish” is understood to include without limitation, the Teleosti grouping of fish, i.e., teleosts. Both the Salmoniformes order (which includes the Salmonidae family) and the Perciformes order (which includes the Centrarchidae family) are contained within the Teleosti grouping. Examples of potential fish recipients include the Salmonidae, Serranidae, Sparidae, Cichlidae, and Centrarchidae, among others.

Other animals are also contemplated to benefit from the inventive methods, including marsupials (such as kangaroos), reptiles (such as farmed turtles), and other economically important domestic animals for which the inventive methods are safe and effective in treating or preventing parasite infection or infestation.

Examples of parasitic invertebrate pests controlled by administering a pesticidally effective amount of the compounds of the invention to an animal to be protected include ectoparasites (arthropods, acarines, etc.) and endoparasites (helminths, e.g., nematodes, trematodes, cestodes, acanthocephalans, etc.).

The disease or group of diseases described generally as helminthiasis is due to infection of an animal host with parasitic worms known as helminths. The term ‘helminths’ is meant to include nematodes, trematodes, cestodes and acanthocephalans. Helminthiasis is a prevalent and serious economic problem with domesticated animals such as swine, sheep, horses, cattle, goats, dogs, cats and poultry.

Among the helminths, the group of worms described as nematodes causes widespread and at times serious infection in various species of animals. Nematodes that are contemplated to be treated by the compounds of the invention include, without limitation, the following genera: Acanthocheilonema, Aelurostrongylus, Ancylostoma, Angiostrongylus, Ascaridia, Ascaris, Brugia, Bunostomum, Capillaria, Chabertia, Cooperia, Crenosoma, Dictyocaulus, Dioctophyme, Dipetalonema, Diphyllobothrium, Dirofilaria, Dracunculus, Enterobius, Filaroides, Haemonchus, Heterakis, Lagochilascaris, Loa, Mansonella, Muellerius, Necator, Nematodirus, Oesophagostomum, Ostertagia, Oxyuris, Parafilaria, Parascaris, Physaloptera, Protostrongylus, Setaria, Spirocerca, Stephanofilaria, Strongyloides, Strongylus, Thelazia, Toxascaris, Toxocara, Trichinella, Trichonema, Trichostrongylus, Trichuris, Uncinaria and Wuchereria.

Of the above, the most common genera of nematodes infecting the animals referred to above are Haemonchus, Trichostrongylus, Ostertagia, Nematodirus, Cooperia, Ascaris, Bunostomum, Oesophagostomum, Chabertia, Trichuris, Strongylus, Trichonema, Dictyocaulus, Capillaria, Heterakis, Toxocara, Ascaridia, Oxyuris, Ancylostoma, Uncinaria, Toxascaris and Parascaris. Certain of these, such as Nematodirus, Cooperia and Oesophagostomum attack primarily the intestinal tract while others, such as Haemonchus and Ostertagia, are more prevalent in the stomach while others such as Dictyocaulus are found in the lungs. Still other parasites may be located in other tissues such as the heart and blood vessels, subcutaneous and lymphatic tissue and the like.

Trematodes that are contemplated to be treated by the invention and by the inventive methods include, without limitation, the following genera: Alaria, Fasciola, Nanophyetus, Opisthorchis, Paragonimus and Schistosoma.

Cestodes that are contemplated to be treated by the invention and by the inventive methods include, without limitation, the following genera: Diphyllobothrium, Diplydium, Spirometra and Taenia.

The most common genera of parasites of the gastrointestinal tract of humans are Ancylostoma, Necator, Ascaris, Strongyhides, Trichinella, Capillaria, Trichuris and Enterobius. Other medically important genera of parasites which are found in the blood or other tissues and organs outside the gastrointestinal tract are the filarial worms such as Wuchereria, Brugia, Onchocerca and Loa, as well as Dracunculus and extra intestinal stages of the intestinal worms Strongyloides and Trichinella.

Numerous other helminth genera and species are known to the art, and are also contemplated to be treated by the compounds of the invention. These are enumerated in great detail in Textbook of Veterinary Clinical Parasitology, Volume 1, Helminths, E. J. L. Soulsby, F. A. Davis Co., Philadelphia, Pa.; Helminths, Arthropods and Protozoa, (6^{th} Edition of Monnig's Veterinary Helminthology and Entomology), E. J. L. Soulsby, Williams and Wilkins Co., Baltimore, Md.

The compounds of the invention may be effective against a number of animal ectoparasites (e.g., arthropod ectoparasites of mammals and birds).

Insect and acarine pests include, e.g., biting insects such as flies and mosquitoes, mites, ticks, lice, fleas, true bugs, parasitic maggots, and the like.

Adult flies include, e.g., the horn fly or Haematobia irritans, the horse fly or Tabanus spp., the stable fly or Stomoxys calcitrans, the black fly or Simulium spp., the deer fly or Chrysops spp., the louse fly or Melophagus ovinus, and the tsetse fly or Glossina spp. Parasitic fly maggots include, e.g., the bot fly (Oestrus ovis and Cuterebra spp.), the blow fly or Phaenicia spp., the screwworm or Cochliomyia hominivorax, the cattle grub or Hypoderma spp., the fleeceworm and the Gastrophilus of horses. Mosquitoes include, for example, Culex spp., Anopheles spp. and Aedes spp.

Mites include Mesostigmalphatalpha spp. e.g., mesostigmatids such as the chicken mite, Dermalphanyssus galphallinalphae; itch or scab mites such as Sarcoptidae spp. for example, Salpharcoptes scalphabiei; mange mites such as Psoroptidae spp. including Chorioptes bovis and Psoroptes ovis; chiggers e.g., Trombiculidae spp. for example the North American chigger, Trombiculalpha alphalfreddugesi.

Ticks include, e.g., soft-bodied ticks including Argasidae spp. for example Argalphas spp. and Ornithodoros spp.; hard-bodied ticks including Ixodidae spp., for example Rhipicephalphalus sanguineus, Dermacentor variabilis, Dermacentor andersoni, Amblyomma americanum, Ixodes scapularis and other Rhipicephalus spp. (including the former Boophilus genera).

Lice include, e.g., sucking lice, e.g., Menopon spp. and Bovicola spp.; biting lice, e.g., Haematopinus spp., Linognathus spp. and Solenopotes spp.

Fleas include, e.g., Ctenocephalides spp., such as dog flea (Ctenocephalides canis) and cat flea (Ctenocephalides felis); Xenopsylla spp. such as oriental rat flea (Xenopsylla cheopis); and Pulex spp. such as human flea (Pulex irritans).

True bugs include, e.g., Cimicidae or e.g., the common bed bug (Cimex lectularius); Triatominae spp. including triatomid bugs also known as kissing bugs; for example Rhodnius prolixus and Triatoma spp.

Generally, flies, fleas, lice, mosquitoes, gnats, mites, ticks and helminths cause tremendous losses to the livestock and companion animal sectors. Arthropod parasites also are a nuisance to humans and can vector disease-causing organisms in humans and animals.

Numerous other parasitic invertebrate pests are known to the art, and are also contemplated to be treated by the compounds of the invention. These are enumerated in great detail in Medical and Veterinary Entomology, D. S. Kettle, John Wiley AND Sons, New York and Toronto; Control of Arthropod Pests of Livestock: A Review of Technology, R. O. Drummand, J. E. George, and S. E. Kunz, CRC Press, Boca Raton, Fla.

The compounds of the invention may also be effective against ectoparasites including: flies such as Haematobia (Lyperosia) irritans (horn fly), Simulium spp. (blackfly), Glossina spp. (tsetse flies), Hydrotaea irritans (head fly), Musca autumnalis (face fly), Musca domestica (house fly), Morellia simplex (sweat fly), Tabanus spp. (horse fly), Hypoderma bovis, Hypoderma lineatum, Lucilia sericata, Lucilia cuprina (green blowfly), Calliphora spp. (blowfly), Protophormia spp., Oestrus ovis (nasal botfly), Culicoides spp. (midges), Hippobosca equine, Gastrophilus intestinalis, Gastrophilus haemorrhoidalis and Gastrophilus nasalis; lice such as Bovicola (Damalinia) bovis, Bovicola equi, Haematopinus asini, Felicola subrostratus, Heterodoxus spiniger, Lignonathus setosus and Trichodectes canis; keds such as Melophagus ovinus; and mites such as Psoroptes spp., Sarcoptes scabei, Chorioptes bovis, Demodex equi, Cheyletiella spp., Notoedres cati, Trombicula spp. and Otodectes cyanotis (ear mites).

Treatments of the invention are by conventional means such as by enteral administration in the form of, for example, tablets, capsules, drinks, drenching preparations, granulates, pastes, boli, feed-through procedures, or suppositories; or by parenteral administration, such as, for example, by injection (including intramuscular, subcutaneous, intravenous, intraperitoneal) or implants; or by nasal administration.

When compounds of the invention are applied in combination with an additional biologically active ingredient, they may be administered separately e.g. as separate compositions. In this case, the biologically active ingredients may be administered simultaneously or sequentially. Alternatively, the biologically active ingredients may be components of one composition.

The compounds of the invention may be administered in a controlled release form, for example in subcutaneous or orally adminstered slow release formulations.

Typically a parasiticidal composition according to the present invention comprises a compound of the invention, optionally in combination with an additional biologically active ingredient, or N-oxides or salts thereof, with one or more pharmaceutically or veterinarily acceptable carriers comprising excipients and auxiliaries selected with regard to the intended route of administration (e.g., oral or parenteral administration such as injection) and in accordance with standard practice. In addition, a suitable carrier is selected on the basis of compatibility with the one or more active ingredients in the composition, including such considerations as stability relative to pH and moisture content. Therefore of note are compounds of the invention for protecting an animal from an invertebrate parasitic pest comprising a parasitically effective amount of a compound of the invention, optionally in combination with an additional biologically active ingredient and at least one carrier.

For parenteral administration including intravenous, intramuscular and subcutaneous injection, the compounds of the invention can be formulated in suspension, solution or emulsion in oily or aqueous vehicles, and may contain adjuncts such as suspending, stabilizing and/or dispersing agents.

The compounds of the invention may also be formulated for bolus injection or continuous infusion. Pharmaceutical compositions for injection include aqueous solutions of water-soluble forms of active ingredients (e.g., a salt of an active compound), preferably in physiologically compatible buffers containing other excipients or auxiliaries as are known in the art of pharmaceutical formulation. Additionally, suspensions of the active compounds may be prepared in a lipophilic vehicle. Suitable lipophilic vehicles include fatty oils such as sesame oil, synthetic fatty acid esters such as ethyl oleate and triglycerides, or materials such as liposomes.

Aqueous injection suspensions may contain substances that increase the viscosity of the suspension, such as sodium carboxymethyl cellulose, sorbitol, or dextran. Formulations for injection may be presented in unit dosage form, e.g., in ampoules or in multi-dose containers. Alternatively, the active ingredient may be in powder form for constitution with a suitable vehicle, e.g., sterile, pyrogen-free water, before use.

In addition to the formulations described supra, the compounds of the invention may also be formulated as a depot preparation. Such long acting formulations may be administered by implantation (for example, subcutaneously or intramuscularly) or by intramuscular or subcutaneous injection.

The compounds of the invention may be formulated for this route of administration with suitable polymeric or hydrophobic materials (for instance, in an emulsion with a pharmacologically acceptable oil), with ion exchange resins, or as a sparingly soluble derivative such as, without limitation, a sparingly soluble salt.

For administration by inhalation, the compounds of the invention can be delivered in the form of an aerosol spray using a pressurized pack or a nebulizer and a suitable propellant, e.g., without limitation, dichlorodifluoromethane, trichlorofluoromethane, dichlorotetrafluoroethane or carbon dioxide. In the case of a pressurized aerosol, the dosage unit may be controlled by providing a valve to deliver a metered amount. Capsules and cartridges of, for example, gelatin for use in an inhaler or insufflator may be formulated containing a powder mix of the compound and a suitable powder base such as lactose or starch.

The compounds of the invention may have favourable pharmacokinetic and pharmacodynamic properties providing systemic availability from oral administration and ingestion. Therefore after ingestion by the animal to be protected, parasiticidally effective concentrations of a compound of the invention in the bloodstream may protect the treated animal from blood-sucking pests such as fleas, ticks and lice. Therefore of note is a composition for protecting an animal from an invertebrate parasite pest in a form for oral administration (i.e. comprising, in addition to a parasiticidally effective amount of a compound of the invention, one or more carriers selected from binders and fillers suitable for oral administration and feed concentrate carriers).

For oral administration in the form of solutions (the most readily available form for absorption), emulsions, suspensions, pastes, gels, capsules, tablets, boluses, powders, granules, rumen-retention and feed/water/lick blocks, the compounds of the invention can be formulated with binders/fillers known in the art to be suitable for oral administration compositions, such as sugars and sugar derivatives (e.g., lactose, sucrose, mannitol, sorbitol), starch (e.g., maize starch, wheat starch, rice starch, potato starch), cellulose and derivatives (e.g., methylcellulose, carboxymethylcellulose, ethylhydroxycellulose), protein derivatives (e.g., zein, gelatin), and synthetic polymers (e.g., polyvinyl alcohol, polyvinylpyrrolidone). If desired, lubricants (e.g., magnesium stearate), disintegrating agents (e.g., cross-linked polyvinylpyrrolidinone, agar, alginic acid) and dyes or pigments can be added. Pastes and gels often also contain adhesives (e.g., acacia, alginic acid, bentonite, cellulose, xanthan gum, colloidal magnesium aluminum silicate) to aid in keeping the composition in contact with the oral cavity and not being easily ejected.

In one embodiment a composition of the present invention is formulated into a chewable and/or edible product (e.g., a chewable treat or edible tablet). Such a product would ideally have a taste, texture and/or aroma favored by the animal to be protected so as to facilitate oral administration of the compounds of the invention.

If the parasiticidal compositions are in the form of feed concentrates, the carrier is typically selected from high-performance feed, feed cereals or protein concentrates. Such feed concentrate-containing compositions can, in addition to the parasiticidal active ingredients, comprise additives promoting animal health or growth, improving quality of meat from animals for slaughter or otherwise useful to animal husbandry. These additives can include, for example, vitamins, antibiotics, chemotherapeutics, bacteriostats, fungistats, coccidiostats and hormones.

The compound of the invention may also be formulated in rectal compositions such as suppositories or retention enemas, using, e.g., conventional suppository bases such as cocoa butter or other glycerides.

The formulations for the method of this invention may include an antioxidant, such asBHT (butylated hydroxytoluene). The antioxidant is generally present in amounts of at 0.1-5 percent (wt/vol). Some of the formulations require a solubilizer, such as oleic acid, to dissolve the active agent, particularly if spinosad is included. Common spreading agents used in these pour-on formulations include isopropyl myristate, isopropyl palmitate, caprylic/capric acid esters of saturated C₁₂-C₁₈ fatty alcohols, oleic acid, oleyl ester, ethyl oleate, triglycerides, silicone oils and dipropylene glycol methyl ether. The pour-on formulations for the method of this invention are prepared according to known techniques. Where the pour-on is a solution, the parasiticide/insecticide is mixed with the carrier or vehicle, using heat and stirring if required. Auxiliary or additional ingredients can be added to the mixture of active agent and carrier, or they can be mixed with the active agent prior to the addition of the carrier. Pour-on formulations in the form of emulsions or suspensions are similarly prepared using known techniques.

Other delivery systems for relatively hydrophobic pharmaceutical compounds may be employed. Liposomes and emulsions are well-known examples of delivery vehicles or carriers for hydrophobic drugs. In addition, organic solvents such as dimethylsulfoxide may be used, if needed.

The rate of application required for effective parasitic invertebrate pest control (e.g. “pesticidally effective amount”) will depend on such factors as the species of parasitic invertebrate pest to be controlled, the pest's life cycle, life stage, its size, location, time of year, host crop or animal, feeding behavior, mating behavior, ambient moisture, temperature, and the like. One skilled in the art can easily determine the pesticidally effective amount necessary for the desired level of parasitic invertebrate pest control.

In general for veterinary use, the compounds of the invention are administered in a pesticidally effective amount to an animal, particularly a homeothermic animal, to be protected from parasitic invertebrate pests.

A pesticidally effective amount is the amount of active ingredient needed to achieve an observable effect diminishing the occurrence or activity of the target parasitic invertebrate pest. One skilled in the art will appreciate that the pesticidally effective dose can vary for the various compounds and compositions useful for the method of the present invention, the desired pesticidal effect and duration, the target parasitic invertebrate pest species, the animal to be protected, the mode of application and the like, and the amount needed to achieve a particular result can be determined through simple experimentation.

For oral or parenteral administration to animals, a dose of the compositions of the present invention administered at suitable intervals typically ranges from about 0.01 mg/kg to about 100 mg/kg, and preferably from about 0.01 mg/kg to about 30 mg/kg of animal body weight.

Suitable intervals for the administration of the compositions of the present invention to animals range from about daily to about yearly. Of note are administration intervals ranging from about weekly to about once every 6 months. Of particular note are monthly administration intervals (i.e. administering the compounds to the animal once every month).

### EXAMPLES

The following Examples illustrate, but do not limit, the invention.

The following abbreviations were used in this section: DCE=1,2-dichloroethane, s=singlet; bs=broad singlet; d=doublet; dd=double doublet; dt=double triplet; t=triplet, tt=triple triplet, q=quartet, sept=septet; m=multiplet; Me=methyl; Et=ethyl; Pr=propyl; Bu=butyl; M.p.=melting point; RT=retention time, [M+H]⁺=molecular mass of the molecular cation, [M−H]⁻=molecular mass of the molecular anion, ee=enantiomeric excess.

The following LC-MS methods were used to characterize the compounds:

Method A

| MS | ZQ Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, source temperature (° C.) 100, desolvation temperature | | | |
| | (° C.) 250, cone gas flow (L/Hr) 50, desolvation gas flow (L/Hr) 400, mass | | | |
| | range: 150 to 1000 Da. | | | |
| LC | HP 1100 HPLC from Agilent: solvent degasser, quaternary pump, heated | | | |
| | column compartment and diode-array detector. | | | |
| | Column: Phenomenex Gemini C18, length (mm) 30, internal diameter (mm) 3, | | | |
| | particle size (μm) 3, temperature (° C.) 60, DAD wavelength range (nm): 200 to | | | |
| | 500, solvent gradient: A = 0.05% v/v formic acid in water and B = 0.04% v/v | | | |
| | formic acid in acetonitrile/methanol (4:1). | | | |
| | Time (min) | A % | B % | Flow (ml/min) |
| | 0.0 | 95 | 5.0 | 1.7 |
| | 2.0 | 0.0 | 100 | 1.7 |
| | 2.8 | 0.0 | 100 | 1.7 |
| | 2.9 | 95 | 5.0 | 1.7 |

Method B

| MS | ZMD Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, extractor (V) 3.00, source temperature (° C.) 150, | | | |
| | desolvation temperature (° C.) 320, cone gas flow (L/Hr) 50, desolvation gas | | | |
| | flow (L/Hr) 400, mass range: 150 to 800 Da. | | | |
| LC | Alliance 2795 LC HPLC from Waters: quaternary pump, heated column | | | |
| | compartment and diode-array detector. | | | |
| | Column: Waters Atlantis dc18, length (mm) 20, internal diameter (mm) 3, | | | |
| | particle size (μm) 3, temperature (° C.) 40, DAD wavelength range (nm): 200 to | | | |
| | 500, solvent gradient: A = 0.1% v/v formic acid in water and B = 0.1% v/v | | | |
| | formic acid in acetonitrile. | | | |
| | Time (min) | A % | B % | Flow (ml/min) |
| | 0.0 | 80 | 20 | 1.7 |
| | 5.0 | 0.0 | 100 | 1.7 |
| | 5.6 | 0.0 | 100 | 1.7 |
| | 6.0 | 80 | 20 | 1.7 |

Method C

| MS | ZQ Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, extractor (V) 3.00, source temperature (° C.) 100, | | | |
| | desolvation temperature (° C.) 200, cone gas flow (L/Hr) 200, desolvation gas | | | |
| | flow (L/Hr) 250, mass range: 150 to 800 Da. | | | |
| LC | 1100er Series HPLC from Agilent: quaternary pump, heated column | | | |
| | compartment and diode-array detector. | | | |
| | Column: Waters Atlantis dc18, length (mm) 20, internal diameter (mm) 3, | | | |
| | particle size (μm) 3, temperature (° C.) 40, DAD wavelength range (nm): 200 to | | | |
| | 500, solvent gradient: A = 0.1% v/v formic acid in water and B = 0.1% v/v | | | |
| | formic acid in acetonitrile. | | | |
| | Time (min) | A % | B % | Flow (ml/min) |
| | 0.0 | 90 | 10 | 1.7 |
| | 5.5 | 0.0 | 100 | 1.7 |
| | 5.8 | 0.0 | 100 | 1.7 |
| | 5.9 | 90 | 10 | 1.7 |

Method D

| MS | ZMD Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, extractor (V) 3.00, source temperature (° C.) 150, | | | |
| | desolvation temperature (° C.) 320, cone gas flow (L/Hr) 50, desolvation gas | | | |
| | flow (L/Hr) 400, mass range: 150 to 800 Da. | | | |
| LC | Alliance 2795 LC HPLC from Waters: quaternary pump, heated column | | | |
| | compartment and diode-array detector. | | | |
| | Column: Waters Atlantis dc18, length (mm) 20, internal diameter (mm) 3, | | | |
| | particle size (μm) 3, temperature (° C.) 40, DAD wavelength range (nm): 200 to | | | |
| | 500, solvent gradient: A = 0.1% v/v formic acid in water and B = 0.1% v/v | | | |
| | formic acid in acetonitrile. | | | |
| | Time (min) | A % | B % | Flow (ml/min) |
| | 0.0 | 80 | 20 | 1.7 |
| | 2.5 | 0.0 | 100 | 1.7 |
| | 2.8 | 0.0 | 100 | 1.7 |
| | 2.9 | 80 | 20 | 1.7 |

Method E

| MS | ZQ Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, extractor (V) 3.00, source temperature (° C.) 100, | | | |
| | desolvation temperature (° C.) 200, cone gas flow (L/Hr) 200, desolvation gas | | | |
| | flow (L/Hr) 250, mass range: 150 to 800 Da. | | | |
| LC | 1100er Series HPLC from Agilent: quaternary pump, heated column | | | |
| | compartment and diode-array detector. | | | |
| | Column: Waters Atlantis dc18, length (mm) 20, internal diameter (mm) 3, | | | |
| | particle size (μm) 3, temperature (° C.) 40, DAD wavelength range (nm): 200 to | | | |
| | 500, solvent gradient: A = 0.1% v/v formic acid in water and B = 0.1% v/v | | | |
| | formic acid in acetonitrile. | | | |
| | Time (min) | A % | B % | Flow (ml/min) |
| | 0.0 | 80 | 20 | 1.7 |
| | 2.5 | 0.0 | 100 | 1.7 |
| | 2.8 | 0.0 | 100 | 1.7 |
| | 2.9 | 80 | 20 | 1.7 |

Method F

| MS | ZQ Mass Spectrometer from Waters (single quadrupole mass spectrometer), | | | |
|---|---|---|---|---|
| | ionization method: electrospray, polarity: negative ionization, capillary (kV) | | | |
| | 3.00, cone (V) 45.00, source temperature (° C.) 100, desolvation temperature | | | |
| | (° C.) 250, cone gas flow (L/Hr) 50, desolvation gas flow (L/Hr) 400, mass | | | |
| | range: 150 to 1000 Da. | | | |
| LC | HP 1100 HPLC from Agilent: solvent degasser, binary pump, heated column | | | |
| | compartment and diode-array detector. | | | |
| | Column: Phenomenex Gemini C18, length (mm) 30, internal diameter (mm) 3, | | | |
| | particle size (μm) 3, temperature (° C.) 60, DAD wavelength range (nm): 200 to | | | |
| | 500, solvent gradient: A = 0.05% v/v formic acid in water and B = 0.04% v/v | | | |
| | formic acid in acetonitrile/methanol (4:1). | | | |
| | Time (min) | A % | B % | Flow (ml/min) |
| | 0.0 | 95 | 5.0 | 1.7 |
| | 2.0 | 0.0 | 100 | 1.7 |
| | 2.8 | 0.0 | 100 | 1.7 |
| | 2.9 | 95 | 5.0 | 1.7 |
| | 3.1 | 95 | 5 | 1.7 |

Method G

| MS | ZQ Mass Spectrometer from Waters (single quadrupole mass spectrometer), | | | |
|---|---|---|---|---|
| | ionization method: electrospray, polarity: negative ionization, capillary (kV) | | | |
| | 3.00, cone (V) 30.00, source temperature (° C.) 100, desolvation temperature | | | |
| | (° C.) 250, cone gas flow (L/Hr) 50, desolvation gas flow (L/Hr) 400, mass | | | |
| | range: 100 to 900 Da. | | | |
| LC | HP 1100 HPLC from Agilent: solvent degasser, quaternary pump (ZDQ), | | | |
| | heated column compartment and diode-array detector. | | | |
| | Column: Phenomenex Gemini C18, length (mm) 30, internal diameter (mm) 3, | | | |
| | particle size (μm) 3, temperature (° C.) 60, DAD wavelength range (nm): 200 to | | | |
| | 500, solvent gradient: A = 0.05% v/v formic acid in water and B = 0.04% v/v | | | |
| | formic acid in acetonitrile/methanol (4:1). | | | |
| | Time (min) | A % | B % | Flow (ml/min) |
| | 0.0 | 95 | 5.0 | 1.7 |
| | 2.0 | 0.0 | 100 | 1.7 |
| | 2.8 | 0.0 | 100 | 1.7 |
| | 2.9 | 95 | 5.0 | 1.7 |
| | 3.0 | 95 | 5 | 1.7 |

Method H

| MS | ZMD Mass Spectrometer from Waters (single quadrupole mass spectrometer), | | | |
|---|---|---|---|---|
| | ionization method: electrospray, polarity: positive ionization, capillary (kV) | | | |
| | 3.80, cone (V) 30.00, extractor (V) 3.00, source temperature (° C.) 150, | | | |
| | desolvation temperature (° C.) 350, cone gas flow (L/Hr) OFF, desolvation gas | | | |
| | flow (L/Hr) 600, mass range: 100 to 900 Da. | | | |
| LC | HP 1100 HPLC from Agilent: solvent degasser, binary pump, heated column | | | |
| | compartment and diode-array detector. | | | |
| | Column: Phenomenex Gemini C18, length (mm) 30, internal diameter (mm) 3, | | | |
| | particle size (μm) 3, temperature (° C.) 60, DAD wavelength range (nm): 200 to | | | |
| | 500, solvent gradient: A = 0.05% v/v formic acid in water and B = 0.04% v/v | | | |
| | formic acid in acetonitrile/methanol (4:1). | | | |
| | Time (min) | A % | B % | Flow (ml/min) |
| | 0.0 | 95 | 5.0 | 1.7 |
| | 2.0 | 0.0 | 100 | 1.7 |
| | 2.8 | 0.0 | 100 | 1.7 |
| | 2.9 | 95 | 5.0 | 1.7 |
| | 3.0 | 95 | 5 | 1.7 |

The following Chiral HPLC method was used to characterize the compounds:

Method I

| | |
|---|---|
| CHIRAL | Alliance 2695 HPLC from Waters: solvent degasser, binary |
| HPLC | pump, heated column compartment and diode-array detector |
| | Column: Chiralpak IC, length (mm) 250, internal diameter |
| | (mm) 4.6, particle size (μ) 5, wavelength (nm): 220 nm, |
| | temperature (° C.) 30, solvent: Isocratic isopropyl |
| | alcohol:heptane 20:80, injection volume 25 uL, flow |
| | (ml/min) 1. |

Method J

| | |
|---|---|
| CHIRAL | Alliance 2695 HPLC from Waters: solvent degasser, binary |
| HPLC | pump, heated column compartment and diode-array detector |
| | Column: Chiralpak IC, length (mm) 250, internal diameter |
| | (mm) 4.6, particle size (μ) 5, wavelength (nm): 220 nm, |
| | temperature (° C.) 30, solvent: Isocratic isopropyl |
| | alcohol:heptane:diethylamine 30:70:0.1, injection volume |
| | 25 uL, flow (ml/min) 1. |

### Example 1A

### Catalyst Preparation: Anthracenyl-methyl quininium chloride

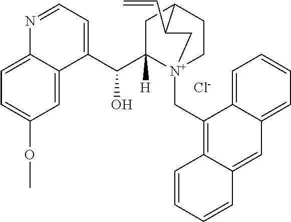 [SMILES: C=CC1C[N+]2(Cc3c4ccccc4cc4ccccc34)CCC1C[C@H]2[C@H](O)c1ccnc2ccc(OC)cc12 ; [Cl-]]

A solution of 9-chloromethyl-anthracene (0.91 g) and quinine (1 g) in toluene (7 ml) was heated at 90° C. for 18 hours. The reaction mixture was filtered, washed with n-heptane. The solid was recrystallised from chloroform and n-heptane to afford the title product (1.69 g) as a yellow solid. M.p. 150-152° C. (decomposed). LCMS (method H) 1.31 min, M⁺ 515; ¹H NMR (400 MHz, CDCl₃) 9.15 (d, 1H), 8.65 (d, 1H), 8.53 (d, 1H), 8.40 (s, 1H), 8.00 (m, 3H), 7.88 (d, 1H), 7.71 (s, 1H), 7.68 (t, 1H), 7.53 (t, 1H), 7.45 (m, 2H), 7.33 (dd, 1H), 7.11 (d, 1H), 7.02 (d, 1H), 6.22 (d, 1H), 5.51 (m, 1H), 5.15 (m, 1H), 4.98 (m, 2H), 4.38 (m, 1H), 3.98 (s, 3H), 3.48 (m, 1H), 2.90 (m, 1H), 2.63 (t, 1H), 2.20 (m, 2H), 1.85 (m, 2H), 1.45 (m, 2H).

### Example 1B

### Catalyst Preparation: Anthracenyl-methyl dihydroquininium chloride

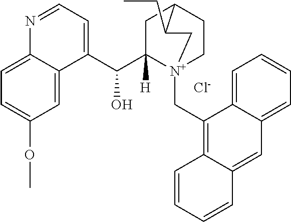 [SMILES: CCC1C[N+]2(Cc3c4ccccc4cc4ccccc34)CCC1C[C@H]2[C@H](O)c1ccnc2ccc(OC)cc12 ; [Cl-]]

A solution of 9-chloromethylanthracenyl (0.45 g) and hydroquinine (0.5 g) in toluene (9 ml) was heated at 80° C. for 18 hours. The reaction mixture was poured in diethyl ether and then filtrated to afford the title product as a yellow solid (0.60 g). ¹H NMR (400 MHz, CDCl₃) 9.33 (d, 1H), 8.72 (d, 1H), 8.54 (bs, 1H), 8.34 (d, 1H), 8.03-8.09 (m, 2H), 7.95-8.01 (m, 3H), 7.75-7.80 (m, 1H), 7.65 (d, 1H), 7.56-7.62 (m, 1H), 7.47-7.54 (m, 2H), 7.37-7.41 (m, 1H), 7.08-7.19 (m, 2H), 5.93 (d, 1H), 5.23-5.32 (m, 1H), 4.15 (t, 1H), 3.97 (s, 3H), 2.90-2.99 (m, 2H), 2.67 (t, 1H), 2.29-2.39 (m, 2H), 1.87 (bs, 1H), 1.33-1.50 (m, 3H), 1.10-1.19 (m, 2H), 0.55 (t, 3H).

### Example 2

### Catalyst Preparation: 2,4,6-pentafluorophenyl-methyl quininium bromide

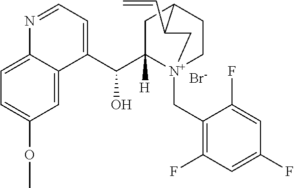 [SMILES: C=CC1C[N+]2(Cc3c(F)cc(F)cc3F)CCC1C[C@H]2[C@H](O)c1ccnc2ccc(OC)cc12 ; [Br-]]

A solution of 1-bromomethyl-2,4,6-pentafluorobenzene (0.45 g) and quinine (0.5 g) in toluene (9 ml) was heated at 80° C. for 18 hours. The reaction mixture was poured in diethyl ether and then filtrate to afford the title product as a white solid (0.80 g). LCMS (method H) 1.02 min, M⁺ 469; ¹H NMR (400 MHz, DMSO-d₆) 8.82 (d, 1H), 8.05 (d, 1H), 7.78 (d, 1H), 7.54 (q, 2H), 7.41 (m, 1H), 7.21 (m, 1H), 6.79 (m, 1H), 6.57 (m, 1H), 5.77 (m, 1H), 5.42 (d, 1H), 5.09 (d, 1H), 5.04 (d, 1H), 4.63 (d, 1H), 4.18 (m, 2H), 3.98 (s, 3H), 3.59 (m, 2H), 2.71 (m, 1H), 2.20 (m, 2H), 2.05 (m, 1H), 1.87 (m, 1H), 1.42 (m, 1H).

### Example 3

### Catalyst Preparation: 2,3,4,5,6-pentafluorophenyl-methyl quininium bromide

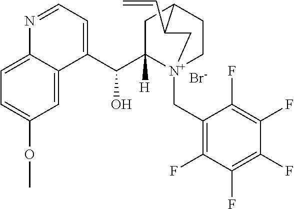 [SMILES: C=CC1C[N+]2(Cc3c(F)c(F)c(F)c(F)c3F)CCC1C[C@H]2[C@H](O)c1ccnc2ccc(OC)cc12 ; [Br-]]

A solution of 1-bromomethyl-2,3,4,5,6-pentafluorobenzene (0.52 g) and quinine (0.5 g) in toluene (9 ml) was heated at 80° C. for 18 hours. The reaction mixture was poured in diethyl ether and then filtrate to afford the title product as a white solid (0.90 g). M.p. 162-165° C. (decomposed). LCMS (method G) 1.08 min, M⁺ 505; ¹H NMR (400 MHz, CDCl₃) 8.78 (d, 1H), 8.05 (d, 1H), 7.78 (d, 1H), 7.39 (dd, 1H), 7.18 (d, 1H), 6.73 (m, 1H), 6.41 (d, 1H), 6.09 (d, 1H), 5.50 (m, 1H), 5.04 (d, 1H), 4.98 (d, 1H), 4.70 (m, 1H), 4.63 (d, 1H), 3.98 (s, 3H), 3.97 (m, 1H), 3.74 (m, 2H), 3.10 (m, 1H), 2.81 (m, 1H), 2.30 (m, 2H), 2.05 (m, 2H), 1.41 (m, 1H). ¹⁹F NMR (376 MHz, CDCl₃) −132.67 (s, 1F), −146.60 (s, 2F), −158.28 (s, 2F).

### Example 4

### Catalyst Preparation: 2,3,4,5,6-pentafluorophenyl-methyl quininium chloride

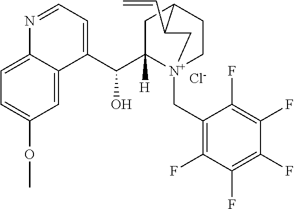 [SMILES: C=CC1C[N+]2(Cc3c(F)c(F)c(F)c(F)c3F)CCC1C[C@H]2[C@H](O)c1ccnc2ccc(OC)cc12 ; [Cl-]]

A solution of 1-chloromethyl-2,3,4,5,6-pentafluorobenzene (0.42 g) and quinine (0.50 g) in toluene (9 ml) was heated at 80° C. for 18 hours. The reaction mixture was poured in diethyl ether and then filtrate to afford the title product as a pale yellow solid (0.3 g). LCMS (method G) 1.10 min, M⁺ 505; ¹H NMR (400 MHz, CDCl₃) 8.78 (d, 1H), 7.95 (d, 1H), 7.78 (d, 1H), 7.31 (dd, 1H), 7.21 (d, 1H), 6.75 (s, 1H), 6.25 (d, 1H), 5.50 (m, 1H), 5.00 (m, 2H), 4.88 (d, 1H), 3.98 (s, 3H). ¹⁹F NMR (376 MHz, CDCl₃) −132.67 (s, 1F), −146.60 (s, 2F), −158.28 (s, 2F).

### Example 5

### Catalyst Preparation: 6-chloropiperonyl quininium chloride

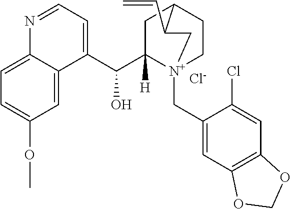 [SMILES: C=CC1C[N+]2(Cc3cc4c(cc3Cl)OCO4)CCC1C[C@H]2[C@H](O)c1ccnc2ccc(OC)cc12 ; [Cl-]]

A solution of 6-chloropiperonyl chloride (0.41 g) and quinine (0.50 g) in toluene (9 ml) was heated at 80° C. for 18 hours. The reaction mixture was poured in diethyl ether and then filtrate to afford the title product as a pale yellow solid (0.75 g). LCMS (method H) 1.12 min, M⁺ 494; ¹H NMR (400 MHz, CDCl₃) 8.83 (d, 1H), 8.11 (d, 1H), 7.86 (m, 2H), 7.41 (m, 2H), 7.09 (d, 1H), 6.98 (s, 1H), 6.72 (m, 2H), 6.10 (s, 2H), 5.61 (m, 1H), 5.12 (d, 1H), 5.05 (d, 1H), 4.62 (d, 1H), 3.98 (s, 3H), 3.67 (m, 1H), 3.38 (dd, 1H), 3.19 (m, 2H), 2.58 (m, 2H), 2.33 (m, 1H), 2.10 (m, 1H), 1.83 (m, 1H), 1.48 (m, 1H).

### Example 6

### Catalyst Preparation: 3,4,5-trimethoxybenzyl quininium chloride

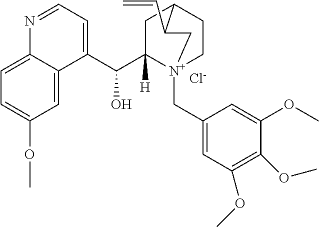 [SMILES: C=CC1C[N+]2(Cc3cc(OC)c(OC)c(OC)c3)CCC1C[C@H]2[C@H](O)c1ccnc2ccc(OC)cc12 ; [Cl-]]

A solution of 3,4,5-trimethoxybenzyl chloride (0.42 g) and quinine (0.50 g) in toluene (9 ml) was heated at 80° C. for 18 hours. The reaction mixture was poured in diethyl ether and then filtrate to afford the title product as a white solid (0.848 g). LCMS (method G) 1.06 min, M⁺ 505; ¹H NMR (400 MHz, CDCl₃) 8.75 (d, 1H), 8.05 (d, 1H), 7.71 (d, 1H), 7.37 (m, 2H), 7.08 (s, 2H), 6.67 (d, 1H), 6.11 (d, 1H), 5.61 (m, 1H), 5.12 (m, 2H), 4.61 (d, 1H), 3.98 (s, 3H), 3.87 (s, 3H), 3.81 (s, 6H), 3.70 (t, 1H), 3.15 (m, 2H), 2.65 (m, 1H), 2.37 (m, 2H), 2.09 (m, 1H), 1.79 (m, 3H), 1.58 (t, 1H).

### Example 7

### Catalyst Preparation: 4-methylpyridine quininium chloride

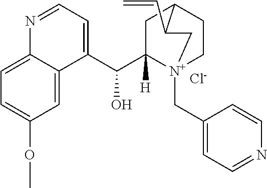 [SMILES: C=CC1C[N+]2(Cc3ccncc3)CCC1C[C@H]2[C@H](O)c1ccnc2ccc(OC)cc12 ; [Cl-]]

A solution of 4-chloromethyl-pyridine hydrochloride (0.41 g) and potassium bicarbonate (0.22 g) in toluene (9 ml) was stirred for 1 hour. Then quinine (0.50 g) was added to the suspension and the reaction mixture was heated at 80° C. for 18 hours. The reaction mixture was poured in a mixture of water and diethyl ether, then filtrate, dried in vacuo at 35° C. to afford the title product as a red solid (0.30 g). LCMS (method G) 0.76 min, M⁺ 516; ¹H NMR (400 MHz, CDCl₃) 8.71 (d, 1H), 8.65 (d, 2H), 7.95 (d, 1H), 7.74 (m, 3H), 7.29 (m, 1H), 6.58 (m, 1H), 6.28 (d, 1H), 5.55 (m, 1H), 5.10 (m, 3H), 3.94 (s, 3H), 3.54 (m, 1H), 3.38 (m, 2H), 3.00 (m, 2H), 2.61 (m, 1H), 2.31 (m, 1H), 2.05 (m, 2H), 1.74 (m, 2H), 1.41 (m, 1H).

### Example 8

### Catalyst Preparation: 2,6-dichloro-4-methyl-pyridine quininium chloride

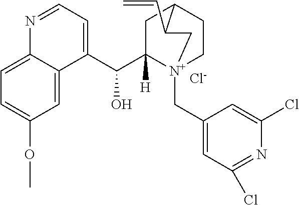 [SMILES: C=CC1C[N+]2(Cc3cc(Cl)nc(Cl)c3)CCC1C[C@H]2[C@H](O)c1ccnc2ccc(OC)cc12 ; [Cl-]]

A solution of 2,6-dichloro-4-chloromethyl-pyridine (0.14 g) and quinine (0.18 g) in toluene (3 ml) was heated at 80° C. for 18 hours. The reaction mixture was poured in diethyl ether and then filtrate to afford the title product as a white solid (0.10 g). LCMS (method G) 1.07 min, M⁺ 485; ¹H NMR (400 MHz, DMSO-d₆) 8.81 (d, 1H), 8.05 (s, 2H), 8.03 (d, 1H), 7.73 (d, 1H), 7.48 (dd, 1H), 7.21 (d, 1H), 6.48 (s, 1H), 5.75 (m, 1H), 5.58 (m, 1H), 5.15 (d, 1H), 5.03 (d, 1H), 4.72 (d, 1H), 4.42 (m, 1H), 4.01 (s, 3H), 3.78 (m, 1H), 3.68 (m, 1H), 3.51 (t, 1H), 3.27 (m, 1H), 2.63 (m, 1H), 2.18 (m, 2H), 2.05 (m, 1H), 1.78 (m, 1H), 1.45 (m, 1H).

### Example 9

### Chiral Separation

### 4-[5-(3,5-Dichloro-phenyl)-5-trifluoromethyl-4,5-dihydro-isoxazol-3-yl]-2-methyl-N-thietan-3-yl-benzamide

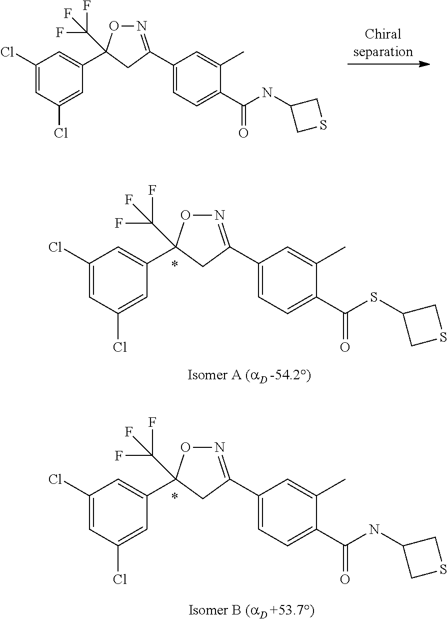 [SMILES: Cc1cc(C2=NOC(c3cc(Cl)cc(Cl)c3)(C(F)(F)F)C2)ccc1C(=O)NC1CSC1 ; Cc1cc(C2=NOC(c3cc(Cl)cc(Cl)c3)(C(F)(F)F)C2)ccc1C(=O)SC1CSC1 ; Cc1cc(C2=NOC(c3cc(Cl)cc(Cl)c3)(C(F)(F)F)C2)ccc1C(=O)NC1CSC1]

4-[5-(3,5-Dichloro-phenyl)-5-trifluoromethyl-4,5-dihydro-isoxazol-3-yl]-2-methyl-N-thietan-3-yl-benzamide (0.97 g; prepared as described in WO09080250) was separated through chiral phase preparative HPLC (Column: CHIRALPAK® IC 5 μm; Mobile Phase: 90/10 Carbon Dioxide/Ethanol; Flow Rate: 120 ml/min; Detection: 230 nm; Temperature: 25° C.; Outlet Pressure: 150 bars) to afford 0.38 g of 4-[5-(3,5-dichloro-phenyl)-5-trifluoromethyl-4,5-dihydro-isoxazol-3-yl]-2-methyl-N-thietan-3-yl-benzamide ISOMER A (α_{D} −54.2°, and 0.35 g 4-[5-(3,5-dichloro-phenyl)-5-trifluoromethyl-4,5-dihydro-isoxazol-3-yl]-2-methyl-N-thietan-3-yl-benzamide ISOMER B (α_{D} +53.7°). Similarly 4-[5-(3,5-dichloro-phenyl)-5-trifluoromethyl-4,5-dihydro-isoxazol-3-yl]-2-methyl-N-(cis-1-oxide-thietan-3-yl)-benzamide (1.98 g; prepared as described in WO09080250) was resolved to afford 0.81 g of 4-[5-(3,5-dichloro-phenyl)-5-trifluoromethyl-4,5-dihydro-isoxazol-3-yl]-2-methyl-N-(cis-1-oxide-thietan-3-yl)-benzamide ISOMER A (α_{D} −46.2° and 0.83 g of ISOMER B (α_{D} +48.4°. Similarly 4-[5-(3,5-dichloro-phenyl)-5-trifluoromethyl-4,5-dihydro-isoxazol-3-yl]-2-methyl-N-(1,1-dioxo-thietan-3-yl)-benzamide (0.94 g; prepared as described in WO09080250) was resolved to afford 0.44 g of 4-[5-(3,5-dichloro-phenyl)-5-trifluoromethyl-4,5-dihydro-isoxazol-3-yl]-2-methyl-N-(1,1-dioxo-thietan-3-yl)-benzamide ISOMER A (α_{D} −50.2°; and 0.45 g of ISOMER B (α_{D} +51.1°.

### Example 10

### Intermediate Preparation

### 4-[(E)-3-(3,5-dichloro-phenyl)-4,4,4-trifluoro-but-2-enoyl]-2-methyl-N-thietan-3-yl-benzamide

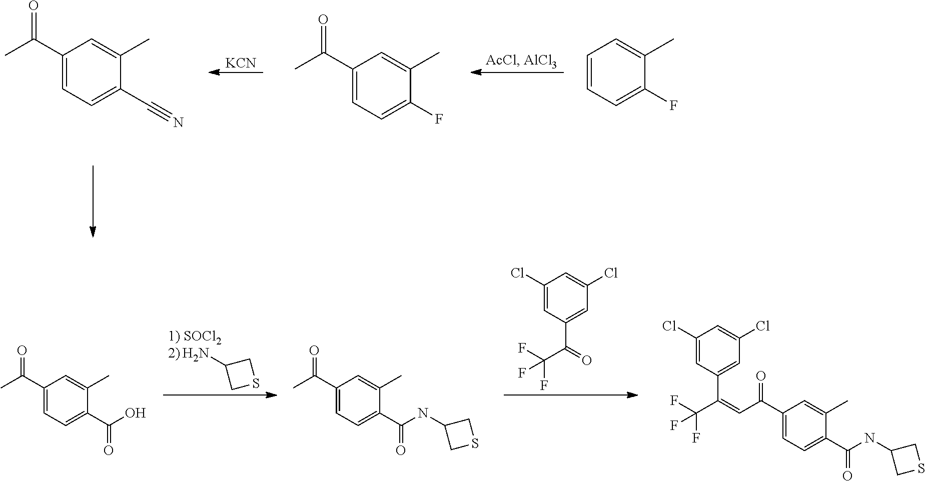

### Step A: 1-(4-Fluoro-3-methyl-phenyl)-ethanone

To a solution of 2-fluorotoluene (10.0 g, 90.8 mmol) and acetyl chloride (6.64 ml, 93.4 mmol) in dry CH₂Cl₂ (50 ml) was added portion-wise AlCl₃ (15.3 g, 115 mmol) (caution: vigorous exothermic reaction). The reaction was stirred at room temperature for 24 h. To complete the reaction, the mixture was heated to reflux for 2 h. The reaction mixture was quenched with saturated aqueous Na₂CO₃, diluted with Et₂O and filtered through a pad of Celite®. The organic phase was then separated, washed with saturated aqueous NaCl, dried over Na₂SO₄ and concentrated in vacuo. Purification by flash chromatography (SiO₂, Heptane:Ethylacetate 97:3 to 90:10) gave the title product as a pale brown oil (13.6 g). ¹H NMR (400 MHz, CDCl₃) 7.83 (d, 1H), 7.77-7.81 (m, 1H), 7.06 (t, 1H), 2.58 (s, 3H), 2.32 (d, 3H).

### Step B: 1-(4-Cyano-3-methyl-phenyl)-ethanone

1-(4-Fluoro-3-methyl-phenyl)-ethanone (2.02 g, 13.3 mmol) was dissolved in DMSO (4.5 ml) and then NaCN (0.81 g, 16.6 mmol) was added. The resulting mixture was heated for 12 h at 120° C. The cooled reaction mixture was then diluted with CH₂Cl₂ and washed with water. The water phase was back-extracted with CH₂Cl₂ (3×). The combined organics were washed with H₂O (3×), saturated aqueous NaCl (1×), dried over Na₂SO₄, filtrated and concentrated under reduced pressure to afford an orange oil (2.1 g). ¹H NMR (400 MHz, CDCl₃): 7.89 (s, 1H), 7.83 (d, 1H), 7.71 (d, 1H), 2.63 (s, 3H), 2.62 (s, 3H).

### Step C: 4-Acetyl-2-methyl-benzoic acid

A pale yellow solution of 1-(4-Cyano-3-methyl-phenyl)-ethanone (4.54 g, 28.5 mmol) in AcOH (23 ml), H₂O (23 ml) and concentrated H₂SO₄ (23 ml) was refluxed for 5 h and stirred at room temperature overnight. The resulting orange slurry was adjusted to pH≈10 with 175 ml NaOH 30%. The resulting orange solution was washed with AcOEt (2×250 mL). The aqueous layer was acidified with concentrated HCl (100 ml) to pH=1 and then extracted with AcOEt (2×200 ml). The organic phase was washed with H₂O (1×200 mL), dried over Na₂SO₄, filtrated and evaporated under reduced pressure to give an orange solid (4.94 g). The orange solid was dissolved in CH₂Cl₂ (150 ml) and water (100 ml) followed by 30% NaOH (50 ml) were successively added. The water phase was washed with CH₂Cl₂ (2×50 mL). To the aqueous phase HCl conc. (90 ml) was added. The resulting precipitate was then filtered off and washed with water. The residue was then dissolved in CH₂Cl₂. The organic phase was dried over Na₂SO₄, filtrated and concentrated under reduced pressure to give a pale orange solid (3.3 g). LCMS (method F) RT=1.21 min, [M+H⁺]=179; ¹H NMR (400 MHz, DMSO-d₆): 13.2 (bs, 1H), 7.82-7.91 (m, 3H), 2.61 (s, 3H), 2.58 (s, 3H).

### Step D: 4-Acetyl-2-methyl-N-thietan-3-yl-benzamide

4-Acetyl-2-methyl-benzoic acid (70 g, 39.3 mmol) was dissolved in CH₂Cl₂ (700 ml) and oxalyl chloride (109 g, 86 mmol) DMF (1 mL) were successively added. The reaction mixture was stirred overnight at room temperature. The mixture was then concentrated in vacuo to afford a brown oil (82 g). The acid chloride was redissolved in CH₂Cl₂ (500 ml) and cooled to 0° C. A solution of hydro thietane-3-yl amine trifluoroacetate (prepared as described in WO09080250, 92 g, 34 mmol) and Et₃N (200 g, 200 mmol) in CH₂Cl₂ (400 mL) was then added dropwise. The resulting mixture was stirred overnight at room temperature. NaOH 10% was added. The mixture was washed successively with water and with 2N HCl (300 ml). The organic layer was dried over Na₂SO₄ and evaporated in vacuo to afford brown oil (132 g). Purification by silica gel chromatography (CH₂Cl₂:Ethyl acetate 2:1) afforded the title compound as a yellow solid (34 g). LCMS (method F) RT=1.21 min, [M+H⁺]=250. ¹H NMR (400 MHz, CDCl₃): 7.82 (s, 1H), 7.79 (d, 1H), 7.43 (d, 1H), 6.21 (bs, 1H), 5.43 (q, 1H), 3.50 (t, 2H), 3.39 (t, 2H), 2.61 (s, 3H), 2.49 (s, 3H).

### Step E: 4-[(E)-3-(3,5-dichloro-phenyl)-4,4,4-trifluoro-but-2-enoyl]-2-methyl-N-thietan-3-yl-benzamide

4-Acetyl-2-methyl-N-thietan-3-yl-benzamide (0.25 g, 1 mmol), 3,5 dichloro 2,2,2 trifluoroacetophenone (0.24 g, 1 mmol) potassium carbonate (138 mg, 1 mmol) and triethylamine (10 mg, 0.1 mmol) were dissolved in 1,2 dichloroethane (2.5 ml). The resulting mixture was refluxed for 3 h. The reaction mixture was cooled to room temperature and saturated aqueous NH₄Cl was added. The mixture was extracted with CH₂Cl₂ (3×50 ml). The combined organic extracts were dried over Na₂SO₄ and concentrated in vacuo to afford a brown solid (0.51 g). Purification by silica gel chromatography (Heptane:Ethyl acetate 2:1) afforded the title compound as a yellow solid (0.33 g). LCMS (method F) RT=2.09 min, [M+H⁺]=474, 476, 477. ¹H NMR (400 MHz, CDCl₃): 7.65-7.67 (m, 2H), 7.40-7.43 (m, 1H), 7.36-7.37 (m, 1H), 7.34 (t, 1H), 7.15 (s, 2H), 6.17 (d, 1H), 5.42 (q, 1H), 3.50 (t, 2H), 3.38 (t, 2H), 2.46 (s, 3H).

### Example 11

### Intermediate Preparation

### 4-[(E)-3-(3,5-dichloro-phenyl)-4,4,4-trifluoro-but-2-enoyl]-2-methyl-N-(cis-1-oxide-thietan-3-yl)-benzamide

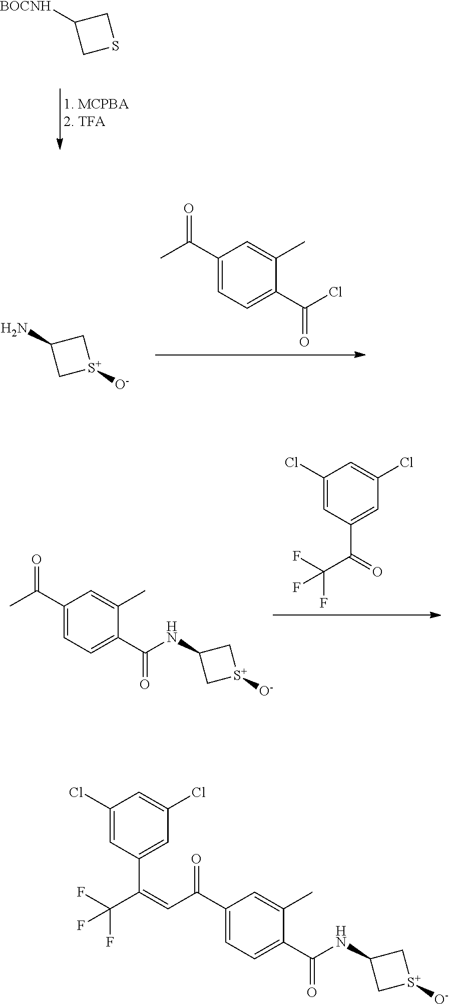

### Step A: cis-1-oxide-thietan-3-ylamine

Thietan-3-yl-carbamic acid tert-butyl ester (prepared as described in WO09080250, 5.0 g, 26.4 mmol) was dissolved in dichloromethane (400 ml), followed by the addition of NaHCO₃ as a solution in water (150 ml). The reaction mixture was cooled to 0° C. and under strong stirring, 3-chloroperbenzoic acid (6.5 g, 264.4 mmol) was added dropwise as a solution in dichloromethane (100 ml) within 30 minutes. The reaction mixture temperature did not go over 4° C. during the addition. Dichloromethane (50 ml) was added for washing, and the reaction mixture was stirred at around 2-3° C. during 2 hours. Immiscible phases were separated, and the aqueous phase was extracted with dichloromethane (3×). The combined organic phases were collected, dried over Na₂SO₄, filtered and concentrated in vacuo to give a white solid (5.3 g). This crude product was purified by silica gel chromatography (ethyl acetate/heptane/methanol 75:25:0-100:0:0-80:0:20) and first afforded cis-1-oxide-thietan-3-yl carbamic acid tert-butyl ester (2.09 g), then a mixture of both cis-1-oxide-thietan-3-yl carbamic acid tert-butyl ester and trans-1-oxide-thietan-3yl carbamic acid tert-butyl ester (1.15 g), and finally 1,1-dioxide-thietan-3-yl carbamic acid tert-butyl ester (0.92 g).

To a solution of cis-1-oxide-thietan-3-yl carbamic acid tert-butyl ester (10 g, 5.3 mmol) at 0° C. was added trifluoroacetic acid (6.5 g, 5.7 mmol). The resulting mixture was stirred at 0° C. overnight and was then concentrated in vacuo to afford the title salt as a yellow oil (12.1 g), which was used without further purification in the next step. ¹H NMR (400 MHz, DMSO-d₆): 12.1 (bs, 1H), 8.73 (bs, 2H), 4.50-4.57 (m, 2H), 4.35-4.43 (m, 2H), 4.07-4.16 (m, 1H).

### Step B: 4-Acetyl-2-methyl-N-(cis-1-oxide-thietan-3-yl)-benzamide

To a solution of cis-1-oxide-thietan-3-ylamine (2.2 g, 10 mmol) and 4-Acetyl-2-methyl-benzoic acid chloride (2 g, 10 mmol) in CH₂Cl₂ (21 ml) was added triethylamine (5.05 g, 50 mmol) at 0° C. The resulting mixture was stirred at room temperature overnight. The mixture was quenched with saturated aqueous NH₄Cl. The aqueous phase was extracted with CH₂Cl₂ (3×50 mL). The combined organic phases were washed with saturated aqueous Na₂CO₃, dried over Na₂SO₄ and concentrated in vacuo to afford the title compound as an amber solid (2.2 g). ¹H NMR (400 MHz, CDCl₃): 7.80 (s, 1H), 7.77 (d, 1H), 7.44 (d, 1H), 6.66 (d, 1H), 4.69 (q, 1H), 4.17-4.32 (m, 2H), 3.29 (dt, 2H), 2.61 (s, 3H), 2.48 (s, 3H).

### Step C: 4-[(E)-3-(3,5-dichloro-phenyl)-4,4,4-trifluoro-but-2-enoyl]-2-methyl-N-(cis-1-oxide-thietan-3-yl-benzamide

4-Acetyl-2-methyl-N-(cis-1-dioxide-thietan-3-yl)-benzamide (1.0 g, 3.7 mmol), (3,5 dichloro 2,2,2 trifluoroacetophenone (0.9 g, 3.7 mmol) potassium carbonate (0.52 g, 3.7 mmol) and triethylamine (40 mg, 0.37 mmol) were dissolved in 1,2 dichloroethane (11 ml). The resulting mixture was refluxed overnight. The reaction mixture was cooled to room temperature and was diluted with warm (40° C.) ethyl acetate, water was added, and the separated aqueous layer was extracted with warm EtOAc, the organic layer was washed brine with dried with Na₂SO₄ and concentrated in vacuo to afford an off white solid (1.8 g). LCMS (method F) RT=1.89 min, [M+H⁺]=490, 492. ¹H NMR (400 MHz, CDCl₃): 7.66-7.68 (m, 2H), 7.42-7.45 (m, 2H), 7.36-7.38 (m, 1H), 7.34 (t, 1H), 7.15 (d, 2H), 6.54 (d, 1H), 4.64-4.75 (m, 1H), 4.17-4.24 (m, 2H), 3.25 (dt, 2H), 2.46 (s, 3H).

### Example 12

### Intermediate Preparation

### 4-[(E)-3-(3,5-dichloro-phenyl)-4,4,4-trifluoro-but-2-enoyl]-2-methyl-N-(1,1-dioxide-thietan-3-yl)-benzamide

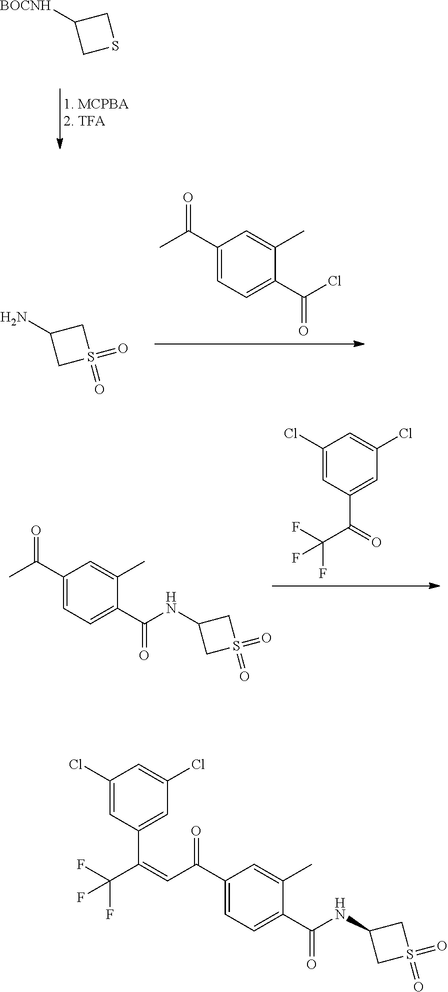

### Step A: 1,1-dioxide-thietan-3-ylamine

Thietan-3-yl-carbamic acid tert-butyl ester (prepared as described in WO09080250, 5.0 g, 26.4 mmol) was dissolved in dichloromethane (400 ml), followed by the addition of NaHCO₃ as a solution in water (150 ml). The reaction mixture was cooled to 0° C. and under a strong stirring, 3-chloroperbenzoic acid (6.5 g, 264.4 mmol) was added dropwise as a solution in dichloromethane (100 ml) within 30 minutes. The reaction mixture temperature did not go over 4° C. during the addition. Dichloromethane (50 ml) was added for washing, and the reaction mixture was stirred at around 2-3° C. during 2 hours. Immiscible phases were separated, and the aqueous phase was extracted with dichloromethane (3×). The combined organic phases were collected, dried over Na₂SO₄, filtered and concentrated in vacuo to give a white solid (5.3 g). This crude product was purified by silica gel chromatography (ethyl acetate/heptane/methanol 75:25:0-100:0:0-80:0:20) and first afforded cis-1-oxide-thietan-3-yl carbamic acid tert-butyl ester (2.09 g), then a mixture of both cis-1-oxide-thietan-3-yl carbamic acid tert-butyl ester and trans-1-oxide-thietan-3yl carbamic acid tert-butyl ester (1.15 g), and finally 1,1-dioxide-thietan-3-yl carbamic acid tert-butyl ester (0.92 g).

To a solution of 1,1-dioxide-thietan-3-yl carbamic acid tert-butyl ester (1.0 g, 4.5 mmol) was added trifluoroacetic acid (1 ml, 12.9 mmol). The resulting mixture was stirred for 2 h at room temperature. Another injection of trifluoroacetic acid (3 ml) was performed after 2 h followed by a last addition of trifluoroacetic acid (5 ml) after 5 h. Solvents were then removed in vacuo. The resulting gum was washed with Et₂O (3×) and the resulting solid was dried in vacuo to afford the title compound as a white powder (0.92 g). ¹H NMR (400 MHz, DMSO-d₆): 8.31 (bs, 2H), 4.01 (t, 2H), 3.70-3.81 (bs, 1H), 3.27 (t, 2H).

### Step B: 4-Acetyl-2-methyl-N-(1,1-dioxide-thietan-3-yl)-benzamide

To a solution of 4-acetyl-2-methyl benzoylchloride (4.6 g, 23 mmol) and Et₃N (2.53 g, 25 mmol) in CH₂Cl₂ (100 ml) cooled to 0° C. was added hydro thietane-3-yl amine1,1-dioxide trifluoroacetate (5.0 g, 21 mmol). The resulting mixture was stirred overnight at room temperature. The mixture was washed successively with water and extracted with CH₂Cl₂ (2×100 ml). The combined organic phases were washed with 2N HCl. The organic layer was dried over Na₂SO₄ and evaporated in vacuo to afford yellow oil (5.9 g). LCMS (method F) RT=1.05 min, [M+H⁺]=282. ¹H NMR (400 MHz, CDCl₃): 7.82 (s, 1H), 7.78 (d, 1H), 7.46 (d, 1H), 6.63 (d, 1H), 4.86-4.94 (m, 1H), 4.59-4.67 (m, 2H), 4.03-4.08 (m, 2H), 2.62 (s, 3H), 2.50 (s, 3H).

### Step C: 4-[(E)-3-(3,5-dichloro-phenyl)-4,4,4-trifluoro-but-2-enoyl]-2-methyl-N-(1,1-dioxide-thietan-3-yl-benzamide

4-Acetyl-2-methyl-N-(1,1-dioxide-thietan-3-yl)-benzamide (0.28 g, 1 mmol), (3,5 dichloro 2,2,2 trifluoroacetophenone (0.24 g, 1 mmol) potassium carbonate (138 mg, 1 mmol) and triethylamine (10 mg, 0.1 mmol) were dissolved in 1,2 dichloroethane (2.5 ml). The resulting mixture was refluxed for 3 h. The reaction mixture was cooled to room temperature and saturated aqueous NH₄Cl was added. The mixture was extracted with CH₂Cl₂ (3×50 ml). The combined organic extracts were dried over Na₂SO₄ and concentrated in vacuo to afford a brown solid (0.52 g). Purification by silica gel chromatography (heptane:Ethyl acetate 2:1) afforded the title compound as a yellow solid (0.33 g). The solid was suspended in heptane (10 ml) and stirred for 1 h at 40° C. It was then cooled to 0° C., filtered, washed with 1 ml cold TBME. After being dried under vacuum the title compound was obtained as a white solid (0.50 g). ¹H NMR (400 MHz, CDCl₃): 7.65-7.69 (m, 2H), 7.45-7.47 (m, 2H), 7.43-7.45 (m, 2H), 7.36-7.37 (m, 1H), 7.35 (t, 1H), 7.15 (d, 2H), 6.49 (d, 1H), 4.86-4.94 (m, 1H), 4.59-4.67 (m, 2H), 3.99-4.05 (m, 2H), 2.48 (s, 3H).

### Example 13

### 4-[5-(3,5-Dichloro-phenyl)-5-trifluoromethyl-4,5-dihydro-isoxazol-3-yl]-2-methyl-N-thietan-3-yl-benzamide

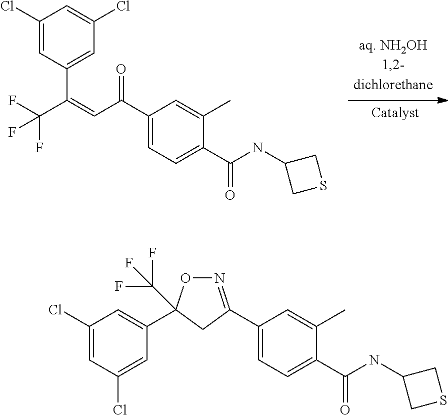 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

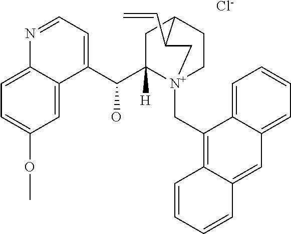 [SMILES: [Cl-] ; C=CC1C[N+]2(Cc3c4ccccc4cc4ccccc34)CCC1C[C@H]2[C@H](O)c1ccnc2ccc(OC)cc12]

A pre-cooled solution of 5M sodium hydroxide (0.25 ml) was added to a solution of hydroxylamine (50% in water, 37 mg) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and anthracenyl-methyl quininium chloride (20 mg) (catalyst preparation Example 1) in 1,2-dichloroethane (1.5 ml) cooled in an ice-acetone bath. The mixture was stirred rapidly at ca −25° C. for 5 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 5%) to give the title compound (90 mg) as a white solid. ¹H NMR (400 MHz, CDCl₃) 7.52 (m, 4H), 7.42 (m, 2H), 6.18 (d, 1H), 5.41 (q, 1H), 4.09 (d, 1H), 3.67 (d, 1H), 3.50 (t, 2H), 3.39 (t, 2H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.60 minutes) as the major product (40% ee).

### Example 14

### 4-[5-(3,5-Dichloro-phenyl)-5-trifluoromethyl-4,5-dihydro-isoxazol-3-yl]-2-methyl-N-thietan-3-yl-benzamide

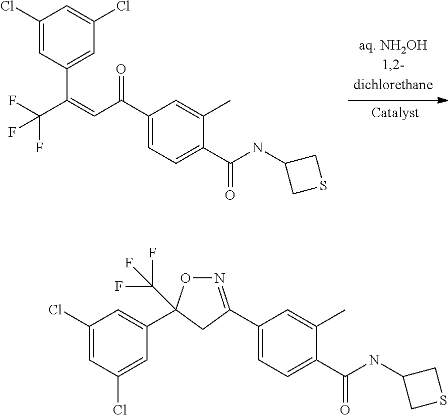 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

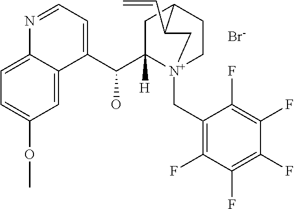 [SMILES: C=CC1C[N+]2(Cc3c(F)c(F)c(F)c(F)c3F)CCC1C[C@H]2[C@H](O)c1ccnc2ccc(OC)cc12 ; [Br-]]

A pre-cooled solution of 5M sodium hydroxide (0.25 ml) was added to a solution of hydroxylamine (50% in water, 37 mg) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 2,3,4,5,6-pentafluorophenyl-methyl quininium bromide (20 mg) (catalyst preparation Example 3) in 1,2-dichloroethane (1.5 ml) cooled by a cryostat in an acetone bath. The mixture was stirred rapidly at ca −15° C. for 3 hours. The reaction mixture was diluted with dichloromethane, passed through an isolute phase separating cartridge and concentrated in vacuo to leave a yellow oil. This residue was purified by chromatography on silica gel (eluent: heptane/ethyl acetate 20%) to give the title compound (100 mg) as a white solid. ¹H NMR (400 MHz, CDCl₃) 7.52 (m, 4H), 7.42 (m, 2H), 6.18 (d, 1H), 5.41 (q, 1H), 4.09 (d, 1H), 3.67 (d, 1H), 3.50 (t, 2H), 3.39 (t, 2H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (Chiral separation Example): the product contained ISOMER B (retention time 8.80 min) as the major product (63% ee).

### Example 15

### 4-[5-(3,5-Dichloro-phenyl)-5-trifluoromethyl-4,5-dihydro-isoxazol-3-yl]-2-methyl-N-thietan-3-yl-benzamide

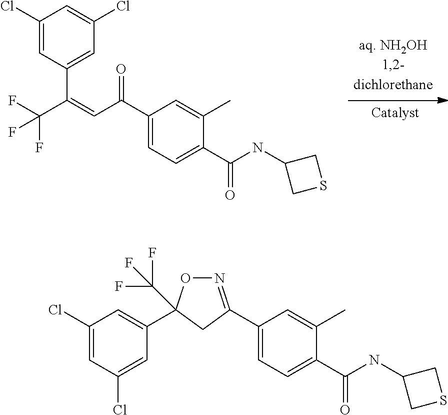 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

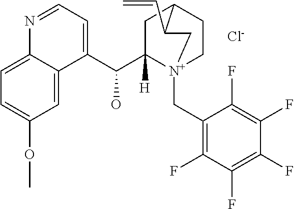 [SMILES: C=CC1C[N+]2(Cc3c(F)c(F)c(F)c(F)c3F)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 2,3,4,5,6-pentafluorophenyl-methyl quininium chloride (21 mg) (catalyst preparation Example 4) in 1,2-dichloroethane (1.5 ml) cooled in an ice bath. The mixture was stirred rapidly at ca 0° C. for 2 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (75 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.80 min) as the major product (75% ee).

### Example 16

### 4-[5-(3,5-Dichloro-phenyl)-5-trifluoromethyl-4,5-dihydro-isoxazol-3-yl]-2-methyl-N-thietan-3-yl-benzamide

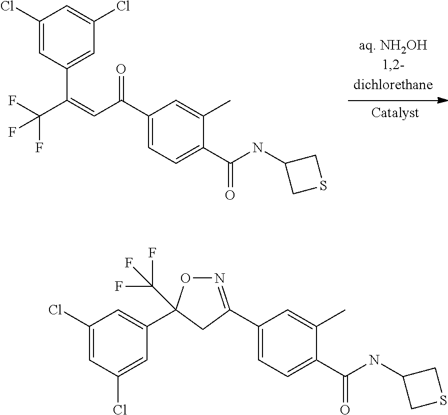 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

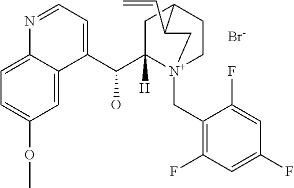 [SMILES: C=CC1C[N+]2(Cc3c(F)cc(F)cc3F)CCC1C[C@H]2[C@H](O)c1ccnc2ccc(OC)cc12 ; [Br-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 2,4,6-trifluorophenyl-methyl quininium bromide (19 mg) (catalyst preparation Example 2) in 1,2-dichloroethane (1.5 ml) cooled by a cryostat in an acetone bath. The mixture was stirred rapidly at ca −15° C. for 3 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (100 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.40 min) as the major product (49% ee).

### Example 17

### 4-[5-(3,5-Dichloro-phenyl)-5-trifluoromethyl-4,5-dihydro-isoxazol-3-yl]-2-methyl-N-thietan-3-yl-benzamide

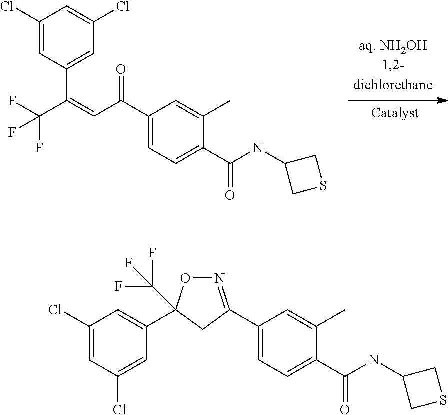 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

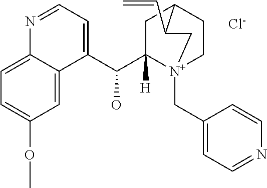 [SMILES: C=CC1C[N+]2(Cc3ccncc3)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 4-pyridine-methyl-quininium chloride (15 mg) (catalyst preparation Example 7) in 1,2-dichloroethane (1.5 mL) cooled by a cryostat in an acetone bath. The mixture was stirred rapidly at ca −15° C. for 3 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (54 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.80 min) as the major product (51% ee).

### Example 18

### 4-[5-(3,5-Dichloro-phenyl)-5-trifluoromethyl-4,5-dihydro-isoxazol-3-yl]-2-methyl-N-thietan-3-yl-benzamide

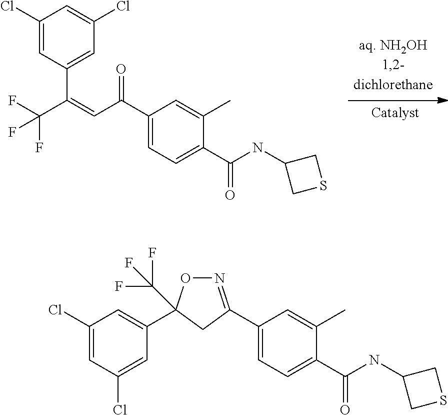 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

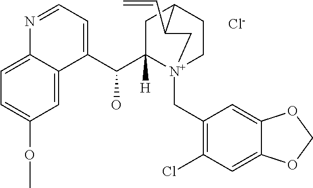 [SMILES: C=CC1C[N+]2(Cc3cc4c(cc3Cl)OCO4)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 6-piperonyl quininium chloride (18 mg) (catalyst preparation Example 5) in 1,2-dichloroethane (1.5 ml) cooled by a cryostat in an acetone bath. The mixture was stirred rapidly at ca −15° C. for 3 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (100 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.80 min) as the major product (51% ee).

### Example 19

### 4-[5-(3,5-Dichloro-phenyl)-5-trifluoromethyl-4,5-dihydro-isoxazol-3-yl]-2-methyl-N-thietan-3-yl-benzamide

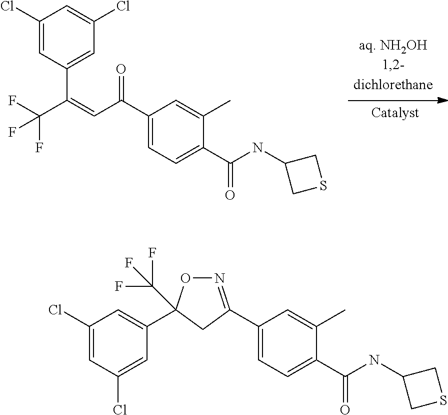 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

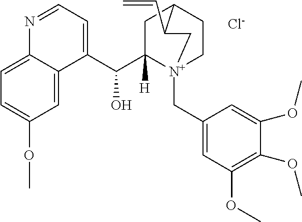 [SMILES: C=CC1C[N+]2(Cc3cc(OC)c(OC)c(OC)c3)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 mL) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 3,4,5-trimethoxyphenyl-methyl quininium chloride (22 mg) (catalyst preparation Example 6) in 1,2-dichloroethane (1.5 ml) cooled in an ice bath. The mixture was stirred rapidly at ca 0° C. for 2 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (67 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.80 min) as the major product (77% ee).

### Example 20

### 4-[5-(3,5-Dichloro-phenyl)-5-trifluoromethyl-4,5-dihydro-isoxazol-3-yl]-2-methyl-N-thietan-3-yl-benzamide

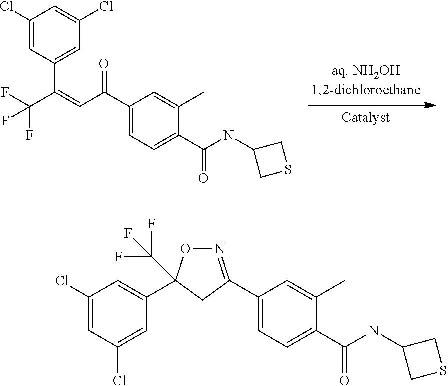 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

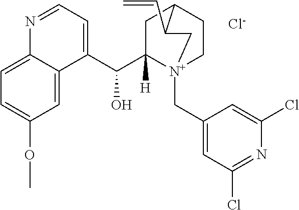 [SMILES: C=CC1C[N+]2(Cc3cc(Cl)nc(Cl)c3)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 4-[(E)-3-(3,5-dichloro-phenyl)-4,4,4-trifluoro-but-2-enoyl]-2-methyl-N-thietan-3-yl-benzamide (100 mg) and 2,6-dichloropyridine-methyl quininium chloride (21 mg) (catalyst preparation Example 8) in 1,2-dichloroethane (1.5 ml) cooled in an ice bath. The mixture was stirred rapidly at ca 0° C. for 2 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound (70 mg) as a white solid. ¹H NMR (400 MHz, CDCl₃) 7.52 (m, 4H), 7.42 (m, 2H), 6.18 (d, 10H), 5.41 (q, 1H), 4.09 (d, 1H), 3.67 (d, 1H), 3.50 (t, 1H), 3.39 (t, 1H), 2.47 (s, 3H). ¹⁹F NMR (376 MHz, CDCl₃) −79.51 (s, 3F). The product was analysed by chiral HPLC (method I) and compared to reference samples of ISOMERS A and B of the title compound (chiral separation Example): the product contained ISOMER B (retention time 8.80 min) as the major product (66% ee).

### Example 21

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

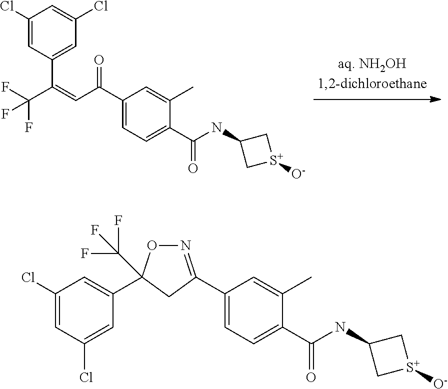 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

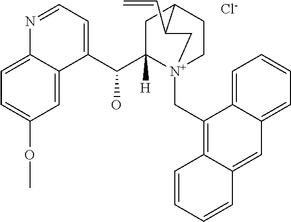 [SMILES: C=CC1C[N+]2(Cc3c4ccccc4cc4ccccc34)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 37 mg) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and anthracenyl-methyl quininium chloride (24 mg) (catalyst preparation Example 1) in 1,2-dichloroethane (1.5 ml) cooled in an ice bath. The mixture was stirred rapidly at ca 0° C. for 1 hour. The reaction mixture was diluted with dichloromethane, passed through an isolute phase separating cartridge and concentrated in vacuo to leave a yellow oil. This residue was purified by chromatography on silica gel (eluent: ethyl acetate/ethanol 5%) to give the title compound (90 mg) as a white solid. ¹H NMR (400 MHz, CDCl₃) 7.48 (m, 5H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (S, 3F). The product was analyzed by chiral HPLC (method J) and compared to reference samples of ISOMERS A and B of the title compound (chiral separation Example): the product contained ISOMER B (retention time 17.6 min) as the major product (37% ee).

### Example 22

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

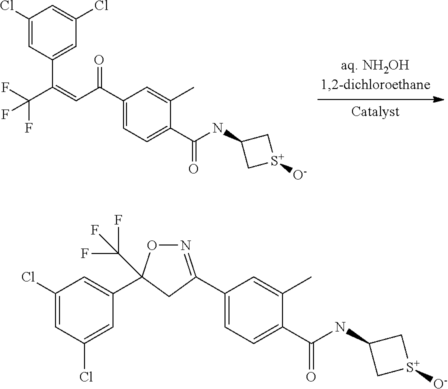 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

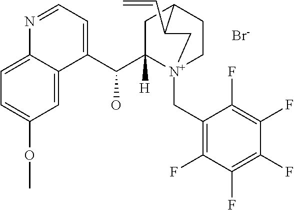 [SMILES: C=CC1C[N+]2(Cc3c(F)c(F)c(F)c(F)c3F)CCC1C[C@H]2[C@H](O)c1ccnc2ccc(OC)cc12 ; [Br-]]

A pre-cooled solution of 5M sodium hydroxide (0.25 ml) was added to a solution of hydroxylamine (50% in water, 37 mg) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 2,3,4,5,6-pentafluorophenyl-methyl quininium bromide (24 mg) (catalyst preparation Example 3) in 1,2-dichloroethane (1.5 ml) cooled in an ice bath. The mixture was stirred rapidly at ca 0° C. for 1 hour. The reaction mixture was diluted with dichloromethane, passed through an isolute phase separating cartridge and concentrated in vacuo to leave a yellow oil. This residue was purified by chromatography on silica gel (eluent: ethyl acetate/ethanol 5%) to give the title compound (34 mg) as a white solid. ¹H NMR (400 MHz, CDCl₃) 7.48 (m, 6H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 17.1 min) as the major product (87% ee).

### Example 23

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

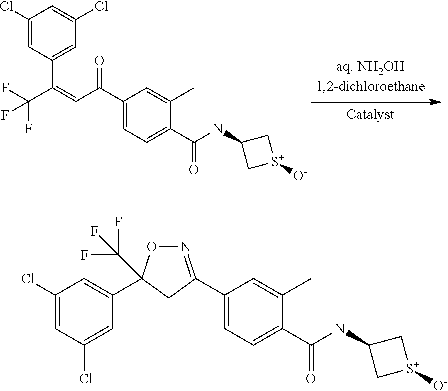 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

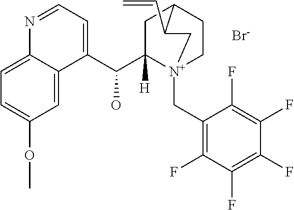 [SMILES: C=CC1C[N+]2(Cc3c(F)c(F)c(F)c(F)c3F)CCC1C[C@H]2[C@H](O)c1ccnc2ccc(OC)cc12 ; [Br-]]

A pre-cooled solution of 5M sodium hydroxide (0.45 ml) was added to a solution of hydroxylamine (50% in water, 67 mg) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (500 mg) and 2,3,4,5,6-pentafluorophenyl-methyl quininium bromide (120 mg) (catalyst preparation Example 3) in 1,2-dichloroethane (7 ml) cooled in an ice bath. The mixture was stirred rapidly at ca 0° C. for 2 hour. The reaction mixture was diluted with dichloromethane, passed through an isolute phase separating cartridge and concentrated in vacuo to leave a yellow oil. This residue was purified by chromatography on silica gel (eluent: ethyl acetate/ethanol 5%) to give the title compound (450 mg) as a white solid. ¹H NMR (400 MHz, CDCl₃) 7.48 (m, 6H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 17.0 minutes) as the major product (90% ee). Optical rotation was measured on a 3.1 mg sample dissolved in 1 ml ethanol using a 1 dm path length. [α_{D}] +58.7°.

### Example 24

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

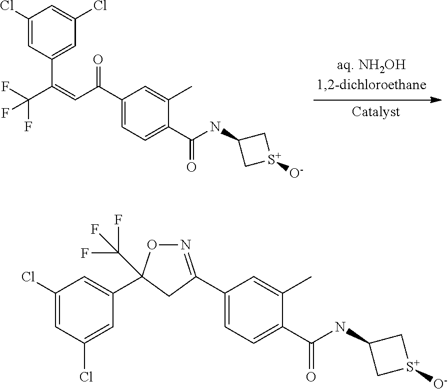 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

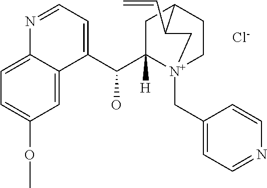 [SMILES: C=CC1C[N+]2(Cc3ccncc3)CCC1C[C@H]2[C@H](O)c1ccnc2ccc(OC)cc12 ; [Cl-]]

A pre-cooled solution of 5M sodium hydroxide (0.25 ml) was added to a solution of hydroxylamine (50% in water, 0.075 ml) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 4-pyridine-methyl-quininium chloride (15 mg) (catalyst preparation Example 7) in 1,2-dichloroethane (1.5 ml) cooled in an ice bath. The mixture was stirred rapidly at ca 0° C. for 1 hour. The reaction mixture was diluted with dichloromethane, passed through an isolute phase separating cartridge and concentrated in vacuo to leave yellow oil. This residue was purified by chromatography on silica gel (eluent: ethyl acetate/ethanol 5%) to give the title compound (100 mg) as a white solid. ¹H NMR (400 MHz, CDCl₃) 7.48 (m, 5H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 17.14 min) as the major product (59% ee).

### Example 25

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

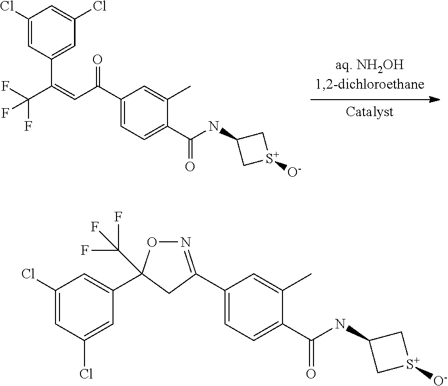 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

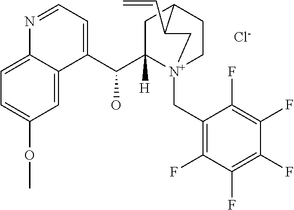 [SMILES: C=CC1C[N+]2(Cc3c(F)c(F)c(F)c(F)c3F)CCC1C[C@H]2[C@H](O)c1ccnc2ccc(OC)cc12 ; [Cl-]]

A pre-cooled solution of 5M sodium hydroxide (0.09 ml) was added to a solution of hydroxylamine (50% in water, 0.026 ml) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 2,3,4,5,6-pentafluorophenyl-methyl quininium chloride (21 mg) (catalyst preparation Example 4) in 1,2-dichloroethane (1.5 ml) cooled in an ice bath. The mixture was stirred rapidly at ca 0° C. for 3 hour. The reaction mixture was diluted with dichloromethane, passed through an isolute phase separating cartridge and concentrated in vacuo to leave yellow oil. This residue was purified by chromatography on silica gel (eluent: ethyl acetate/ethanol 5%) to give the title compound (85 mg) as a white solid. ¹H NMR (400 MHz, CDCl₃) 7.48 (m, 5H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 17.05 min) as the major product (73% ee).

### Example 26

### 4-[5-(3,5-Dichloro-phenyl)-5-trifluoromethyl-4,5-dihydro-isoxazol-3-yl]-2-methyl-N-(cis-1-oxide-thietan-3-yl)-benzamide

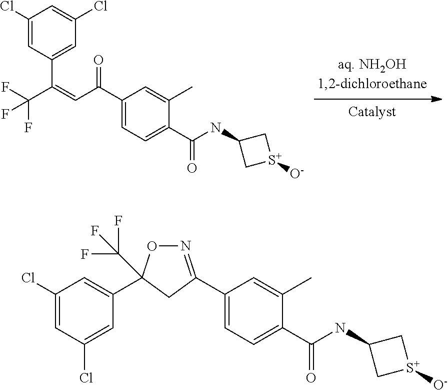 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

### Catalyst:

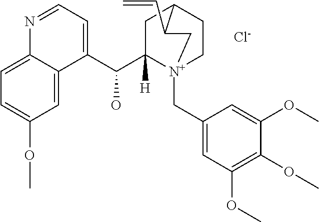 [SMILES: C=CC1C[N+]2(Cc3cc(OC)c(OC)c(OC)c3)CCC1C[C@H]2[C@H](O)c1ccnc2ccc(OC)cc12 ; [Cl-]]

A pre-cooled solution of 5M sodium hydroxide (0.09 ml) was added to a solution of hydroxylamine (50% in water, 0.026 mL) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 3,4,5-trimethoxyphenyl-methyl quininium chloride (22 mg) (catalyst preparation Example 6) in 1,2-dichloroethane (1.5 ml) cooled in an ice bath. The mixture was stirred rapidly at ca 0° C. for 3 hour. The reaction mixture was diluted with dichloromethane, passed through an isolute phase separating cartridge and concentrated in vacuo to leave yellow oil. This residue was purified by chromatography on silica gel (eluent: ethyl acetate/ethanol 5%) to give the title compound (90 mg) as a white solid. ¹H NMR (400 MHz, CDCl₃) 7.48 (m, 5H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 17.36 min) as the major product (70% ee).

### Example 27

### 4-[5-(3,5-Dichloro-phenyl)-5-trifluoromethyl-4,5-dihydro-isoxazol-3-yl]-2-methyl-N-(1,1-dioxo-thietan-3-yl)-benzamide

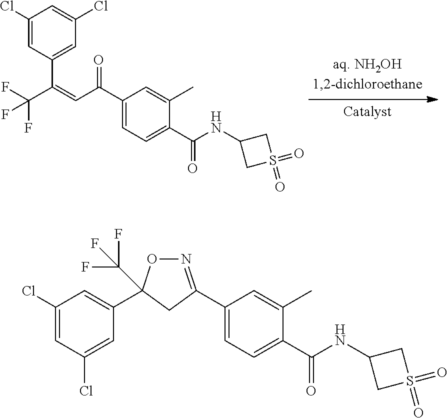 [SMILES: Cc1cc(C(=O)/C=C(\c2cc(Cl)cc(Cl)c2)C(F)(F)F)ccc1C(=O)NC1CS(=O)(=O)C1 ; Cc1cc(C2=NOC(c3cc(Cl)cc(Cl)c3)(C(F)(F)F)C2)ccc1C(=O)NC1CS(=O)(=O)C1]

### Catalyst:

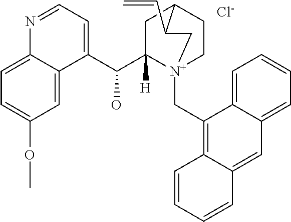 [SMILES: C=CC1C[N+]2(Cc3c4ccccc4cc4ccccc34)CCC1C[C@H]2[C@H](O)c1ccnc2ccc(OC)cc12 ; [Cl-]]

Sodium hydroxide (35 mg, 0.88 mmol) was dissolved in water (0.20 ml), the mixture was cooled to 0° C. in an ice bath and a solution of hydroxylamine (50% in water, 0.49 ml) was added dropwise. The mixture was stirred for 5-10 min, then added dropwise to a stirred solution of 1,4-[(E)-3-(3,5-dichloro-phenyl)-4,4,4-trifluoro-but-2-enoyl]-2-methyl-N-(1,1-dioxide-thietan-3-yl)-benzamide (0.202 g, 0.40 mmol) and anthracenyl-methyl quininium chloride (66 mg) (catalyst preparation Example 1) in 1,2-dichloroethane (4 ml) at −15° C., the mixture was stirred overnight. LC shows consumption of starting material and formation of product. The mixture was diluted with dichloromethane and quenched with dilute hydrochloric acid (2M, 1 mL). The mixture was passed through an isolute phase separating cartridge and concentrated in vacuo, the residue was purified by chromatography on silica gel (eluent: cyclohexane/ethyl acetate 50%) to give the title compound (208 mg) as a colourless solid. ¹H NMR (400 MHz, CDCl₃) 7.52 (m, 4H), 7.42 (m, 2H), 6.79 (br. d, 1H), 4.85 (m, 1H), 4.58 (m, 2H), 4.05 (m, 3H), 3.71 (d, 1H), 2.44 (s, 3H). The product was analysed by chiral HPLC (method J) and compared to reference samples of ISOMERS A and B of the title compound (chiral separation Example): the product contained ISOMER B (retention time 21.5 minutes) as the major product (32.5% ee).

### Example 28

### 4-[5-(3,5-Dichloro-phenyl)-5-trifluoromethyl-4,5-dihydro-isoxazol-3-yl]-2-methyl-N-(1,1-dioxo-thietan-3-yl)-benzamide

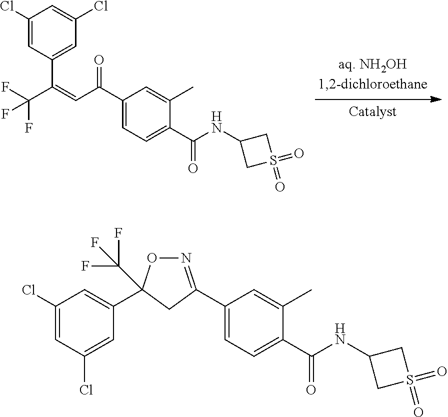 [SMILES: Cc1cc(C(=O)/C=C(\c2cc(Cl)cc(Cl)c2)C(F)(F)F)ccc1C(=O)NC1CS(=O)(=O)C1 ; Cc1cc(C2=NOC(c3cc(Cl)cc(Cl)c3)(C(F)(F)F)C2)ccc1C(=O)NC1CS(=O)(=O)C1]

### Catalyst:

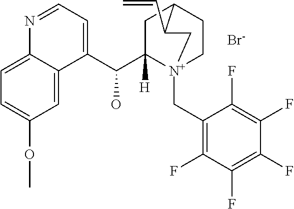 [SMILES: C=CC1C[N+]2(Cc3c(F)c(F)c(F)c(F)c3F)CCC1C[C@H]2[C@H](O)c1ccnc2ccc(OC)cc12 ; [Br-]]

A solution of hydroxylamine (50% in water, 0.024 ml) was added to a pre-cooled (ice-water bath) solution of sodium hydroxide (5M, 0.088 ml), the mixture was stirred for one minute then added to a pre-cooled (ice-water bath) solution of 1,4-[(E)-3-(3,5-dichloro-phenyl)-4,4,4-trifluoro-but-2-enoyl]-2-methyl-N-(1,1-dioxo-thietan-3-yl)-benzamide and 2,3,4,5,6-pentafluorophenyl-methyl quininium bromide (catalyst preparation Example 3) in 1,2-dichloroethane (2 ml). The mixture was stirred for 3 hr at 0-5° C. A small sample was taken and ¹⁹F NMR (376 MHz, CDCl₃) shows formation of product and consumption of starting material. The mixture was diluted with dichloromethane and quenched with dilute hydrochloric acid (2M, 1 ml). The mixture was passed through an isolute phase separating cartridge and concentrated in vacuo, the residue was dissolved in cyclohexane, filtered and concentrated in vacuo. The residue was purified by chromatography on silica gel (eluent: cyclohexane/ethyl acetate 15-50%) to give the title compound (55 mg) as an off white solid. ¹H NMR (400 MHz, CDCl₃) 7.52 (m, 4H), 7.42 (m, 2H), 6.75 (br. d, 1H), 4.88 (m, 1H), 4.62 (m, 2H), 4.05 (m, 3H), 3.70 (d, 1H), 2.47 (s, 3H); ¹⁹F NMR (376 MHz, CDCl₃) 79.52 (s, 3F). The product was analysed by chiral HPLC (method J) and compared to reference samples of ISOMERS A and B of the title compound (chiral separation Example): the product contained ISOMER B (retention time 21.6 minutes) as the major product (67% ee).

### Example 29

### 4-[5-(3,5-Dichloro-phenyl)-5-trifluoromethyl-4,5-dihydro-isoxazol-3-yl]-2-methyl-N-(1,1-dioxo-thietan-3-yl)-benzamide

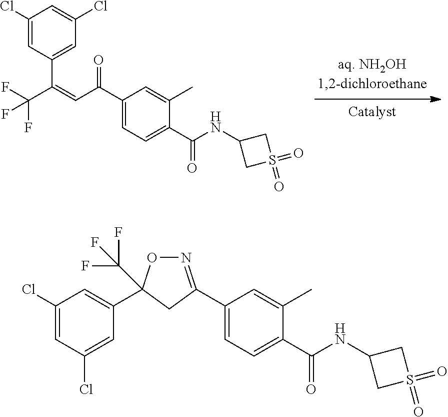 [SMILES: Cc1cc(C(=O)/C=C(\c2cc(Cl)cc(Cl)c2)C(F)(F)F)ccc1C(=O)NC1CS(=O)(=O)C1 ; Cc1cc(C2=NOC(c3cc(Cl)cc(Cl)c3)(C(F)(F)F)C2)ccc1C(=O)NC1CS(=O)(=O)C1]

### Catalyst:

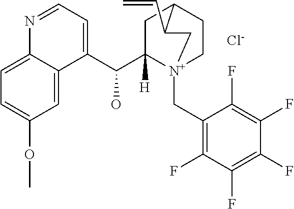 [SMILES: C=CC1C[N+]2(Cc3c(F)c(F)c(F)c(F)c3F)CCC1C[C@H]2[C@H](O)c1ccnc2ccc(OC)cc12 ; [Cl-]]

A pre-cooled solution of 5M sodium hydroxide (0.09 ml) was added to a solution of hydroxylamine (50% in water, 0.026 ml) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 2,3,4,5,6-pentafluorophenyl-methyl quininium chloride (21 mg) (catalyst preparation Example 4) in 1,2-dichloroethane (1.5 ml) cooled in an ice bath. The mixture was stirred rapidly at ca 0° C. for 3 hour. The reaction mixture was diluted with dichloromethane, passed through an isolute phase separating cartridge and concentrated in vacuo to leave yellow oil. This residue was purified by chromatography on silica gel (eluent: n-heptane/ethyl acetate 40%) to give the title compound (58 mg) as a white solid. ¹H NMR (400 MHz, CDCl₃) 7.52 (m, 4H), 7.42 (m, 2H), 6.75 (br. d, 1H), 4.88 (m, 1H), 4.62 (m, 2H), 4.05 (m, 3H), 3.70 (d, 1H), 2.47 (s, 3H); ¹⁹F NMR (376 MHz, CDCl₃) δ9.52 (s, 3F). The product was analyzed by chiral HPLC (method J) and compared to reference samples of ISOMERS A and B of the title compound (chiral separation Example): the product contained ISOMER B (retention time 21.45 min) as the major product (65% ee).

### Example 30

### 4-[5-(3,5-Dichloro-phenyl)-5-trifluoromethyl-4,5-dihydro-isoxazol-3-yl]-2-methyl-N-(1,1-dioxo-thietan-3-yl)-benzamide

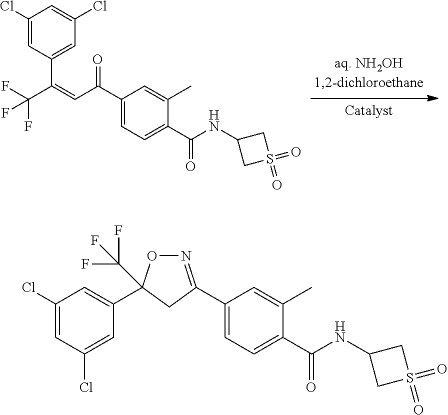 [SMILES: Cc1cc(C(=O)/C=C(\c2cc(Cl)cc(Cl)c2)C(F)(F)F)ccc1C(=O)NC1CS(=O)(=O)C1 ; Cc1cc(C2=NOC(c3cc(Cl)cc(Cl)c3)(C(F)(F)F)C2)ccc1C(=O)NC1CS(=O)(=O)C1]

### Catalyst:

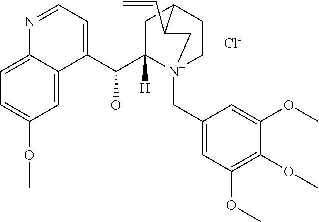 [SMILES: C=CC1C[N+]2(Cc3cc(OC)c(OC)c(OC)c3)CCC1C[C@H]2[C@H](O)c1ccnc2ccc(OC)cc12 ; [Cl-]]

A pre-cooled solution of 5M sodium hydroxide (0.09 mL) was added to a solution of hydroxylamine (50% in water, 0.026 ml) at 5° C. (ice bath). The solution was stirred for 15 min at 5° C. then added to a vigorously stirred solution of 1,4-[(E)-3-(3,5-dichloro-phenyl)-4,4,4-trifluoro-but-2-enoyl]-2-methyl-N-(cis-1-oxide-thietan-3-yl)-benzamide (100 mg) and 3,4,5-trimethoxyphenyl-methyl quininium chloride (catalyst preparation Example 6) (22 mg) in 1,2-dichloroethane (1.5 ml) cooled in an ice bath. The mixture was stirred rapidly at ca 0° C. for 3 hour. The reaction mixture was diluted with dichloromethane, passed through an isolute phase separating cartridge and concentrated in vacuo to leave yellow oil. This residue was purified by chromatography on silica gel (eluent: n-heptane/ethyl acetate 40%) to give the title compound (62 mg) as a white solid. ¹H NMR (400 MHz, CDCl₃) 7.48 (m, 5H), 7.15 (d, 1H), 4.70 (m, 1H), 4.15 (m, 2H), 4.10 (d, 1H), 3.73 (d, 1H), 3.47 (m, 2H), 2.42 (s, 3H). ¹⁹F NMR (376 MHz, CDCl₃) 79.52 (s, 3F). The product was analyzed by chiral HPLC (method J) and compared to reference samples of ISOMERS A and B of the title compound (chiral separation Example): the product contained ISOMER B (retention time 21.67 min) as the major product (68% ee).

### Example 31

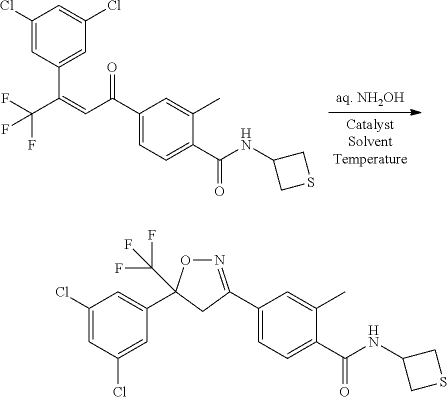 [SMILES: Cc1cc(C(=O)/C=C(\c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

Following the general procedure described in Example 13, different catalysts, solvents and reaction conditions were screened for the preparation of 4-[5-(3,5-dichloro-phenyl)-5-trifluoromethyl-4,5-dihydro-isoxazol-3-yl]-2-methyl-N-(thietan-3-yl)-benzamide. The following results were obtained:

| | | NH₂OH | NaOH | Catalyst | | | | |
|---|---|---|---|---|---|---|---|---|
| Example | Catalyst | (eq.) | (eq.) | (mol %) | Solvent | T° C. | Yield | ee% |
| 31.1 | 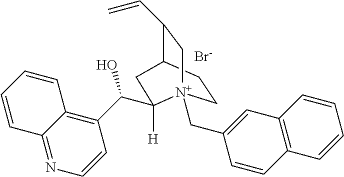 [SMILES: C=CC1C[N+]2(Cc3ccc4ccccc4c3)CCC1CC2[C@@H](O)c1ccnc2ccccc12 ; [Br-]] | 5 | 6 | 20 mol % | DCE | −15° C. | 62% | 5% |
| 31.2 | 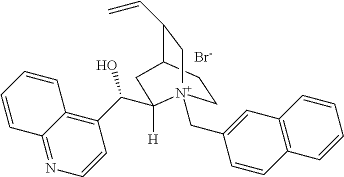 [SMILES: C=CC1C[N+]2(Cc3ccc4ccccc4c3)CCC1CC2[C@@H](O)c1ccnc2ccccc12 ; [Br-]] | 5 | 6 | 20 mol % | DCE | 0° C. | 73% | 6% |
| 31.3 | 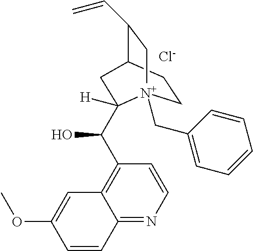 [SMILES: C=CC1C[N+]2(Cc3ccccc3)CCC1CC2[C@H](O)c1ccnc2ccc(OC)cc12 ; [Cl-]] | 5 | 6 | 20 mol % | DCE | −30° C. | 66% | 20% |
| 31.4 | 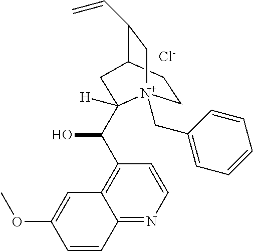 [SMILES: C=CC1C[N+]2(Cc3ccccc3)CCC1CC2[C@H](O)c1ccnc2ccc(OC)cc12 ; [Cl-]] | 2 | 2.2 | 20 mol % | DCE | 0° C. | 68% | 21% |
| 31.5 | 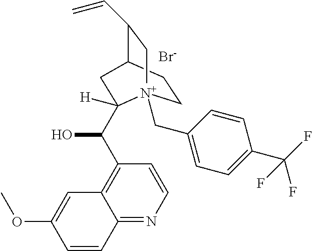 [SMILES: C=CC1C[N+]2(Cc3ccc(C(F)(F)F)cc3)CCC1CC2[C@H](O)c1ccnc2ccc(OC)cc12 ; [Br-]] | 5 | 6 | 20 mol % | DCE | −25° C. | 78% | 15% |
| 31.6 | 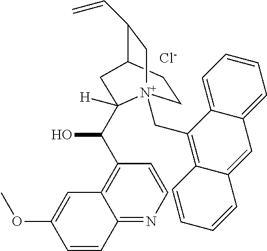 [SMILES: C=CC1C[N+]2(Cc3c4ccccc4cc4ccccc34)CCC1CC2[C@H](O)c1ccnc2ccc(OC)cc12 ; [Cl-]] | 5 | 6 | 20 mol % | DCE | −25° C. | 88% | 40% |
| 31.7 | 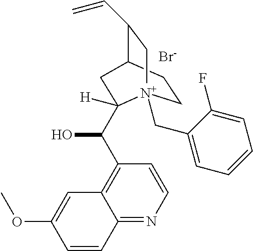 [SMILES: C=CC1C[N+]2(Cc3ccccc3F)CCC1CC2[C@H](O)c1ccnc2ccc(OC)cc12 ; [Br-]] | 5 | 6 | 20 mol % | DCE | −25° C. | — | 25% |
| 31.8 | 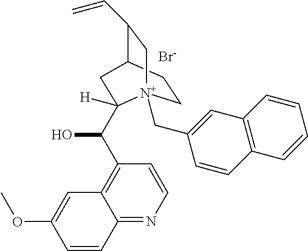 [SMILES: C=CC1C[N+]2(Cc3ccc4ccccc4c3)CCC1CC2[C@H](O)c1ccnc2ccc(OC)cc12 ; [Br-]] | 5 | 6 | 20 mol % | DCE | −25° C. | 92% | 20% |
| 31.9 | 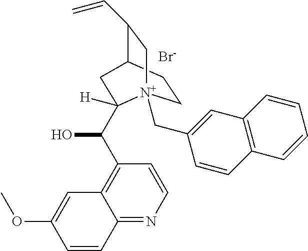 [SMILES: C=CC1C[N+]2(Cc3ccc4ccccc4c3)CCC1CC2[C@H](O)c1ccnc2ccc(OC)cc12 ; [Br-]] | 5 | 6 | 20 mol % | DCE | 0° C. | 97% | 20% |
| 31.10 | 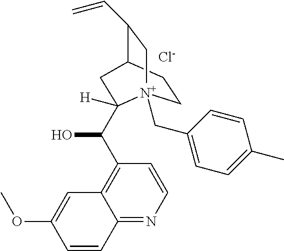 | 5 | 6 | 20 mol % | DCE | −25° C. | 77% | 20% |
| 31.11 | 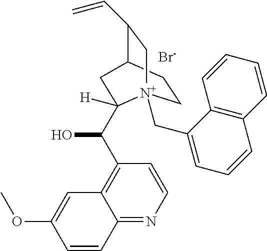 [SMILES: C=CC1C[N+]2(Cc3cccc4ccccc34)CCC1CC2[C@H](O)c1ccnc2ccc(OC)cc12 ; [Br-]] | 5 | 6 | 20 mol % | DCE | −25° C. | 97% | 20% |
| 31.12 | 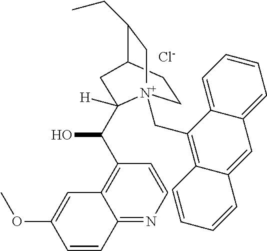 [SMILES: CCC1C[N+]2(Cc3c4ccccc4cc4ccccc34)CCC1CC2[C@H](O)c1ccnc2ccc(OC)cc12 ; [Cl-]] | 5 | 6 | 20 mol % | DCE | −25° C. | 83% | 40% |
| 31.13 | 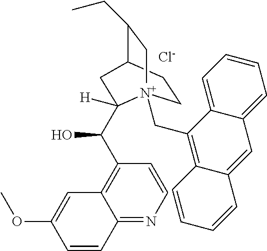 [SMILES: CCC1C[N+]2(Cc3c4ccccc4cc4ccccc34)CCC1CC2[C@H](O)c1ccnc2ccc(OC)cc12 ; [Cl-]] | 2 | 2.2 | 20 mol % | DCE | 0° C. | 68% | 41% |
| 31.14 | 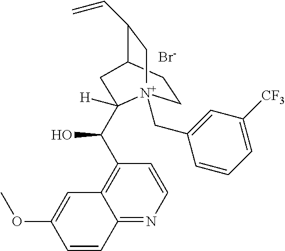 [SMILES: C=CC1C[N+]2(Cc3cccc(C(F)(F)F)c3)CCC1CC2[C@H](O)c1ccnc2ccc(OC)cc12 ; [Br-]] | 5 | 6 | 20 mol % | DCE | −15° C. | 77% | 23% |
| 31.15 | 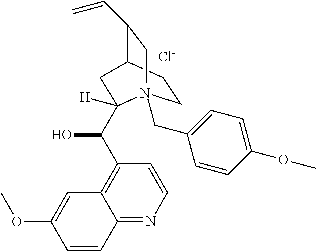 | 5 | 6 | 20 mol % | DCE | −15° C. | 72% | 27% |
| 31.16 | 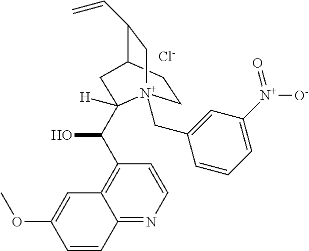 [SMILES: C=CC1C[N+]2(Cc3cccc([N+](=O)[O-])c3)CCC1CC2[C@H](O)c1ccnc2ccc(OC)cc12 ; [Cl-]] | 5 | 6 | 20 mol % | DCE | −15° C. | 74% | 15% |
| 31.17 | 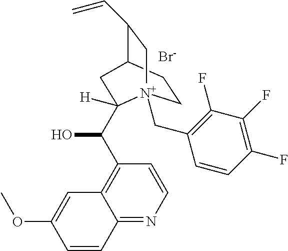 [SMILES: C=CC1C[N+]2(Cc3ccc(F)c(F)c3F)CCC1CC2[C@H](O)c1ccnc2ccc(OC)cc12 ; [Br-]] | 5 | 6 | 20 mol % | DCE | −15° C. | 81% | 30% |
| 31.18 | 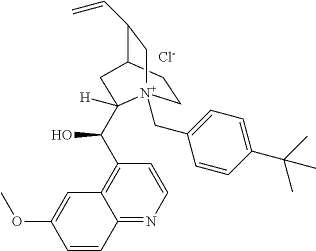 [SMILES: C=CC1C[N+]2(Cc3ccc(C(C)(C)C)cc3)CCC1CC2[C@H](O)c1ccnc2ccc(OC)cc12 ; [Cl-]] | 5 | 6 | 20 mol % | DCE | −15° C. | 87% | 20% |
| 31.19 | 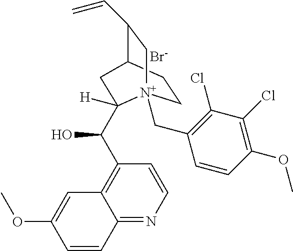 | 5 | 6 | 20 mol % | DCE | −15° C. | — | 46% |
| 31.20 | 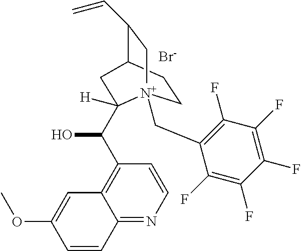 [SMILES: C=CC1C[N+]2(Cc3c(F)c(F)c(F)c(F)c3F)CCC1CC2[C@H](O)c1ccnc2ccc(OC)cc12 ; [Br-]] | 5 | 6 | 20 mol % | DCE | −15° C. | 98% | 63% |
| 31.21 | 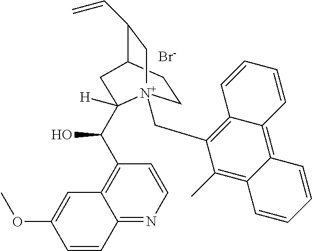 [SMILES: C=CC1C[N+]2(Cc3c(C)c4ccccc4c4ccccc34)CCC1CC2[C@H](O)c1ccnc2ccc(OC)cc12 ; [Br-]] | 5 | 6 | 20 mol % | DCE | −15° C. | 97% | 30% |
| 31.22 | 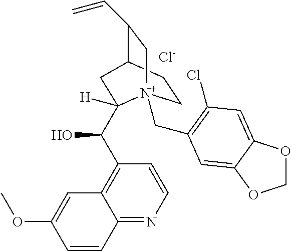 [SMILES: C=CC1C[N+]2(Cc3cc4c(cc3Cl)OCO4)CCC1CC2[C@H](O)c1ccnc2ccc(OC)cc12 ; [Cl-]] | 5 | 6 | 20 mol % | DCE | −15° C. | — | 51% |
| 31.23 | 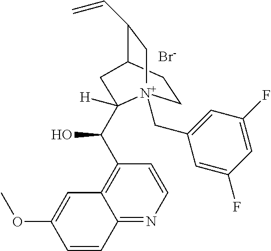 [SMILES: C=CC1C[N+]2(Cc3cc(F)cc(F)c3)CCC1CC2[C@H](O)c1ccnc2ccc(OC)cc12 ; [Br-]] | 5 | 6 | 20 mol % | DCE | −15° C. | 97% | 38% |
| 31.24 | 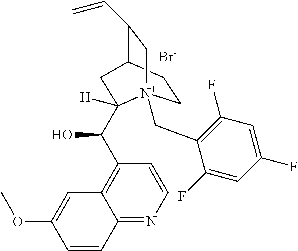 [SMILES: C=CC1C[N+]2(Cc3c(F)cc(F)cc3F)CCC1CC2[C@H](O)c1ccnc2ccc(OC)cc12 ; [Br-]] | 5 | 6 | 20 mol % | DCE | −15° C. | 97% | 49% |
| 31.25 | 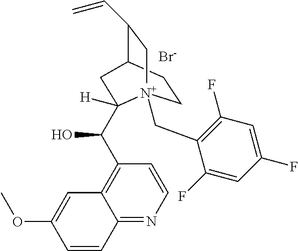 [SMILES: C=CC1C[N+]2(Cc3c(F)cc(F)cc3F)CCC1CC2[C@H](O)c1ccnc2ccc(OC)cc12 ; [Br-]] | 2 | 2.2 | 20 mol % | DCE | 0° C. | 97% | 57% |
| 31.26 | 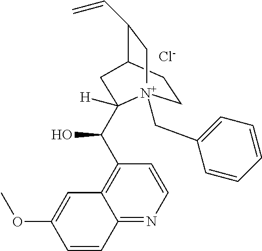 [SMILES: C=CC1C[N+]2(Cc3ccccc3)CCC1CC2[C@H](O)c1ccnc2ccc(OC)cc12 ; [Cl-]] | 5 | 6 | 20 mol% | DCE | −15° C. | — | 51% |
| 31.27 | 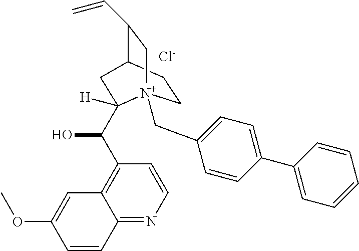 [SMILES: C=CC1C[N+]2(Cc3ccc(-c4ccccc4)cc3)CCC1CC2[C@H](O)c1ccnc2ccc(OC)cc12 ; [Cl-]] | 5 | 6 | 20 mol % | DCE | −15° C. | 74% | 25% |
| 31.28 | 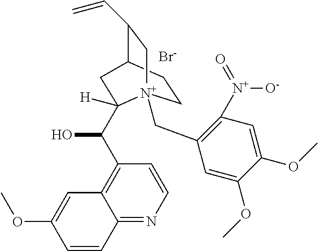 | 5 | 6 | 20 mol % | DCE | −15° C. | 34% | 44% |
| 31.29 | 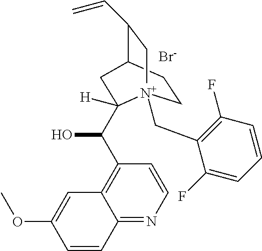 [SMILES: C=CC1C[N+]2(Cc3c(F)cccc3F)CCC1CC2[C@H](O)c1ccnc2ccc(OC)cc12 ; [Br-]] | 5 | 6 | 20 mol % | DCE | −15° C. | 63% | 47% |
| 31.30 | 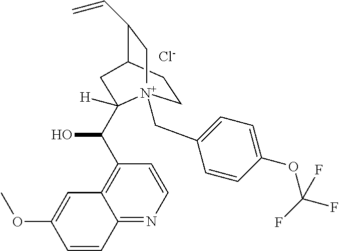 [SMILES: C=CC1C[N+]2(Cc3ccc(OC(F)(F)F)cc3)CCC1CC2[C@H](O)c1ccnc2ccc(OC)cc12 ; [Cl-]] | 5 | 6 | 20 mol % | DCE | −15° C. | — | 22% |
| 31.31 | 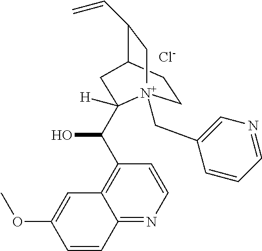 [SMILES: C=CC1C[N+]2(Cc3cccnc3)CCC1CC2[C@H](O)c1ccnc2ccc(OC)cc12 ; [Cl-]] | 5 | 6 | 20 mol % | DCE | −15° C. | — | 46% |
| 31.32 | 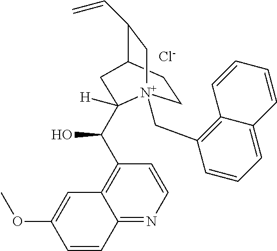 [SMILES: C=CC1C[N+]2(Cc3cccc4ccccc34)CCC1CC2[C@H](O)c1ccnc2ccc(OC)cc12 ; [Cl-]] | 5 | 6 | 20 mol % | DCE | −15° C. | 100% | 33% |
| 31.33 | 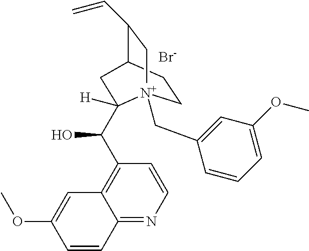 | 5 | 6 | 20 mol % | DCE | −15° C. | 100% | 33% |
| 31.34 | 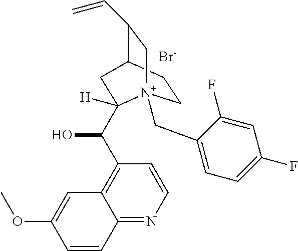 [SMILES: C=CC1C[N+]2(Cc3ccc(F)cc3F)CCC1CC2[C@H](O)c1ccnc2ccc(OC)cc12 ; [Br-]] | 5 | 6 | 20 mol % | DCE | −15° C. | 100% | 37% |
| 31.35 | 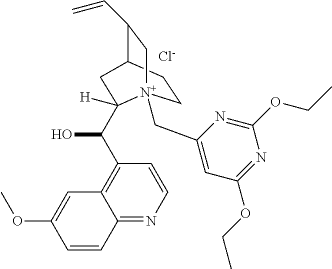 [SMILES: C=CC1C[N+]2(Cc3cc(OCC)nc(OCC)n3)CCC1CC2[C@H](O)c1ccnc2ccc(OC)cc12 ; [Cl-]] | 5 | 6 | 20 mol % | DCE | 0° C. | — | 47% |
| 31.36 | 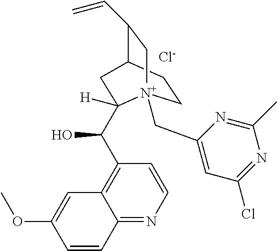 | 5 | 6 | 20 mol % | DCE | 0° C. | — | 24% |
| 31.37 | 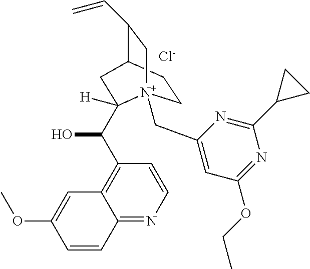 [SMILES: C=CC1C[N+]2(Cc3cc(OCC)nc(C4CC4)n3)CCC1CC2[C@H](O)c1ccnc2ccc(OC)cc12 ; [Cl-]] | 5 | 6 | 20 mol % | DCE | 0° C. | — | 29% |
| 31.38 | 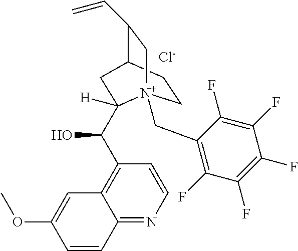 [SMILES: C=CC1C[N+]2(Cc3c(F)c(F)c(F)c(F)c3F)CCC1CC2[C@H](O)c1ccnc2ccc(OC)cc12 ; [Cl-]] | 5 | 6 | 20 mol % | DCE | 0° C. | 73% | 75% |
| 31.39 | 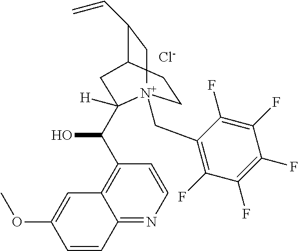 [SMILES: C=CC1C[N+]2(Cc3c(F)c(F)c(F)c(F)c3F)CCC1CC2[C@H](O)c1ccnc2ccc(OC)cc12 ; [Cl-]] | 2 | 2.2 | 20 mol % | DCE | 0° C. | 68% | 68% |
| 31.40 | 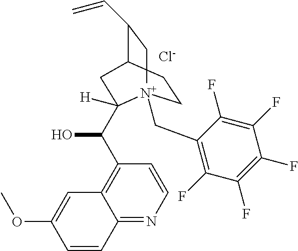 [SMILES: C=CC1C[N+]2(Cc3c(F)c(F)c(F)c(F)c3F)CCC1CC2[C@H](O)c1ccnc2ccc(OC)cc12 ; [Cl-]] | 5 | 6 | 20 mol % | fluoro- benzene | 0° C. | 78% | 65% |
| 31.41 | 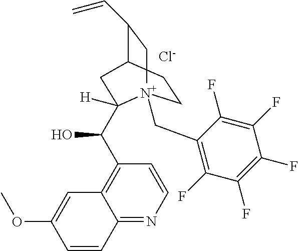 [SMILES: C=CC1C[N+]2(Cc3c(F)c(F)c(F)c(F)c3F)CCC1CC2[C@H](O)c1ccnc2ccc(OC)cc12 ; [Cl-]] | 5 | 6 | 20 mol % | α,α,α- trifluoro- toluene | 0° C. | 63% | 46% |
| 31.42 | 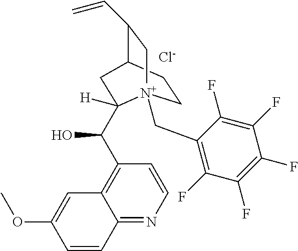 [SMILES: C=CC1C[N+]2(Cc3c(F)c(F)c(F)c(F)c3F)CCC1CC2[C@H](O)c1ccnc2ccc(OC)cc12 ; [Cl-]] | 5 | 6 | 20 mol % | t-butyl- acetate | 0° C. | 81% | 62% |
| 31.43 | 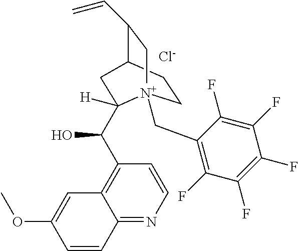 [SMILES: C=CC1C[N+]2(Cc3c(F)c(F)c(F)c(F)c3F)CCC1CC2[C@H](O)c1ccnc2ccc(OC)cc12 ; [Cl-]] | 5 | 6 | 20 mol % | dioxan | 0° C. | 64% | 53% |
| 31.44 | 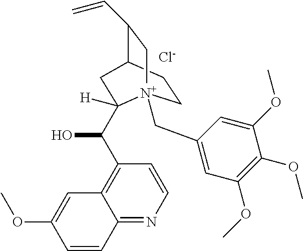 | 5 | 6 | 20 mol % | DCE | 0° C. | 65% | 77% |
| 31.45 | 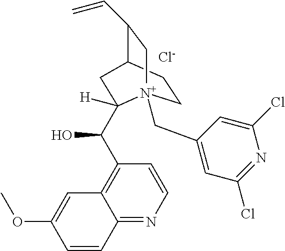 [SMILES: C=CC1C[N+]2(Cc3cc(Cl)nc(Cl)c3)CCC1CC2[C@H](O)c1ccnc2ccc(OC)cc12 ; [Cl-]] | 5 | 6 | 20 mol % | DCE | 0° C. | 68% | 66% |
| 31.46 | 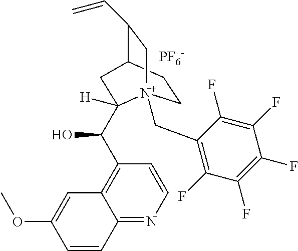 | 5 | 6 | 20 mol % | DCE | 0° C. | 68% | 60% |
| 31.47 | 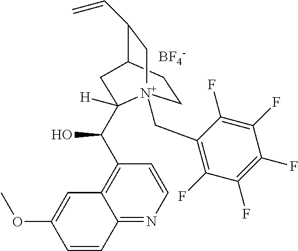 | 5 | 6 | 20 mol % | DCE | 0° C. | 38% | 83% |
| 31.48 | 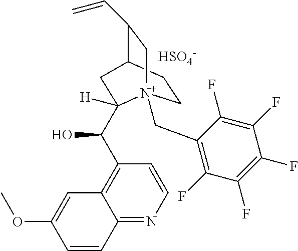 | 5 | 6 | 20 mol % | DCE | 0° C. | 72% | 58% |
| 31.49 | 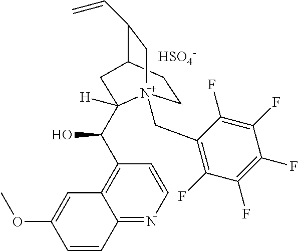 | 5 | 6 | 5 mol % | DCE | 0° C. | 100% | 59% |
| 31.50 | 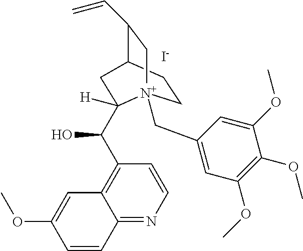 | 5 | 6 | 20 mol % | DCE | 0° C. | 63% | 77% |
| 31.51 | 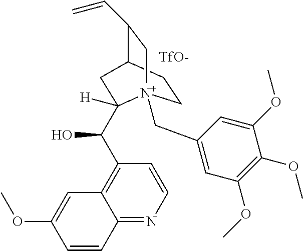 | 5 | 6 | 20 mol % | DCE | 0° C. | 63% | 77% |
| 31.52 | 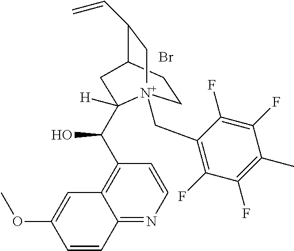 | 5 | 6 | 20 mol % | DCE | 0° C. | 94% | 51% |

### Example 32

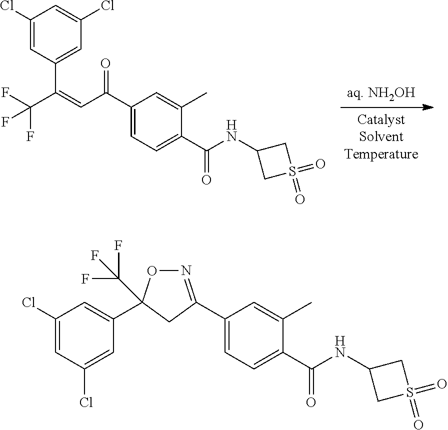 [SMILES: Cc1cc(C(=O)/C=C(\c2cc(Cl)cc(Cl)c2)C(F)(F)F)ccc1C(=O)NC1CS(=O)(=O)C1 ; Cc1cc(C2=NOC(c3cc(Cl)cc(Cl)c3)(C(F)(F)F)C2)ccc1C(=O)NC1CS(=O)(=O)C1]

Following the general procedure described in Example 27, different catalysts, solvents and reaction conditions were screened for the preparation of 4-[5-(3,5-dichloro-phenyl)-5-trifluoromethyl-4,5-dihydro-isoxazol-3-yl]-2-methyl-N-(1,1-dioxo-thietan-3-yl)-benzamide. The following results were obtained:

| | | NH₂OH | NaOH | Catalyst | | | | |
|---|---|---|---|---|---|---|---|---|
| Example | Catalyst | (eq.) | (eq.) | (mol %) | Solvent | T° C. | Yield | ee% |
| 32.1 | 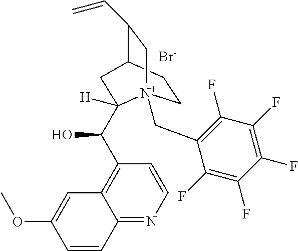 [SMILES: C=CC1C[N+]2(Cc3c(F)c(F)c(F)c(F)c3F)CCC1CC2[C@H](O)c1ccnc2ccc(OC)cc12 ; [Br-]] | 2 | 2.2 | 20 mol % | DCE | 0° C. | 58% | 61% |
| 32.2 | 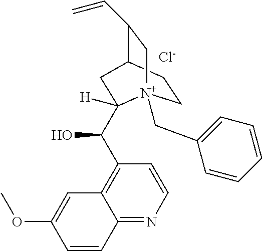 [SMILES: C=CC1C[N+]2(Cc3ccccc3)CCC1CC2[C@H](O)c1ccnc2ccc(OC)cc12 ; [Cl-]] | 2 | 2.2 | 20 mol % | DCE | 0° C. | 28% | 21% |
| 32.3 | 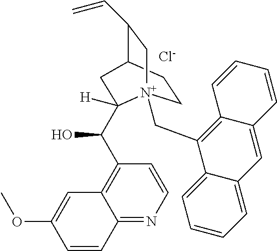 [SMILES: C=CC1C[N+]2(Cc3c4ccccc4cc4ccccc34)CCC1CC2[C@H](O)c1ccnc2ccc(OC)cc12 ; [Cl-]] | 2 | 2.2 | 20 mol % | DCE | 0° C. | 46% | 33% |
| 32.4 | 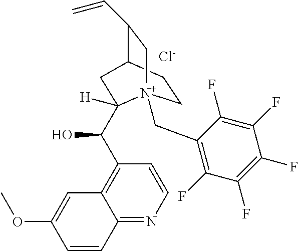 [SMILES: C=CC1C[N+]2(Cc3c(F)c(F)c(F)c(F)c3F)CCC1CC2[C@H](O)c1ccnc2ccc(OC)cc12 ; [Cl-]] | 2 | 2.2 | 20 mol % | DCE | 0° C. | 56% | 65% |
| 32.5 | 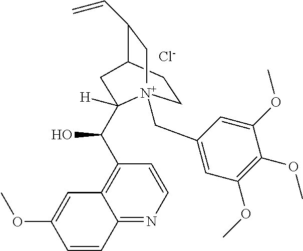 | 2 | 2.2 | 20 mol % | DCE | 0° C. | 60% | 68% |
| 32.6 | 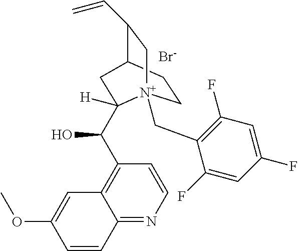 [SMILES: C=CC1C[N+]2(Cc3c(F)cc(F)cc3F)CCC1CC2[C@H](O)c1ccnc2ccc(OC)cc12 ; [Br-]] | 2 | 2.2 | 20 mol % | DCE | 0° C. | 48% | 52% |

### Example 33

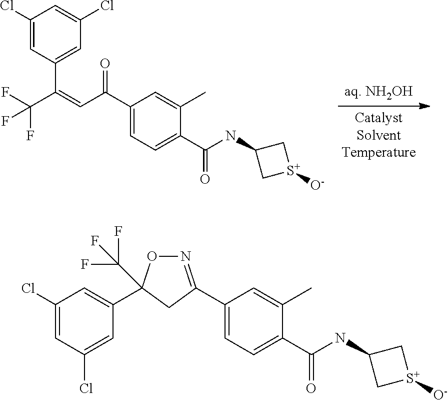 [SMILES: Cc1cc(C(=O)/C=C(\c2cc(Cl)cc(Cl)c2)C(F)(F)F)ccc1C(=O)N[C@H]1C[S@@+]([O-])C1 ; Cc1cc(C2=NOC(c3cc(Cl)cc(Cl)c3)(C(F)(F)F)C2)ccc1C(=O)N[C@H]1C[S@@+]([O-])C1]

Following the general procedure described in Example 21, different catalysts, solvents and reaction conditions were screened for the preparation of 4-[5-(3,5-dichloro-phenyl)-5-trifluoromethyl-4,5-dihydro-isoxazol-3-yl]-2-methyl-N-(cis-1-oxo-thietan-3-yl)-benzamide. The following results were obtained:

| | | NH₂OH | NaOH | Catalyst | | | | |
|---|---|---|---|---|---|---|---|---|
| Example | Catalyst | (eq.) | (eq.) | (mol %) | Solvent | T° C. | Yield | ee% |
| 33.1 | 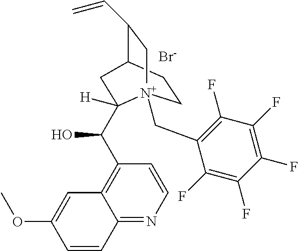 [SMILES: C=CC1C[N+]2(Cc3c(F)c(F)c(F)c(F)c3F)CCC1CC2[C@H](O)c1ccnc2ccc(OC)cc12 ; [Br-]] | 2 | 2.2 | 20 mol % | DCE | 0°C | 88% | 90% |
| 33.2 | 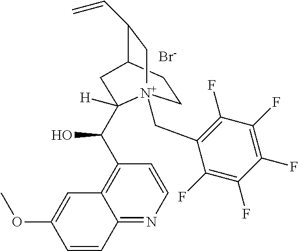 [SMILES: C=CC1C[N+]2(Cc3c(F)c(F)c(F)c(F)c3F)CCC1CC2[C@H](O)c1ccnc2ccc(OC)cc12 ; [Br-]] | 2 | 2.2 | 3 mol % | DCE | 0°C | 100% | 73% |
| 33.3 | 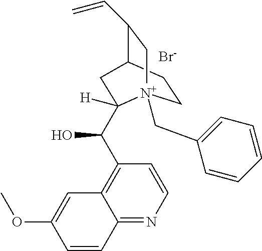 [SMILES: C=CC1C[N+]2(Cc3ccccc3)CCC1CC2[C@H](O)c1ccnc2ccc(OC)cc12 ; [Br-]] | 2 | 2.2 | 20 mol % | DCE | 0°C | 92% | 20% |
| 33.4 | 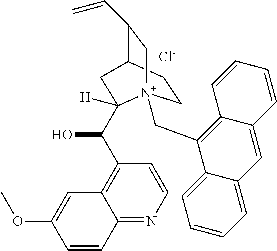 [SMILES: C=CC1C[N+]2(Cc3c4ccccc4cc4ccccc34)CCC1CC2[C@H](O)c1ccnc2ccc(OC)cc12 ; [Cl-]] | 2 | 2.2 | 20 mol % | DCE | 0°C | 68% | 37% |
| 33.5 | 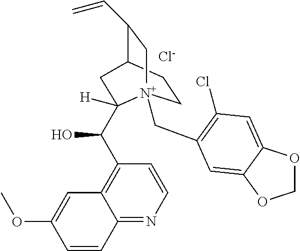 [SMILES: C=CC1C[N+]2(Cc3cc4c(cc3Cl)OCO4)CCC1CC2[C@H](O)c1ccnc2ccc(OC)cc12 ; [Cl-]] | 2 | 2.2 | 20 mol % | DCE | 0°C | 40% | 16% |
| 33.6 | 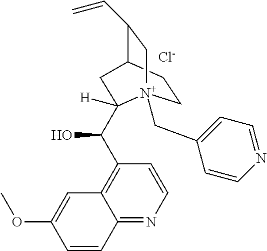 [SMILES: C=CC1C[N+]2(Cc3ccncc3)CCC1CC2[C@H](O)c1ccnc2ccc(OC)cc12 ; [Cl-]] | 2 | 2.2 | 20 mol % | DCE | 0°C | 100% | 60% |
| 33.7 | 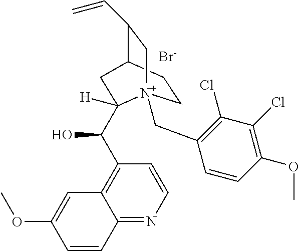 | 2 | 2.2 | 20 mol % | DCE | 0°C | 100% | 39% |
| 33.8 | 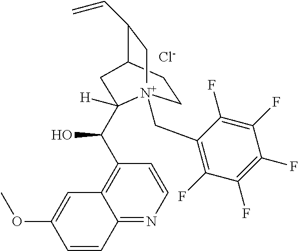 [SMILES: C=CC1C[N+]2(Cc3c(F)c(F)c(F)c(F)c3F)CCC1CC2[C@H](O)c1ccnc2ccc(OC)cc12 ; [Cl-]] | 2 | 2.2 | 20 mol % | DCE | 0°C | 87% | 73% |
| 33.9 | 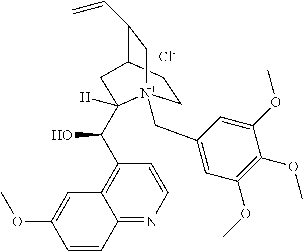 | 2 | 2.2 | 20 mol % | DCE | 0°C | 83% | 70% |
| 33.10 | 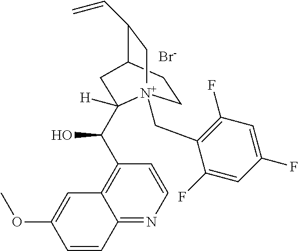 [SMILES: C=CC1C[N+]2(Cc3c(F)cc(F)cc3F)CCC1CC2[C@H](O)c1ccnc2ccc(OC)cc12 ; [Br-]] | 2 | 2.2 | 20 mol % | DCE | 0°C | 63% | 64% |
| 33.11 | 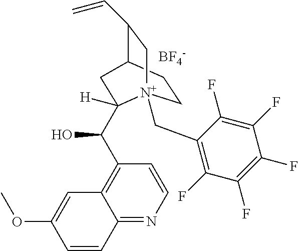 | 5 | 6 | 20 mol % | DCE | 0°C | 53% | 50% |
| 33.12 | 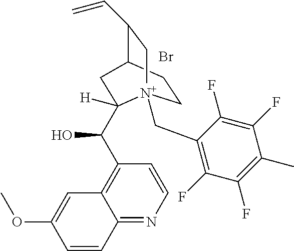 | 2 | 2.2 | 20 mol % | DCE | −10°C | 88% | 79.5% |

### Example 34

### Influence of the E/Z Ratio of (4-[3-(3,5-dichloro-phenyl)-4,4,4-trifluoro-but-2-enoyl]-2-methyl-N-thietan-3-yl-benzamide) on Enantiomeric Excess

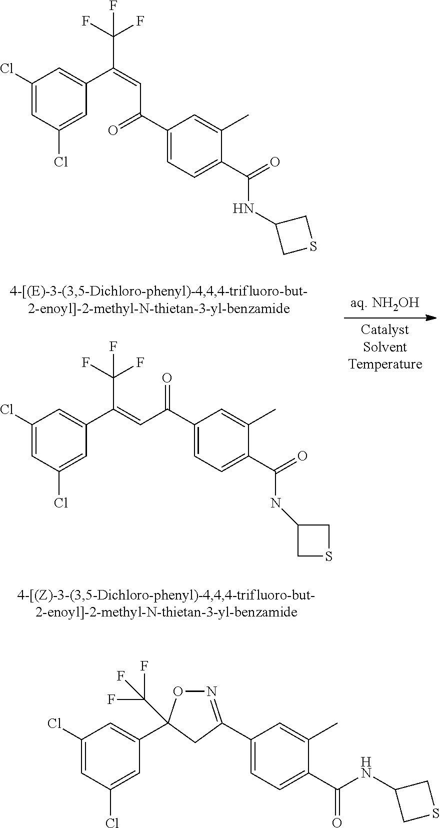 [SMILES: Cc1cc(C(=O)/C=C(\c2cc(Cl)cc(Cl)c2)C(F)(F)F)ccc1C(=O)NC1CSC1 ; Cc1cc(C(=O)/C=C(/c2cc(Cl)cc(Cl)c2)C(F)(F)F)ccc1C(=O)NC1CSC1 ; Cc1cc(C2=NOC(c3cc(Cl)cc(Cl)c3)(C(F)(F)F)C2)ccc1C(=O)NC1CSC1]

### Catalyst:

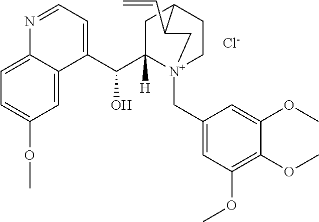 [SMILES: C=CC1C[N+]2(Cc3cc(OC)c(OC)c(OC)c3)CCC1C[C@H]2[C@H](O)c1ccnc2ccc(OC)cc12 ; [Cl-]]

Using the procedure described in Example 10, Step E, different E/Z ratios of the intermediate 4-[3-(3,5-dichloro-phenyl)-4,4,4-trifluoro-but-2-enoyl]-2-methyl-N-thietan-3-yl-benzamide could be obtained by collecting different fractions from column chromatography (heptanes/ethyl acetate 5/1). Thus, from 4-acetyl-2-methyl-N-thietan-3-yl-benzamide (3.97 g), 3.2 g of a 75/25 E/Z mixture of 4-[3-(3,5-dichloro-phenyl)-4,4,4-trifluoro-but-2-enoyl]-2-methyl-N-thietan-3-yl-benzamide was obtained by collecting specific fractions from the chromatography; similarly, from 4-acetyl-2-methyl-N-thietan-3-yl-benzamide (3.97 g), 3.2 g of a 75/25 E/Z mixture of 4-[3-(3,5-dichloro-phenyl)-4,4,4-trifluoro-but-2-enoyl]-2-methyl-N-thietan-3-yl-benzamide were obtained. Similarly, in another experience, from 4-acetyl-2-methyl-N-thietan-3-yl-benzamide (10 g), 3.2 g of a 75/25 E/Z mixture of 4-[3-(3,5-dichloro-phenyl)-4,4,4-trifluoro-but-2-enoyl]-2-methyl-N-thietan-3-yl-benzamide was obtained; similarly, from 4-acetyl-2-methyl-N-thietan-3-yl-benzamide (3.97 g), 16 g of a 91/9 E/Z mixture of 4-[3-(3,5-dichloro-phenyl)-4,4,4-trifluoro-but-2-enoyl]-2-methyl-N-thietan-3-yl-benzamide were obtained by collecting all fractions from the flash chromatography.

A pre-cooled solution of 5M sodium hydroxide (0.093 ml) was added to a solution of hydroxylamine (50% in water, 0.026 mL) at 5° C. (ice bath). The solution was stirred for 15 min at 5° C. then added to a vigorously stirred solution of an isomeric mixture of 4-[(E)-3-(3,5-dichloro-phenyl)-4,4,4-trifluoro-but-2-enoyl]-2-methyl-N-thietan-3-yl-benzamide and 4-[(Z)-3-(3,5-dichloro-phenyl)-4,4,4-trifluoro-but-2-enoyl]-2-methyl-N-thietan-3-yl-benzamide (100 mg, ratio described in table below) and 3,4,5-trimethoxyphenyl-methyl quininium chloride (21 mg) (catalyst preparation Example 6) in 1,2-dichloroethane (1.5 ml) cooled in an ice bath. The mixture was stirred rapidly at ca 0° C. for 2 hours. The reaction mixture was diluted with dichloromethane, passed through an isolute phase separating cartridge and concentrated in vacuo to leave yellow oil. This residue was purified by chromatography on silica gel (eluent: heptane/ethyl acetate 20%) to give the title compound. The product was analysed by chiral HPLC (method J) and compared to reference samples of ISOMERS A and B of the title compound (chiral separation Example): the product contained ISOMER B as the major product (enantiomeric excess in table below)

| | E/Z ratio | | |
|---|---|---|---|
| | (4-[3-(3,5-dichloro-phenyl)- | | |
| | 4,4,4-trifluoro-but-2-enoyl]- | | |
| Example | 2-methyl-N-thietan-3-yl-benzamide) | Yield | ee % |
| 34.1 | 75/25 | 85% | 73% |
| 34.2 | 91/9 | 68% | 77% |

### Example 35

### Biological Examples

This Example illustrates the pesticidal/insecticidal properties of compounds of formula (I). The absolute configuration of isomers A and B has been confirmed by X-ray diffraction. Isomer B corresponds to the compound of formula IB. Tests were performed as follows:

Spodoptera littoralis (Egyptian Cotton Leafworm):

Cotton leaf discs were placed on agar in a 24-well microtiter plate and sprayed with test solutions at an application rate of 50 ppm. After drying, the leaf discs were infested with 5 L1 larvae. The samples were checked for mortality, feeding behavior, and growth regulation 3 days after treatment (DAT).

The following results were obtained:

| | | Control of |
|---|---|---|
| Compound (obtained as described in Example 9) | ISOMER | Spodoptera littoralis |
| 4-[5-(3,5-Dichloro-phenyl)-5-trifluoromethyl-4,5- | A | 50% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 50% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

Heliothis virescens (Tobacco Budworm):

Eggs (0-24 h old) were placed in 24-well microtiter plate on artificial diet and treated with test solutions at an application rate of 50 ppm (concentration in well 18 ppm) by pipetting. After an incubation period of 4 days, samples were checked for egg mortality, larval mortality, and growth regulation.

The following results were obtained:

| | | Control of |
|---|---|---|
| Compound (obtained as described in Example 9) | ISOMER | Heliothis virescens |
| 4-[5-(3,5-Dichloro-phenyl)-5-trifluoromethyl-4,5- | A | 50% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 0% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

Plutella xylostella (Diamond Back Moth):

24-well microtiter plate (MTP) with artificial diet was treated with test solutions at an application rate of 50 ppm (concentration in well 4.5 ppm) by pipetting. After drying, the MTP's were infested with L2 larvae (7-12 per well). After an incubation period of 6 days, samples were checked for larval mortality and growth regulation.

The following results were obtained:

| | | Control of |
|---|---|---|
| Compound (obtained as described in Example 9) | ISOMER | Plutella xylostella |
| 4-[5-(3,5-Dichloro-phenyl)-5-trifluoromethyl-4,5- | A | 0% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 0% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

Diabrotica balteata (Corn Root Worm):

A 24-well microtiter plate (MTP) with artificial diet was treated with test solutions at an application rate of 50 ppm (concentration in well 4.5 ppm) by pipetting. After drying, the MTP's were infested with L2 larvae (6-10 per well). After an incubation period of 5 days, samples were checked for larval mortality and growth regulation.

The following results were obtained:

| | | Control of |
|---|---|---|
| Compound (obtained as described in Example 9) | ISOMER | Diabrotica balteata |
| 4-[5-(3,5-Dichloro-phenyl)-5-trifluoromethyl-4,5- | A | 0% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 0% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

Thrips tabaci (Onion Thrips):

Sunflower leaf discs were placed on agar in a 24-well microtiter plate and sprayed with test solutions at an application rate of 50 ppm. After drying, the leaf discs were infested with an aphid population of mixed ages. After an incubation period of 7 days, samples were checked for mortality.

The following results were obtained:

| | | Control of |
|---|---|---|
| Compound (obtained as described in Example 9) | ISOMER | Thrips tabaci |
| 4-[5-(3,5-Dichloro-phenyl)-5-trifluoromethyl-4,5- | A | 0% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 0% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

Tetranychus urticae (Two-Spotted Spider Mite):

Bean leaf discs on agar in 24-well microtiter plates were sprayed with test solutions at an application rate of 50 ppm. After drying, the leaf discs are infested with mite populations of mixed ages. 8 days later, discs are checked for egg mortality, larval mortality, and adult mortality.

The following results were obtained:

| | | Control of |
|---|---|---|
| Compound (obtained as described in Example 9) | ISOMER | Tetranychus urticae |
| 4-[5-(3,5-Dichloro-phenyl)-5-trifluoromethyl-4,5- | A | 0% |
| dihydro-isoxazol-3-yl]-2-methyl-N-thietan-3-yl- | | |
| benzamide | | |
| 4-[5-(3,5-Dichloro-phenyl)-5-trifluoromethyl-4,5- | B | 100% |
| dihydro-isoxazol-3-yl]-2-methyl-N-thietan-3-yl- | | |
| benzamide | | |
| 4-[5-(3,5-dichloro-phenyl)-5-trifluoromethyl-4,5- | A | 0% |
| dihydro-isoxazol-3-yl]-2-methyl-N-(cis-1-oxide- | | |
| thietan-3-yl)-benzamide | | |
| 4-[5-(3,5-dichloro-phenyl)-5-trifluoromethyl-4,5- | B | 100% |
| dihydro-isoxazol-3-yl]-2-methyl-N-(cis-1-oxide- | | |
| thietan-3-yl)-benzamide | | |
| of 4-[5-(3,5-dichloro-phenyl)-5-trifluoromethyl-4,5- | A | 80% |
| dihydro-isoxazol-3-yl]-2-methyl-N-(1,1-dioxo-thietan- | | |
| 3-yl)-benzamide | | |
| of 4-[5-(3,5-dichloro-phenyl)-5-trifluoromethyl-4,5- | B | 100% |
| dihydro-isoxazol-3-yl]-2-methyl-N-(1,1-dioxo-thietan- | | |
| 3-yl)-benzamide | | |

1. A process for the preparation of a compound of formula IB 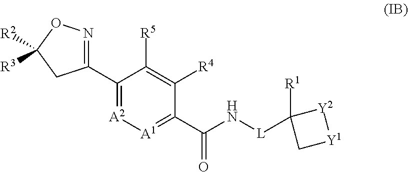
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
comprising reacting a compound of formula II 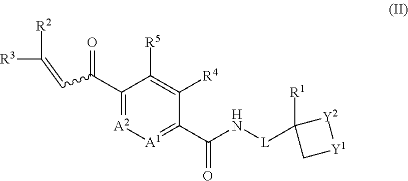
wherein Y¹, Y², L, A¹, A², R¹, R², R³, R⁴ and R⁵ are as defined for the compound of formula I;
with hydroxylamine in the presence of water, a base and a chiral phase transfer catalyst, which chiral phase transfer catalyst is a quinine derivative.

2. A process according to claim 1, wherein the chiral phase transfer catalyst is a compound of formula III 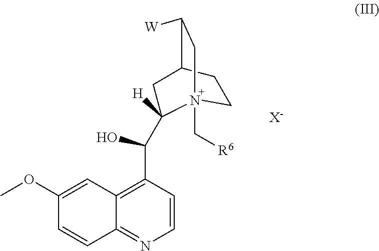
wherein R⁶ is optionally substituted aryl or optionally substituted heteroaryl, W is or ethyl or vinyl, and X is an anion.

3. A process according to claim 1, wherein the chiral phase transfer catalyst is a compound of formula IIIa 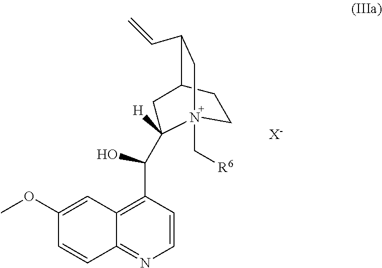
wherein R⁶ is optionally substituted aryl or optionally substituted heteroaryl and X is an anion.

4. A process according to claim 2, wherein
R⁶ is phenyl or phenyl substituted by one to five R⁷, naphthyl or naphthyl substituted by one to five R⁷, anthracenyl or anthracenyl substituted by one to five R⁷, or heteroaryl or heteroaryl substituted by one to four R⁷;
each R⁷ is independently halogen, cyano, nitro, C₁-C₈alkyl, C₁-C₈haloalkyl, C₁-C₈alkoxy, C₁-C₈haloalkoxy, C₃-C₈ cycloalkyl, phenyl or phenyl substituted by one to five halogen, and wherein two R⁷ substituents on adjacent carbon atoms may together form a partially saturated 5-7 membered ring containing one or two heteroatoms selected from O, N(R⁸) and S;
and each R⁸ is independently hydrogen or C₁-C₄ alkyl.

5. A process according to claim 2, wherein
R⁶ is phenyl or phenyl substituted by one to five R⁷, anthracenyl or anthracenyl substituted by one to five R⁷, or pyridyl or pyridyl substituted by one to four R⁷; and
each R⁷ is independently halogen, cyano, nitro, C₁-C₄alkyl, C₁-C₄haloalkyl, C₁-C₄alkoxy, or C₁-C₄haloalkoxy, and wherein any two R⁷ substituents on adjacent carbon atoms may together form a partially saturated 5-7 membered ring containing one or two O atoms.

6. A process according to claim 2, wherein R⁶ is phenyl substituted by one to five R⁷, pyridy or pyridyl substituted by one to four R⁷, pyrimidyl or pyrimidinyl substituted by one to three R⁷, or group A 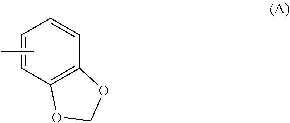
or group A substituted by one to four R⁷, and each R⁷ is independently halogen, nitro, C₁-C₄ alkyl or C₁-C₄ alkoxy.

7. A process according to claim 2, wherein R⁶ is phenyl substituted by one to five substituents independently selected from halogen, methyl and methoxy, pyridyl or pyridyl substituted by one to four halogen atoms.

8. A process according to claim 2, wherein R⁶ is phenyl substituted by three to five substituents independently selected from fluorine, methyl and methoxy.

9. A process according to claim 2, wherein the compound of formula III is a compound of formula IIIA, IIIB, IIIC, IIID, IIIE, IIIF, IIIG, IIIH, IIIJ, IIIK, IIIL, IIIM, IIIN or IIIO 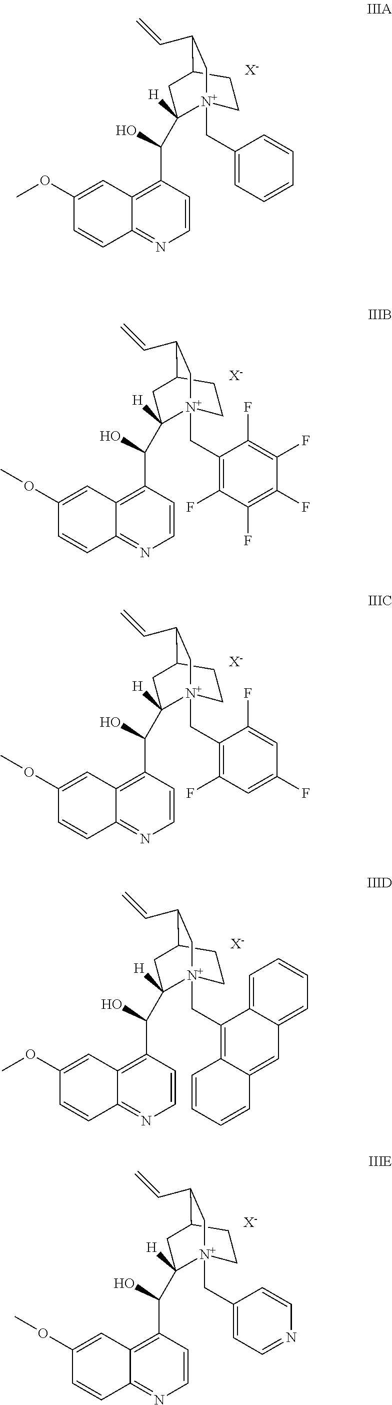 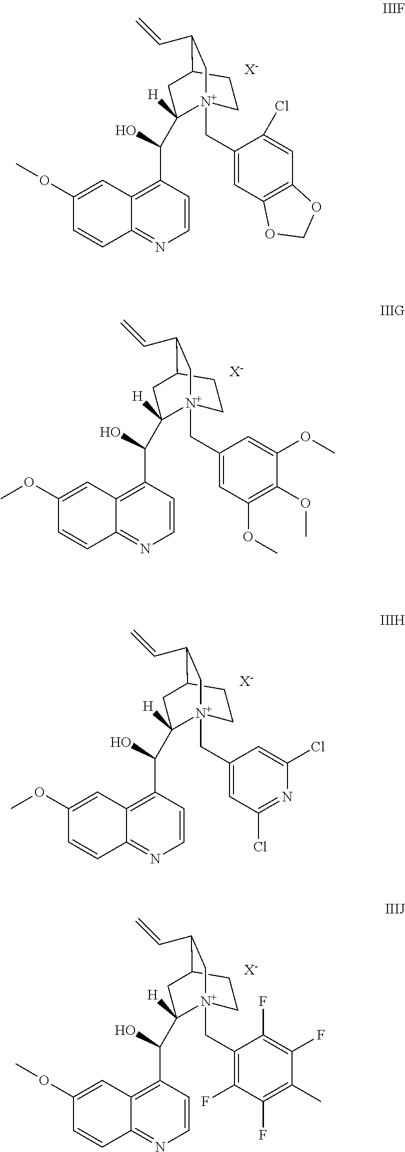 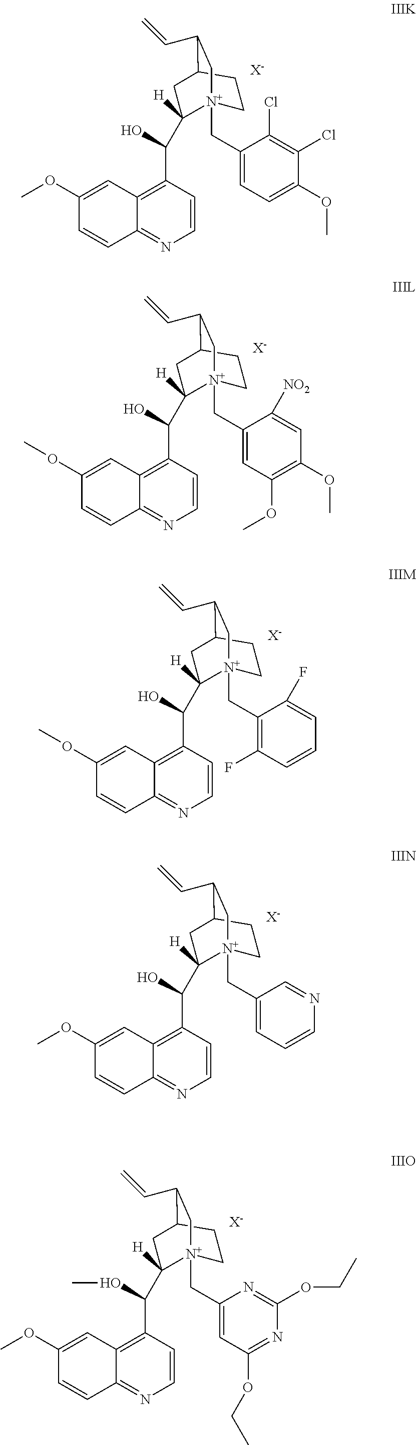
wherein X is an anion.

10. A process according to claim 2, wherein X is halogen.

11. A process for the preparation of a mixture comprising a compound of formula IA and a compound of formula IB 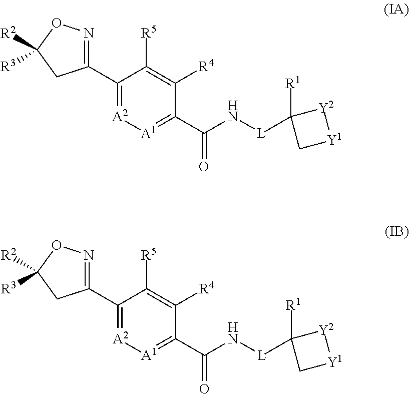
wherein Y¹, Y², L, A¹, A², R¹, R², R³, R⁴ and R⁵ are as defined for the compound of formula I above; wherein the mixture is enantiomerically enriched for the compound of formula IB;
comprising reacting a compound of formula II 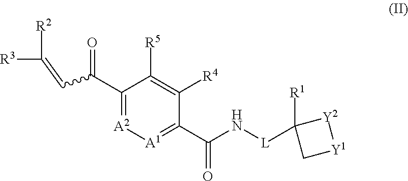
wherein Y¹, Y², L, A¹, A², R¹, R², R³, R⁴ and R⁵ are as defined for the compound of formula I above;
with hydroxylamine in the presence of water, a base and a chiral phase transfer catalyst, which chiral phase transfer catalyst is a quinine derivative.

12. The compound of formula IB 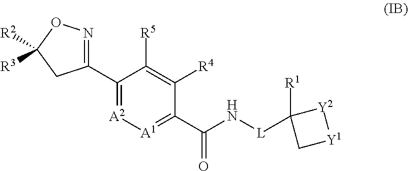
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group.

13. A mixture comprising a compound of formula IA and a compound of formula IB 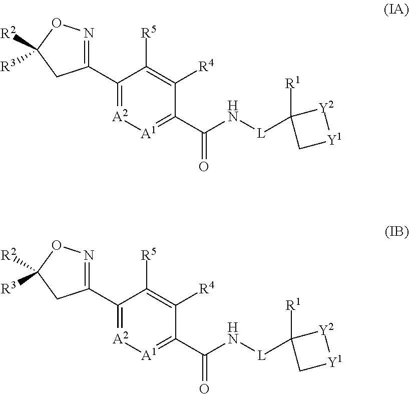
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
wherein the mixture is enantiomerically enriched for the compound of formula IB.

14. A process, compound or mixture according to claim 1, wherein in the compound of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

15. A process, compound or mixture according to claim 1, wherein in the compound of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

16. A process, or mixture according to claim 15, wherein the molar proportion of the cis SO compounds of formula IB compared to the total amount of cis SO and trans SO compounds of formula IB is greater than 50%.

17. A process, compound or mixture according to claim 1, wherein in the compound of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

18. A process, compound or mixture according to claim 1, wherein when L is a direct bond Y² is CH₂ and Y¹ is S, SO or SO₂, and wherein when L is methylene Y² is S, SO or SO₂ and Y¹ is CH₂.

19. A method of controlling insects, acarines, nematodes and/or molluscs which comprises applying to a pest, to a locus of a pest, or to a plant or plant propagation material susceptible to attack by a pest an insecticidally, acaricidally, nematicidally or molluscicidally effective amount of a compound of formula IB or mixture comprising a compound of formula IB and IA as defined in claim 1.

20. A compound of formula III* 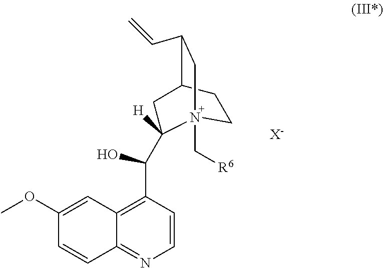
wherein R⁶ is 2,4,6-trifluorophenyl; phenyl substituted by one to five groups independently selected from methyl and fluorine, providing that the phenyl is substituted by at least one methyl and one fluorine; phenyl substituted by one to five groups independently selected from methoxy and nitro, providing that the phenyl is substituted by at least one methoxy and one nitro; phenyl substituted by one to five groups independently selected from methoxy and halogen, providing that the phenyl is substituted by at least one methoxy and one halogen; pyrimidinyl substituted by one to three groups independently selected from halogen, nitro, C₁-C₄ alkyl or C₁-C₄ alkoxy; pyridyl or pyridyl substituted by one to four halogen; or group A 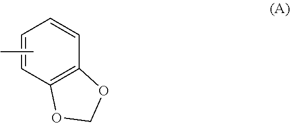
or group A substituted by one to four substituents independently selected from halogen and methoxy, and X is an anion, preferably a halogen anion, more preferably chloride or bromide.

21. A compound of formula III* according to claim 20, wherein the compound of formula III* is a compound of formula IIIC, IIIE, IIIF, IIIH, IIIJ, IIIK, IIIL, IIIN or IIIO 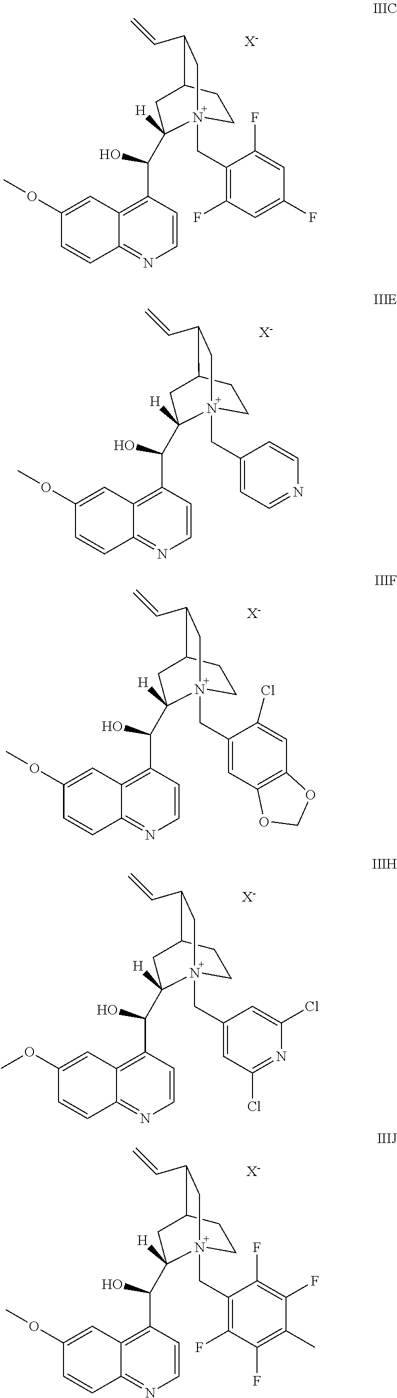 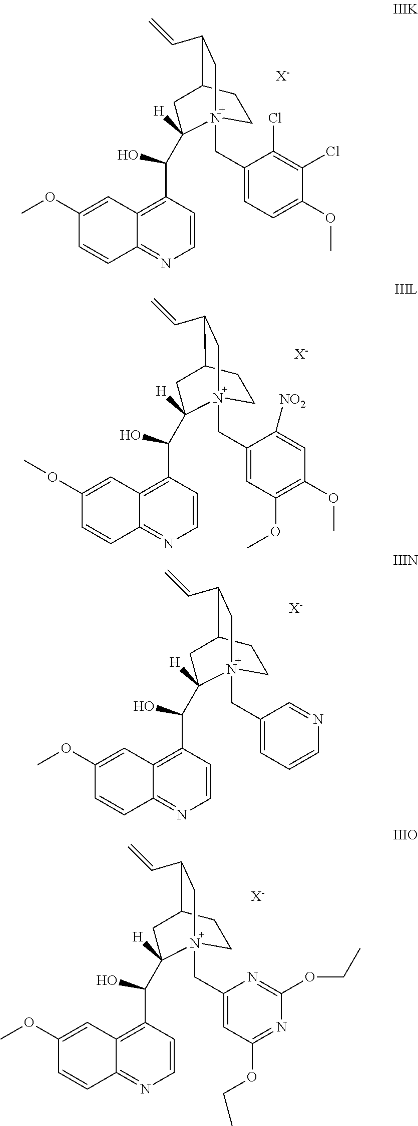
wherein X is an anion.

22. A process for the preparation of a compound of formula III 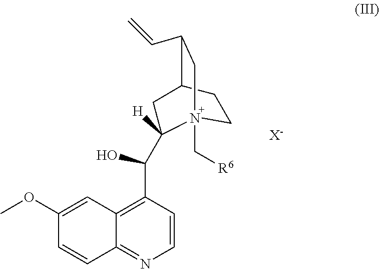
wherein R⁶ is optionally substituted aryl or optionally substituted heteroaryl and X is an anion, preferably a halogen anion, more preferably chloride or bromide;
comprising reacting a compound of formula IV 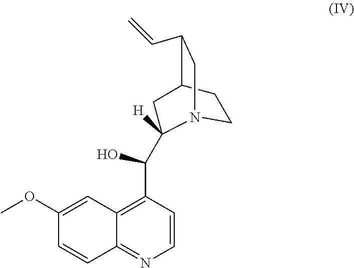 [SMILES: C=CC1CN2CCC1C[C@H]2[C@H](O)c1ccnc2ccc(OC)cc12]
with a compound of formula V 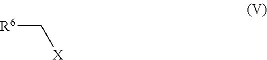
wherein R⁶ and X are as defined for the compound of formula III;
wherein the compound of formula III is for use in a process as defined in claim 1.

23. A method of preparing a compound of formula IB as defined in claim 1, the method comprising using a compound of formula III as defined in claim 2 as a chiral phase transfer catalyst.

24. A process for the preparation of formula IB or a mixture comprising formula IB and IA as defined in claim 1, comprising the step of reacting a beta-keto unsaturated carbonyl group with a hydroxylamine in the presence of water, a base and a chiral phase transfer catalyst, which chiral phase transfer catalyst is a quinine derivative.

25. A process for the preparation of a compound of formula IB or a mixture comprising a compound of formula IA and IB 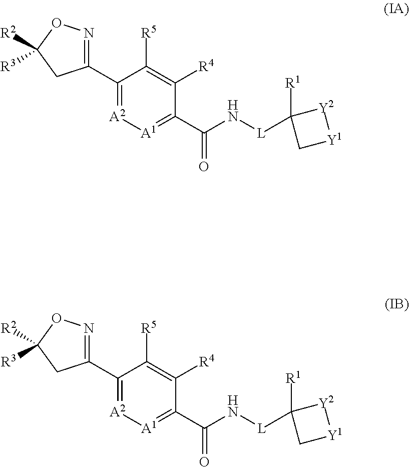
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
comprising reacting a compound of formula XV 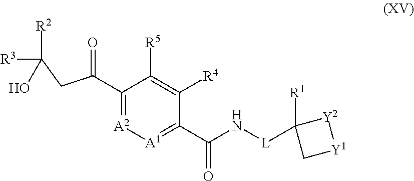
wherein Y¹, Y², L, A¹, A², R¹, R², R³, R⁴ and R⁵ are as defined for the compound of formula I;
with hydroxylamine in the presence of water, a base and a chiral phase transfer catalyst, which chiral phase transfer catalyst is a quinine derivative.

26. A composition comprising a mixture as defined in claim 13, and one or more additional biologically active ingredients.

27. A combination product comprising a pesticidally effective amount of a component A and a pesticidally effective amount of component B, wherein component A is a compound of formula IB or a mixture comprising formula IB and IA as defined in claim 1, and compound B is imidacloprid, enrofloxacin, praziquantel, pyrantel embonate, febantel, penethamate, moloxicam, cefalexin, kanamycin, pimobendan, clenbuterol, fipronil, ivermectin, omeprazole, tiamulin, benazepril, milbemycin, cyromazine, thiamethoxam, pyriprole, deltamethrin, cefquinome, florfenicol, buserelin, cefovecin, tulathromycin, ceftiour, selamectin, carprofen, metaflumizone, moxidectin, methoprene (including S-methoprene), clorsulon, pyrantel, amitraz, triclabendazole, avermectin, abamectin, emamectin, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, fipronil, lufenuron, ecdysone or tebufenozide.
